(19) United States
(12) Patent Application Publication
(10) Pub. No.: US 2012/0023431 A1
(43) Pub. Date: Jan. 26, 2012

(54) COMPUTING DEVICE, OPERATING METHOD OF THE COMPUTING DEVICE USING USER INTERFACE

(75) Inventors: Erik ROTH, Seoul (KR); Jinyung PARK, Seoul (KR); Jaehwa LEE, Seoul (KR); Wookjin CHUNG, Seoul (KR); Stanley KIM, Seoul (KR); Soyoung HAN, Seoul (KR); Heeyoung HWANG, Seoul (KR); Jiyeong KU, Seoul (KR)

(73) Assignee: LG Electronics Inc., Seoul (KR)

(21) Appl. No.: 13/081,324

(22) Filed: Apr. 6, 2011

Related U.S. Application Data
(60) Provisional application No. 61/365,790, filed on Jul. 20, 2010.

(30) Foreign Application Priority Data
Nov. 17, 2010 (KR) PCT/KR2010/008125

(51) Int. Cl. G06F 3/048

(52) U.S. Cl. 715/772

(57) ABSTRACT

A computing device and method that support multitasking environment are discussed. According to an embodiment, the computing device includes a display screen; and a processor which controls the display screen and which: identifies a user command for selecting a first job from a group of jobs associated with the multitasking, determines at least one second job for the same group containing the first job, wherein the second job is a job which was recently accessed by a user from the same group, performs an operating process of the first job while displaying the first job in a first area of the display screen, and performs an operating process of the second job while displaying the second job in a second area of the display screen.

This application claims priority under 35 U.S.C. §119 to PCT International Application No. PCT/KR2010/008125 filed Nov. 17, 2010, and to U.S. Provisional Application No. 61/365,790 filed Jul. 20, 2010. The entire contents of each of these applications are hereby expressly incorporated by reference into the present application.

### BACKGROUND OF THE INVENTION

1. Field of the Invention

The disclosed embodiments relate to an electronic computing device, and also relate to an operating method of the electronic computing device.

2. Discussion of the Background Art

With the recent outstanding leap in the development of the IT technology, diverse IT-based products are being developed and produced. For example, a wide range of IT products from table-top products (or electronic devices), such as desktop personal computers (PC's), digital TV's, up to portable products (or electronic devices), such as smart phones, tablet PC's, and so on, are under research and development based upon their respective purpose.

Also, the recently developed IT products tend to be of a new integrated form of high technology (or high tech) product type executing broadcasting functions, telecommunication functions, work station functions, and so on. Accordingly, since there is an immense difficulty in categorizing the wide variety of IT-based products solely based upon the characteristic names of the corresponding products, in the following description of the embodiments of the invention, the wide range of such IT-based products will be collectively referred to as “computing devices” for simplicity. Accordingly, in the following description of the embodiments of the present invention, the term “computing device” will be broadly used to include existing IT products as well as a variety of new products that are to be developed in the future.

However, most conventional computing device has a problem to perform multitasking jobs, because the conventional device has not been provided with an easily switching process between multitasking jobs and also it does not fully consider the user's experience of using the device. Accordingly, there is a need for a computing device that supports the multitasking environment in a user-friendly and cost-effective manner.

### SUMMARY OF THE INVENTION

An object of the disclosed embodiments is to provide a computing device and an operating method at the computing device for supporting a multitasking environment.

Additional advantages, objects, and features of the present application will be set forth in part in the description which follows and in part will become apparent to those having ordinary skill in the art upon examination of the following or may be learned from practice of the present application. The objectives and other advantages of the present application may be realized and attained by the structure particularly pointed out in the written description and claims hereof as well as the appended drawings.

To achieve these objects and other advantages and in accordance with the purpose of the embodiments, as embodied and broadly described herein, an operating method at a computing device having a display screen and a processor, according to an embodiment includes identifying a user command of selecting a first job from a group, determining a second job in the same group containing the first job, wherein the second job is a job which was recently accessed by a user in the same group, performing an operating process of the first job with displaying the first job in a first area of the display screen, and performing an operating process of the second job with displaying the second job in a second area of the display screen.

In another aspect of the present embodiments, an operating method at a computing device having a display screen and a processor, includes identifying a user command of selecting a first job from a group, determining a second job based on user experienced access, wherein the second job is determined as one of user experience jobs which were accessed by a user while the first job was operating, performing, by the processor, an operating process of the first job with displaying the first job in a first area of the display screen, and performing, by the processor, an operating process of the second job with displaying the second job in a second area of the display screen.

In another aspect of the present embodiments, an operating method at a computing device having a display screen and a processor, includes identifying a user command of selecting a group from a plurality of groups, each group containing at least one application, determining a first job in the selected group, wherein the first job is a job which was most recently accessed by a user in the selected group, determining a second job in the selected group, wherein the second job is a user access job prior to the access of the first job in the selected group, performing an operating process of the first job with displaying the first job in a first area of the display screen, and performing an operating process of the second job with displaying the second job in a second area of the display screen.

In another aspect of the present embodiments, an operating method at a computing device having a display screen and a processor, includes identifying a user command of selecting a group from a plurality of groups, each group containing at least one application, determining, by the processor, a first job in the selected group, wherein the first job is a job which was most recently accessed by a user in the selected group, determining a second job based on user experienced access, wherein the second job is determined as one of user experience jobs which were accessed by a user while the first job was operating, performing an operating process of the first job with displaying the first job in a first area of the display screen, and performing an operating process of the second job with displaying the second job in a second area of the display screen.

In another aspect of the present embodiments, an operating method at a computing device having a display screen and a processor, includes identifying current time when the computing device is powered on, determining a group responding to the current time from a plurality of groups, each group containing at least one application, determining a first job in the determined group, wherein the first job is a job which was most recently accessed by a user in the determined group, determining a second job in the determined group, wherein the second job is a user access job prior to the access of the first job in the determined group, performing an operating process of the first job with displaying the first job in a first area of the display screen, and performing an operating process of the second job with displaying the second job in a second area of the display screen.

In another aspect of the present embodiments, an operating method at a computing device having a display screen and a processor, includes identifying current time when the computing device is powered on, determining a group responding to the current time from a plurality of groups, each group containing at least one application, determining a first job in the determined group, wherein the first job is a job which was most recently accessed by a user in the determined group, determining a second job based on user experienced access, wherein the second job is determined as one of user experience jobs which were accessed by a user while the first job was operating, performing an operating process of the first job with displaying the first job in a first area of the display screen, and performing an operating process of the second job with displaying the second job in a second area of the display screen.

In another aspect of the present embodiments, a computing device includes a display screen, a processor, and a memory configured to store one or more programs, wherein the one or more programs to be executed by the processor, the one or more programs including instructions for identifying a user command of selecting a first job from a group, determining a second job based on user experienced access, wherein the second job is determined as one of user experience jobs which were accessed by a user while the first job was operating, performing an operating process of the first job with displaying the first job in a first area of the display screen, and performing an operating process of the second job with displaying the second job in a second area of the display screen.

In another aspect of the present embodiments, a computing device includes a display screen, a processor, and a memory configured to store one or more programs, wherein the one or more programs to be executed by the processor, the one or more programs including instructions for identifying a user command of selecting a first job from a group, determining a second job based on user experienced access, wherein the second job is determined as one of user experience jobs which were accessed by a user while the first job was operating, performing an operating process of the first job with displaying the first job in a first area of the display screen, and performing an operating process of the second job with displaying the second job in a second area of the display screen.

In another aspect of the present embodiments, a computing device includes a display screen, a processor, and a memory configured to store one or more programs, wherein the one or more programs to be executed by the processor, the one or more programs including instructions for identifying a user command of selecting a group from a plurality of groups, each group containing at least one application, determining a first job in the selected group, wherein the first job is a job which was most recently accessed by a user in the selected group, determining a second job in the selected group, wherein the second job is a user access job prior to the access of the first job in the selected group, performing an operating process of the first job with displaying the first job in a first area of the display screen, and performing an operating process of the second job with displaying the second job in a second area of the display screen.

In another aspect of the present embodiments, a computing device includes a display screen, a processor, and a memory configured to store one or more programs, wherein the one or more programs to be executed by the processor, the one or more programs including instructions for identifying a user command of selecting a group from a plurality of groups, each group containing at least one application, determining a first job in the selected group, wherein the first job is a job which was most recently accessed by a user in the selected group, determining a second job based on user experienced access, wherein the second job is determined as one of user experience jobs which were accessed by a user while the first job was operating, performing an operating process of the first job with displaying the first job in a first area of the display screen, and performing an operating process of the second job with displaying the second job in a second area of the display screen.

In another aspect of the present embodiments, a computing device includes a display screen, a processor, and a memory configured to store one or more programs, wherein the one or more programs to be executed by the processor, the one or more programs including instructions for identifying current time when the computing device is powered on, determining a group responding to the current time from a plurality of groups, each group containing at least one application, determining a first job in the determined group, wherein the first job is a job which was most recently accessed by a user in the determined group, determining a second job in the determined group, wherein the second job is a user access job prior to the access of the first job in the determined group, performing an operating process of the first job with displaying the first job in a first area of the display screen, and performing an operating process of the second job with displaying the second job in a second area of the display screen.

In a further aspect of the present embodiments, a computing device includes a display screen, a processor, and a memory configured to store one or more programs, wherein the one or more programs to be executed by the processor, the one or more programs including instructions for identifying current time when the computing device is powered on, determining a group responding to the current time from a plurality of groups, each group containing at least one application, determining a first job in the determined group, wherein the first job is a job which was most recently accessed by a user in the determined group, determining a second job based on user experienced access, wherein the second job is determined as one of user experience jobs which were accessed by a user while the first job was operating, performing an operating process of the first job with displaying the first job in a first area of the display screen, and performing an operating process of the second job with displaying the second job in a second area of the display screen.

By realizing the embodiments of the present invention, the user is capable of efficiently using multitasking environment by using his (or her) own computing device.

### BRIEF DESCRIPTION OF THE DRAWINGS

For a better understanding of the aforementioned embodiments of the invention as well as additional embodiments thereof, reference should be made to the description of the embodiments below, in conjunction with the following drawings in which like reference numerals refer to corresponding parts throughout the figures.

FIG. 1 illustrates a block view showing the structure of a computing device according to an embodiment of the present invention.

FIG. 2 and FIG. 3 illustrate exemplary diagrams for explaining multitasking operation in accordance with some embodiments.

FIG. 4 illustrates an exemplary configuration of initial groups containing applications in accordance with some embodiments.

FIG. 5 illustrates an exemplary configuration of initial common applications in accordance with some embodiments.

FIG. 6 illustrates an exemplary diagram in accordance with a first embodiment of the present invention.

FIGS. 7(a)˜7(c) illustrate exemplary display screens in accordance with the embodiment of FIG. 6.

FIGS. 8(a)˜8(e) illustrate exemplary display screens in accordance with the embodiment of FIG. 6.

FIGS. 9(a)˜9(d) illustrate exemplary user interfaces for a first job on a display screen in accordance with some embodiments.

FIGS. 10(a)˜10(c) illustrate exemplary user interfaces for switching jobs between a first job and a second job on a display screen in accordance with the embodiment of FIG. 6.

FIGS. 11(a)˜11(c) illustrate exemplary user interfaces for a common job on a display screen in accordance with the some embodiments.

FIGS. 12(a)˜17(b) illustrate exemplary user interfaces for each common job on a display screen in accordance with the some embodiments.

FIG. 18 illustrates an exemplary diagram in accordance with a second embodiment of the present invention.

FIG. 19(a) illustrates an exemplary case to show user experienced access and FIG. 19(b) and FIG. 19(c) illustrate exemplary display screens based on the user experienced access in accordance with the embodiment of FIG. 18.

FIG. 20(a) illustrates another exemplary case to show user experienced access and FIG. 20(b) and FIG. 20(c) illustrate exemplary display screens based on the user experienced access in accordance with the embodiment of FIG. 18.

FIG. 21(a) illustrates another exemplary case to show user experienced access and FIG. 21(b) and FIG. 21(c) illustrate exemplary display screens based on the user experienced access in accordance with the embodiment of FIG. 18.

FIG. 22(a) illustrates another exemplary case to show user experienced access and FIG. 22(b) and FIG. 22(c) illustrate exemplary display screens based on the user experienced access in accordance with the embodiment of FIG. 18.

FIG. 23(a) illustrates another exemplary case to show user experienced access and FIG. 23(b) illustrate an exemplary display screen based on the user experienced access in accordance with the embodiment of FIG. 18.

FIG. 24(a) illustrates another exemplary case to show user experienced access and FIG. 24(b), FIG. 24(c) and FIG. 24(d) illustrate exemplary display screens based on the user experienced access in accordance with the embodiment of FIG. 18.

FIGS. 25(a)˜25(b) illustrate exemplary user interfaces for switching jobs between a first job and a second job on a display screen in accordance with the embodiment of FIG. 18.

FIGS. 26(a)˜26(b) illustrate exemplary user interfaces for switching jobs between a first job and a second job on a display screen in accordance with the embodiment of FIG. 18.

FIGS. 27˜28(c) illustrate exemplary user interfaces for displaying images on a wide display screen in accordance with the some embodiments.

FIGS. 29˜30(b) illustrate exemplary user interfaces for displaying images on a small display screen in accordance with the some embodiments.

FIG. 31 illustrates an exemplary user interface for configuring application groups on a display screen in accordance with the some embodiments.

FIGS. 32(a)˜32(c) illustrate exemplary user interfaces for changing group on a display screen in accordance with the some embodiments.

FIGS. 33(a)˜33(c) illustrate exemplary user interfaces for changing group on a display screen in accordance with the some embodiments.

FIG. 34 is an exemplary diagram in accordance with a third embodiment of the present invention.

FIGS. 35(a)˜38(b) illustrate an exemplary configuration of display screen in accordance with the embodiment of FIG. 34.

FIGS. 39˜41 illustrate an exemplary flow chart in accordance with the embodiment of FIG. 6.

FIGS. 42˜44(b) illustrate an exemplary flow chart in accordance with the embodiment of FIG. 18.

FIGS. 45˜47 illustrate an exemplary flow chart in accordance with the embodiments of FIGS. 6 and 32.

FIGS. 48˜50(b) illustrate an exemplary flow chart in accordance with the embodiments of FIGS. 18 and 32.

FIGS. 51(a), 51(b) and 52 illustrate an exemplary flow chart in accordance with the embodiments of FIGS. 6 and 34.

FIGS. 53˜54(b) illustrate an exemplary flow chart in accordance with the embodiments of FIGS. 18 and 34.

FIGS. 55(a)˜55(c) illustrate exemplary user interfaces for selecting a menu on a display screen in accordance with the some embodiments.

FIGS. 56(a)˜56(c) illustrate exemplary user interfaces for selecting a menu on a display screen in accordance with the some embodiments.

### DETAILED DESCRIPTION OF THE PREFERRED EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms may be used herein to describe various elements, these elements should not be limited by these terms. These terms are only used to distinguish one element from another. The terminology used in the description of the invention herein is for the purpose of describing particular embodiments only and is not intended to be limiting of the invention. As used in the description of the invention and the appended claims, the terms ‘job’ is exemplarily used to indicate an operating application executed by a user or a device so that the image and/or contents operated in the ‘job’ can be displayed on a certain area of a display screen. Thus, in some embodiments, the term ‘job’ can be replaced with the term ‘application’. It will also be understood that the term “and/or” as used herein refers to and encompasses any and all possible combinations of one or more of the associated listed items.

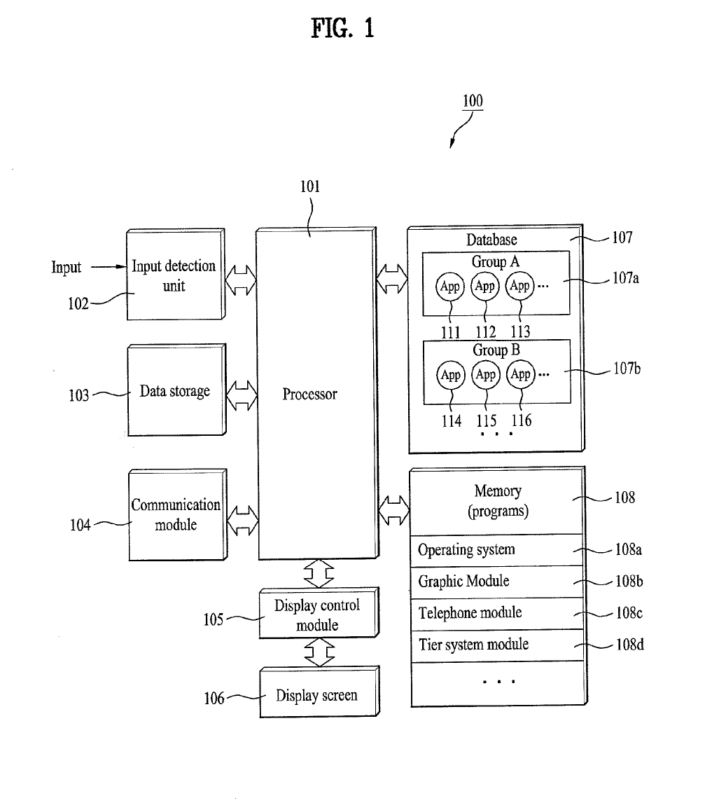

FIG. 1 illustrates a detailed structure of a computing device (100) for supporting a multitasking jobs according to some embodiments of the present invention. As described above, the term “computing device” used in the description of the present invention is broadly used to include existing IT or electronic products as well as a variety of new products that are to be developed in the future.

The computing device (100) according to the embodiments includes a processor (101), an input detection unit (102), a data storage unit (103), a communication module (104), a display control module (105), a display screen (106), a database (107), and a program memory (108). In addition to the above-described structure, although it is not shown in FIG. 1, it is apparent that a variety of other components (or elements), such as a power supply, an audio speaker, a micro phone, a camera, and so on, may be included in the computing device (100). Further, the computing device (100) may include one or more of each of these elements mentioned above.

The input detection unit (102) translates (or analyzes) user commands inputted from an external source and, then, delivers the translated user command to the processor (101). For example, when a specific button provided on the display screen (106) is pressed or clicked, information that the corresponding button has been executed (or activated) (i.e., pressed or clicked) is sent to the processor (101). Also, for example, in case the display screen (106) includes a touch screen module capable of recognizing (or detecting or sensing) a user's touch (i.e., touch-sensitive), when the user performs a touch gesture on the touch screen, the input detection unit (102) analyzes the significance of the corresponding touch gesture, thereby performing a final conversion of the corresponding touch gesture to a user command, thereby sending the converted user command to the processor (101). In another example, the user's input may be received using a proximity sensor, keypad, keyboard, other input unit, etc.

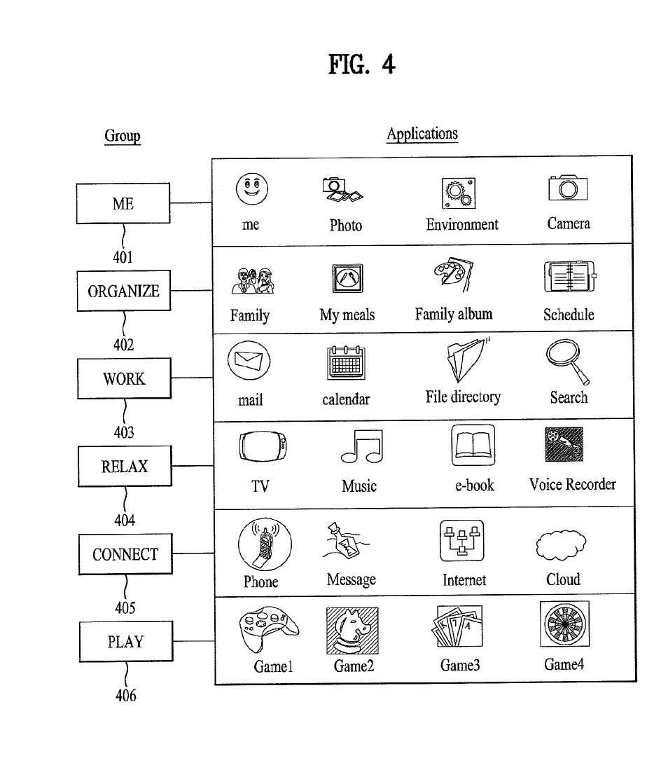

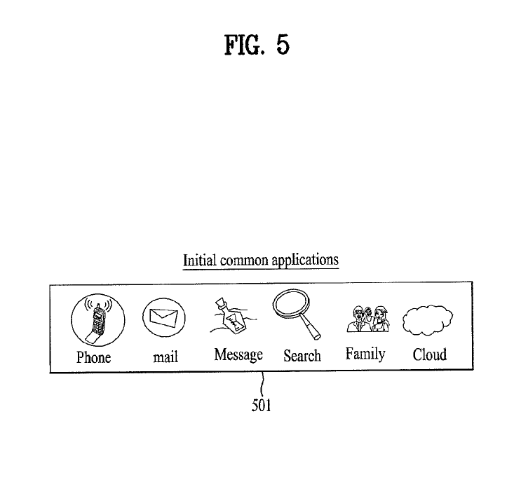

The database (107) is configured to store diverse applications (111, 112, 113, 114, 115, 116, etc.) operating in the computing device (100). For example, the applications can include both applications automatically set-up by the system and applications arbitrarily set-up by the user. Furthermore, the diverse applications may be integrated as a group (107a and 107b) so as to be managed. And, the application group (107a and 107b) may, for example, be automatically grouped by the processor (101) or be arbitrarily grouped and set-up by the user. Herein, more detailed description regarding the application groups will be discussed later at the explanation of FIG. 4 and FIG. 5.

The program memory (108) includes diverse driving programs (e.g., computer software) to operate the computing device (100). For example, the program memory 108 may include an operating system program (108a), a graphic module program (108b), a telephone module program (108c), and a tier-system module program (108d). However, it is apparent that in addition to the above-mentioned programs, other programs may also be included. Most particularly, the tier-system module program (108d) for supporting multitasking jobs is stored in the program memory (108), and the usage of diverse multitasking processes that are to be described later on are realized by having the processor (101) execute the contents programmed by the tier-system module program (108d).

Also, the display screen (106) is configured to perform the function of providing a visual screen to the user, which may be realized by using a variety of methods, such as LCD, LED, OLED, and so on. Moreover, the display screen (106) may further include a touch-sensitive display module (referred to as a “touch screen” for simplicity), which can sense or detect a touching motion (or gesture) of the user. In case of the recently developed portable computing devices (e.g., smart phones, tablet PCs, electronic photo frames, and so on), the adoption of the touch screen is becoming more common for the convenience of the users. An example of applying the above-described touch screen is given in the embodiments, which will be described in detail in the following description of the present invention. However, this is merely exemplary and the technical scope and spirit of the present embodiments will not be limited to the application of touch screens. Furthermore, the display control module (105) physically and/or logically controls the display operations of the display screen (106).

Additionally, the communication module (104) performs the communication between the computing device (100) and an external device or a network. Herein, in case of the computing device (100) according to the embodiments of the present invention, which supports communication functions (e.g., call service, mail service, cloud service and so on), the communication module (104) particularly performs the communication with and/or between the computing device and an external server or a external database, so as to transmit and receive information and contents to and from one another. Various communication methods including wired and wireless communication already exist and can be used herein, and since the details of such communication methods are not directly associated with the present invention, detailed description of the same will be omitted for simplicity.

Also, the data storage unit (103) is configured to temporarily or continuously store data and contents that are used in the computing device (100). Contents that are received or transmitted through the communication module (104) may be also stored on the data storage unit (103) of the computing device (100). The data storage unit (103) can be a built-in storage or a removable storage unit such as a USB or flash memory device.

Furthermore, by driving the programs included in the above-described program memory (108), the processor (101) controls the operations of each element (or component) included in the computing device (100). All components of the computing device (100) are operatively coupled and configured. The computing device (100) can be, e.g., a smart phone, table PC, desktop computer, laptop computer, mobile terminal, pager, MP3 player, navigation device, workshop station, multimedia device, game player, PDA, etc.

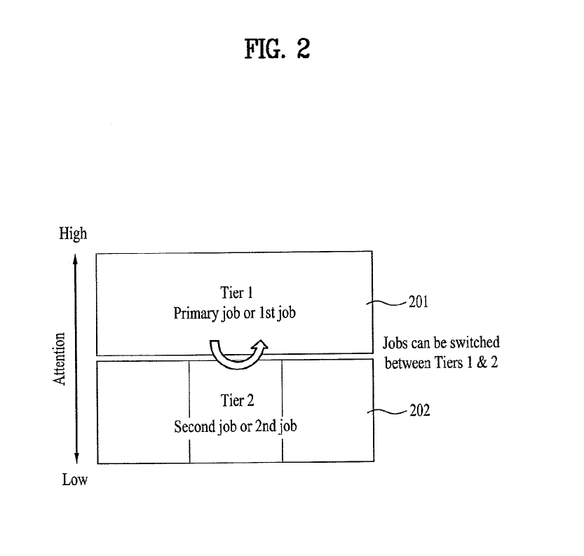

FIG. 2 illustrates an exemplary diagram for explaining multitasking operation in accordance with some embodiments. For convenient multitasking, the present embodiment may classify multitasking jobs into a plurality of job levels (e.g., 2-Tier levels in FIG. 2). The first level (201), referred to as Tier-1 level', relates to or is composed of at least one first job which may be a primary operating job desired by a user or the processor (101). The first job (or a primary job) may be operated by executing a certain application from a certain group. The primary job may be considered a first most important or needed job. The second level (202), referred to as ‘Tier-2 level’, relates to or is composed of at least one second job which may be a secondary operating job determined by the processor (101) which considers correlation between the first job and second job. The second job may be considered a second most important or needed job, or a job is less needed or relevant than the first job. Preferably, the first job may be displayed on a center portion of the display screen (106) for high user attention. In contrast, the second job may be displayed on a side portion (or a hidden portion) of the display screen (106) for lower user attention relatively to the first job. In the embodiment, a user can easily switch jobs between the first job and the second job during a multitasking operation. The more detailed operation and advantage of the 2-Tier levels of the embodiments of the invention will be discussed below by referencing other figures.

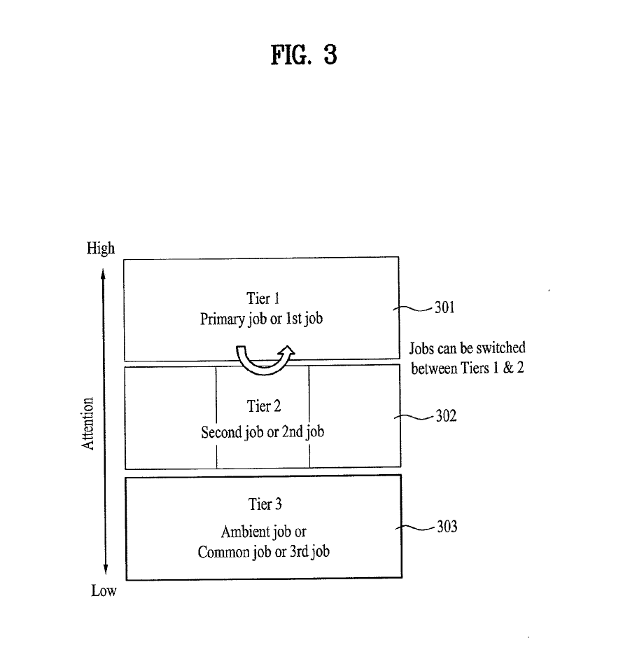

FIG. 3 illustrates an exemplary diagram for explaining multitasking operation in accordance with some embodiments. For convenient multitasking, the present embodiment may classify multitasking jobs into a plurality of job levels (e.g., 3-Tier levels in FIG. 3). The first level (301), referred to as ‘Tier-1 level’, relates to or is composed of at least one first job which may be a primary operating job desired by a user or the processor (101) as like FIG. 2. The second level (302), referred to as Tier-2 level', relates to or is composed of at least one second job which may be a secondary operating job determined by the processor (101) which considers correlation between the first job and second job as like FIG. 2. The third level (303), referred to as Tier-3 level', relates to or is composed of at least one common job (or ambient job) which can be determined as at least one of predetermined common applications (e.g., FIG. 5) preferably excluding the determined second job. The common job may be considered a job that is less important or needed than the first and second jobs, and/or a job that requires a little or no attention from the user. Further, the common job may be displayed in a third area (e.g., global portion) of the display screen (106) for lower user attention relatively to the first job and second job. In some embodiments, the common jobs may be operated without the user attention. The more detailed operation and advantage of the 3-Tier levels above will be discussed below by referencing other figures.

FIG. 4 illustrates an exemplary configuration of initial groups containing applications in accordance with some embodiments. The computing device (100) supports a variety of applications, such as one or more of the following: a telephone application, a music application, an e-mail application, an instant messaging application, a cloud application, a photo management application, a digital camera application, a web browsing (or internet) application, a family hub (simply ‘family’) application, a location application, a game application, a multimedia recording/reproducing application, and so on.

Herein, the embodiments use the term ‘application’ as broad meaning so that the term ‘application’ may include not only programmable application but also device unique widgets and known standard widgets. The various applications that may be executed on the device may use at least one common physical user-interface device, such as the touch screen. One or more functions of the touch screen as well as corresponding information displayed on the device may be adjusted and/or varied from one application to the next and/or within a respective application. In this way, a common physical architecture (such as the touch screen) of the device may support the variety of applications with user interfaces that are intuitive and transparent.

For convenient multitasking jobs, the device (100) may initially classify each application into one of a plurality of groups in consideration of characteristic(s) of each application. However, the group can be modified by a user and also the application classified to the certain group can be changed to another group by the user's intention/input. For example of convenient description, in FIG. 4, the embodiment provide, as an example, 6 groups such as ‘ME, ‘ORGANIZE’, ‘WORK’, ‘RELAX’, ‘CONNECT’, and ‘PLAY’. It is apparent that the embodiment has not been limited to the specific group name and group application.

For example, the group ‘ME’ (401) may include applications that relate to a personalized experience unique to the specific user. The exemplary applications included in the group ‘ME’ (401) may be a ‘me’ application, a ‘photo’ application, an ‘environment’ application, and a ‘camera’ application.

For example, the group ‘ORGANIZE’ (402) may include applications that focus on life management activities like my/family schedule and planning meals. The exemplary applications included in the group ‘ORGANIZE’ (402) may be a ‘family’ application, a ‘My meals’ application, a ‘Family album’ application, and a ‘schedule’ application.

For example, the group ‘WORK’ (403) may include applications that focus on productivity tools. The exemplary applications included in the group ‘WORK’ (403) may be a ‘mail’ application, a ‘search’ application, a ‘file directory’ application, and a ‘calendar’ application.

For example, the group ‘RELAX’ (404) may include applications that give an opportunity to focus on relaxation without distraction. The exemplary applications included in the group ‘RELAX’ (404) may be a TV ‘application, a ‘music’ application, a ‘e-book’ application, and a ‘voice recorder’ application.

For example, the group ‘CONNECT’ (405) may include applications that focus on communications and social networking and give quick and easy access to all communication tools and contacts. The exemplary applications included in the group ‘CONNECT’ (405) may be a ‘phone’ application, a ‘message’ application, a ‘internet’ application, and a ‘cloud’ application.

For example, the group ‘PLAY’ (406) may include applications that focus on games and other fun applications. The exemplary applications included in the group ‘PLAY’ (406) may be a plurality of ‘game’ applications as like as depicted in FIG. 4, a ‘game1’ application, a ‘game2’ application, a ‘game3’ application, and a ‘game4’ application.

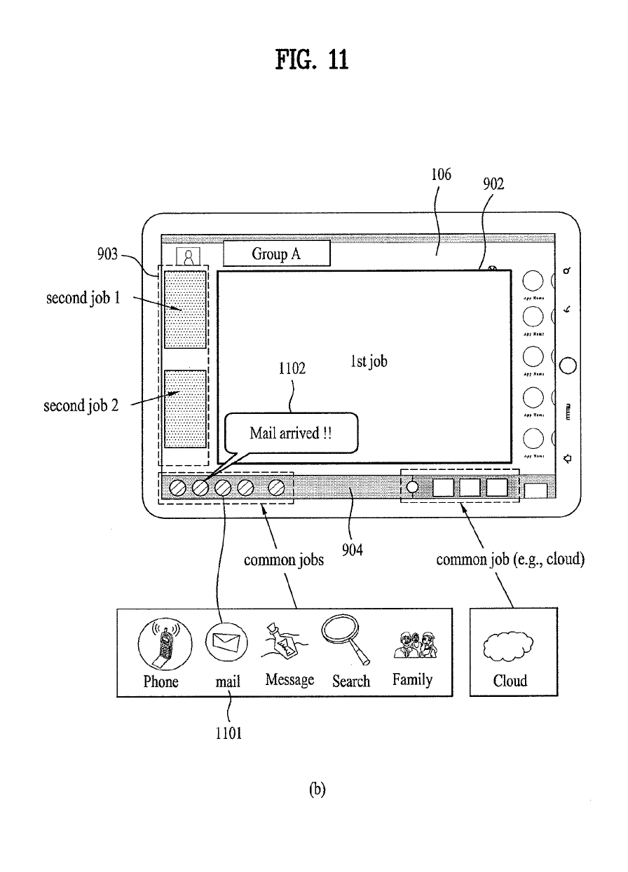

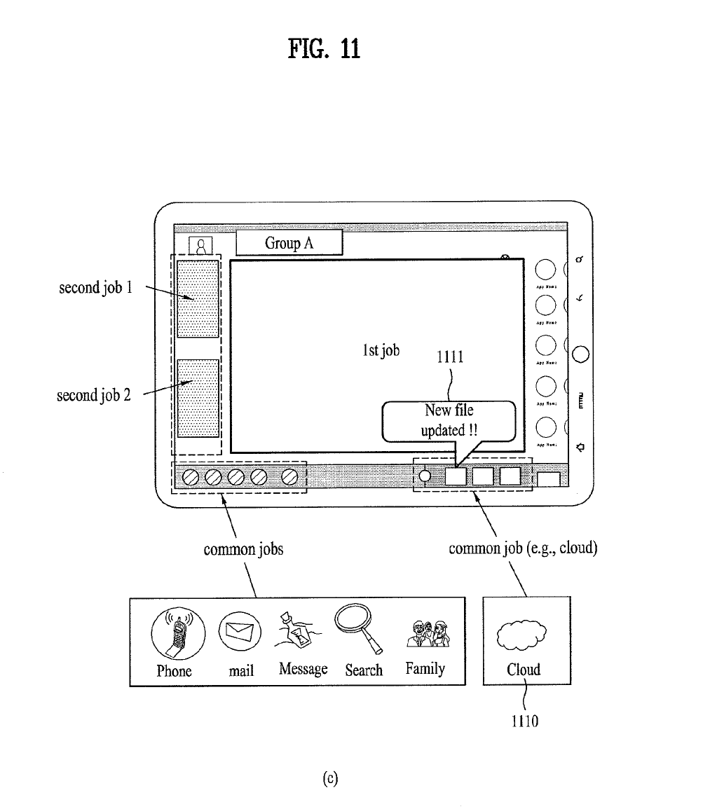

FIG. 5 illustrates an exemplary configuration of initial common applications in accordance with some embodiments. The computing device (100) may initially select common applications (501) from a plurality of applications of FIG. 4. The selected common applications (501) may include applications that focus on an ambient activity requiring almost no or little attention from the user. In this regard, the common applications/jobs may be considered ambient jobs. Often times, a user can not or may not even recognize this as a job. As shown in FIG. 3, the common applications can be operated as common jobs, such as ‘Tier-3’ level. The exemplary applications included in the common applications (501) may be a ‘phone’ application, a ‘mail’ application, ‘message’ application, a ‘search’ application, a ‘family’ application, and a ‘cloud’ application. The applications included in the common applications (501) may be changed or modified to other applications desired by a user. For instance, the user can decide and pick which application among the available applications can be part of the common applications. The detailed description of each common application will be followed later by referencing FIGS. 11(a)˜17(b).

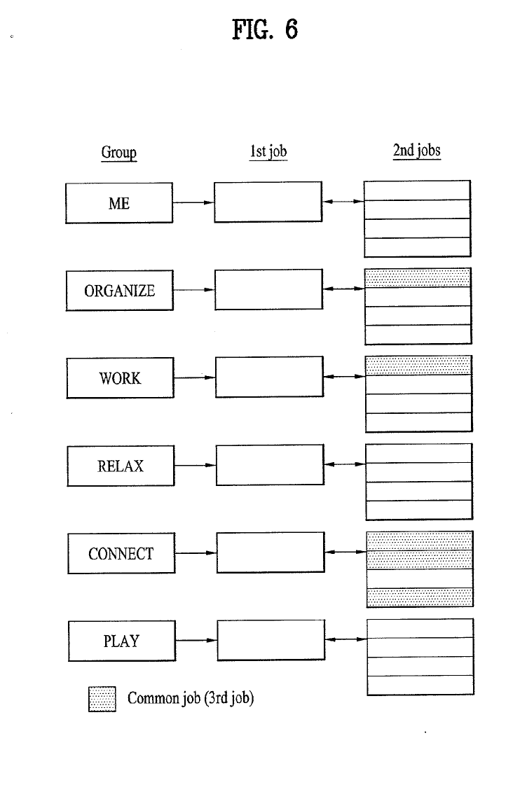

FIG. 6 illustrates an exemplary diagram in accordance with a first embodiment of the present invention. In particular, FIG. 6 shows one embodiment of configuring correlation between the first job and the second job (and/or common jobs). When the first job is determined from a certain group (e.g., group of applications) by a user or a system (e.g., processor (101)), the second job can be determined in the same group containing the first job. The second job is determined as a job which was recently accessed by a user in the same group. That is, in this embodiment, both the first job and the second job are included in the same group. For example, if a certain application is executed by a user command represented by the user's gesture on a touch screen or remote control through a remote controller, the processor (101) can interpret the user command through the input detection unit (102) as operating the application as the first job. And then the processor (101) identifies or determines the second job which was recently accessed by the user in the same group containing the first job. Next, the processor (101) identifies or determines the common job as one of predetermined common applications (501) except the first and second job. For instance, for each group (e.g., “ME’, “ORGANIZE”, etc.), one or more applications belonging to that group can be designated as the first job(s), and one or more applications belonging to the same group can be designated as the second job (b). Additionally or optionally, one or more applications belonging to the same group can be designated as the common job(s). It is preferred that a single application be designated as the first job.

In particular, for example, the processor (101) may perform the operating process of the first job based on a complete running process, the operating process of the second job based on a partial running process, and the operating process of the common job based on a background running process. The complete running can be one of execution processes to invoke higher user attention, which is related to performing the first job with the main screen portion. The partial running can be one of execution processes to invoke lower user attention than the complete running, which is related to performing the second job with a half screen or hidden screen. The background running can be one of execution processes without user attention, which is related to performing the common job within a common area in the screen.

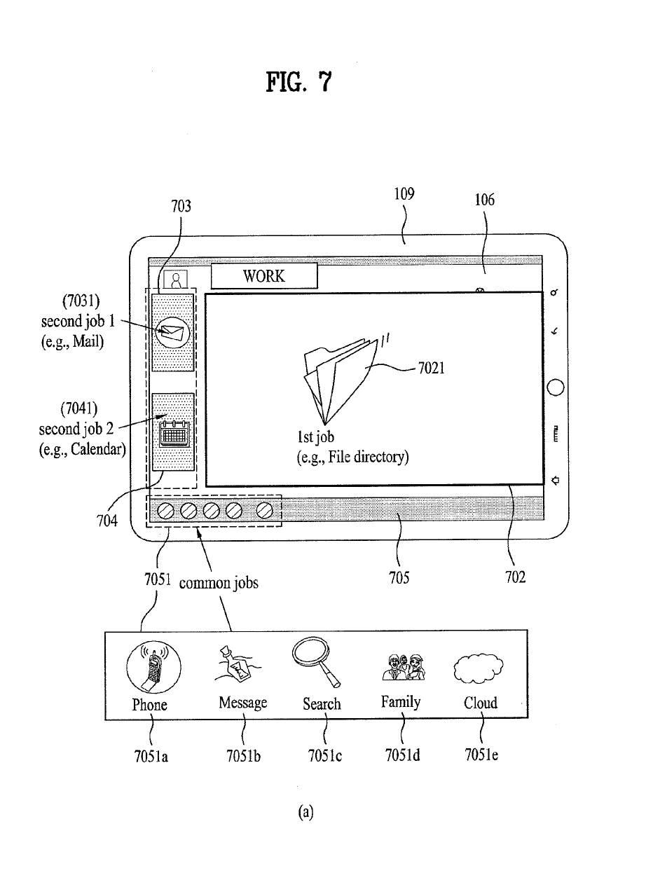

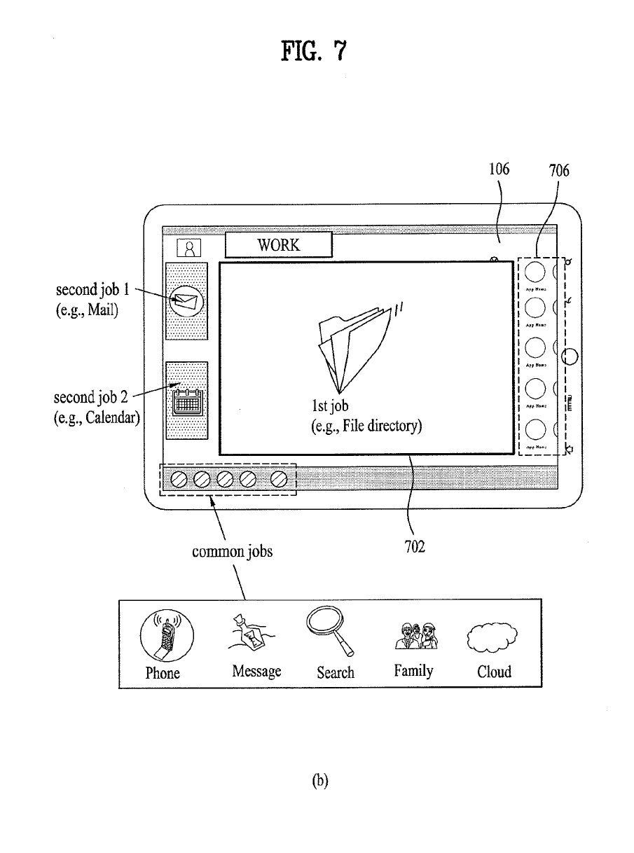

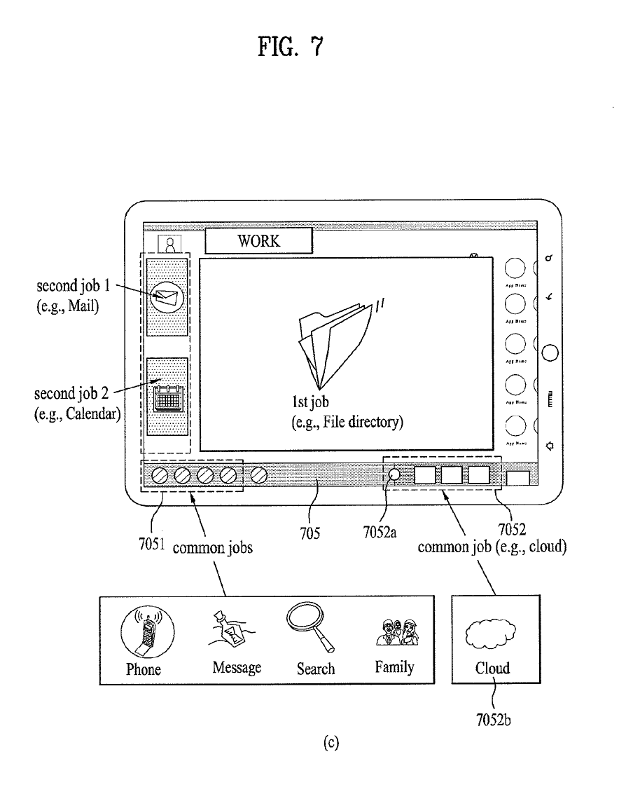

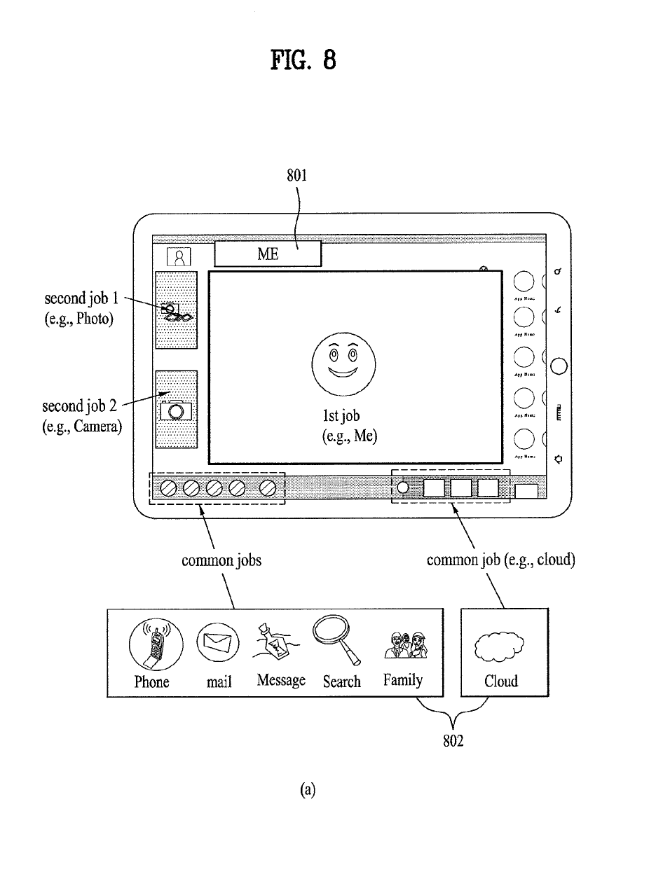

FIGS. 7(a)˜7(c) illustrate an exemplary display screen in accordance with the embodiment of FIG. 6.

FIG. 7(a) shows an exemplary display screen of the computing device (100) in accordance with the embodiment. The device (100) may be configured to include a display screen (106) and a frame (109) surrounding the outer surface of the display screen (106). However, a structure having only the display screen (106) without the frame (109) may also be possible, and any other type of display screen may be used. The display screen (106) includes a first area or a main display area (702) configured to display the first job that is currently being executed by a user or the processor (101). Normally, the first area (702) occupies a center or middle portion of the display screen (106) so that the user can easily view the first area.

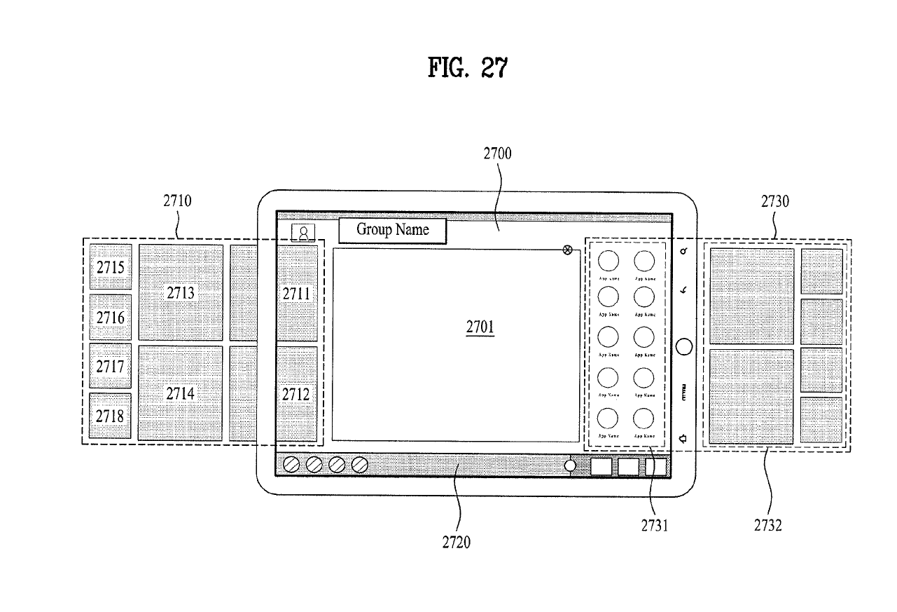

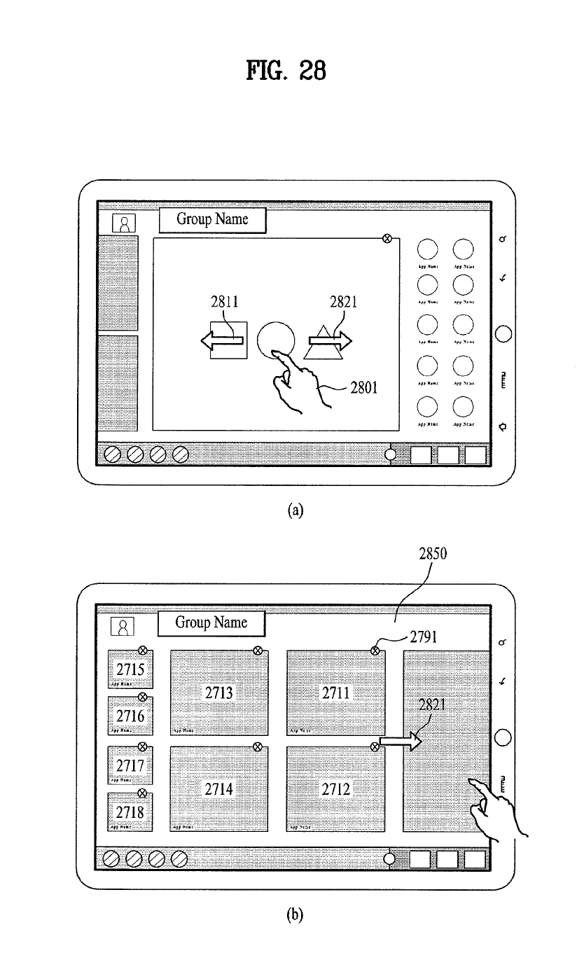

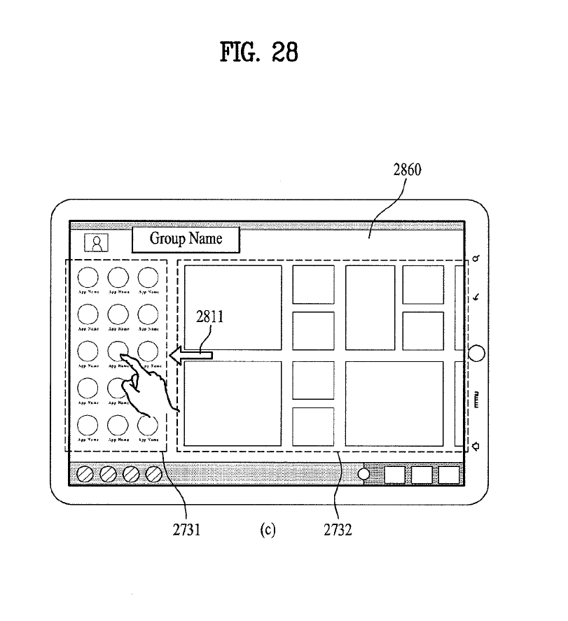

Further, the display screen (106) includes a second area or a sub display area (703, 704) configured to display the determined second job. For example, although FIG. 7(a) illustrates two second areas (703, 704), the embodiment has not been limited to any fixed number of second area. That is, the number of second areas (e.g., one second area or two or more second areas) can be predetermined or modified by the default system environment or user's selection at an initial environment stage or any subsequent stage. Normally, the second areas (703, 704) may occupy a side portion (e.g., left area adjoining the first area (702)) of the display screen (106) so that the user can easily recognize the existence of the second area. Alternatively, in some embodiment, the second areas (703, 704) can occupy a hidden portion of the display screen (106) so that the user can recognize the existence of the second areas with a user gesture of swiping the display screen. Through FIG. 27 to FIG. 28(c), the second areas (703, 704) occupying a hidden portion of the display screen (106) will be discussed in details.

Furthermore, the display screen (106) includes a third area or a global area (705) configured to display the determined common jobs. For example, FIG. 7(a) illustrates the global area (705) positioned at a bottom portion of the display screen (106) as like a bar type formed to horizontal rectangular. In the global area (705), for example, the icon (7051) representing the common applications may be displayed on the left side of global area (705).

Referring to FIG. 7(a), for example, it assumes that the file directory application (7021) is operated as a first job from the group ‘WORK’ (701, 403 in FIG. 4), the processor (101) controls the first job to be displayed on the first area (702) and also the processor (101) determines second jobs and common jobs to be displayed on the second areas (703, 704) and the global area (705), respectively. For the process above, the processor (101) firstly determines two second jobs which were recently accessed by a user in the same group ‘WORK’ (701, 403 in FIG. 4). The determined second jobs are displayed on the second areas (703, 704), respectively. In particular, for example, the processor (101) controls the most recent access application (7031, e.g., ‘mail’ application) to be displayed on an upper positioned second area (703), and next recent access application (7041, e.g., ‘calendar’ application) to be displayed on a lower positioned second area (704). Alternatively, a size of displaying the upper positioned second area (703) can be larger than that of the lower positioned second area (704).

Further, the processor (101) finally determines common jobs from the predetermined common applications (501) excluding the applications corresponding to the first and second job. In case of this example, the ‘mail’ application is already determined as one of the second jobs, thus common applications operating as common jobs are determined to other common applications (7051a˜7051e) except the ‘mail’ application in the predetermined common applications (501) since the ‘mail’ application is already the second job.

FIG. 7(b) shows another exemplary display screen of the computing device (100) in accordance with the embodiment. Compared with FIG. 7(a), FIG. 7(b) further includes a fourth area (706). In this embodiment, the processor (101) controls the display control module (105) to display clipped content and widgets in the fourth area (706) of the display screen (106). The clipped content and widgets displayed in the fourth area (706) do not include the multitasking jobs until the user executes the content and widgets. For example, the fourth area (706) may be positioned at a right side adjoining the first area (702).

FIG. 7(c) shows another exemplary display screen of the computing device (100) in accordance with the embodiment. Compared with FIG. 7(a), FIG. 7(c) further includes a cloud navigation area (7052) in the global area (705). The cloud navigation area (7052) may include a cloud application (7052a) that supports cloud services as one of common jobs. Further, the cloud navigation area (7052) includes a cloud icon (7052b) for at least providing cloud services to the user. The cloud service is capable of providing all types of IT-associated services. For cloud services, an external cloud server and cloud database are provided. The cloud server may be configured to operate the cloud services, and the cloud database may be configured to store diverse contents existing in the cloud services. A plurality of individual devices including the disclosed computing device (100) are subscribed to the cloud services. Then, a user using such a computing device may be capable of using diverse contents (simply referred to as “cloud contents”) stored in the cloud database. Herein, the cloud contents include not only contents (or documents) personally created and uploaded by a computing device user but also contents (or documents) created or provided by other shared users or internet service providers. Therefore, a user of computing device according to the invention may be capable of sharing and using the diverse cloud contents stored in the cloud database through the cloud services regardless of time and location. In this embodiment, the display control module (105) displays the common jobs within the global area (705). At that time, if the cloud application will be included as one of the common jobs, the processor (101) may control the cloud application to be displayed in the cloud navigation area (7052) separately from other common job display area (7051) in the global area (705).

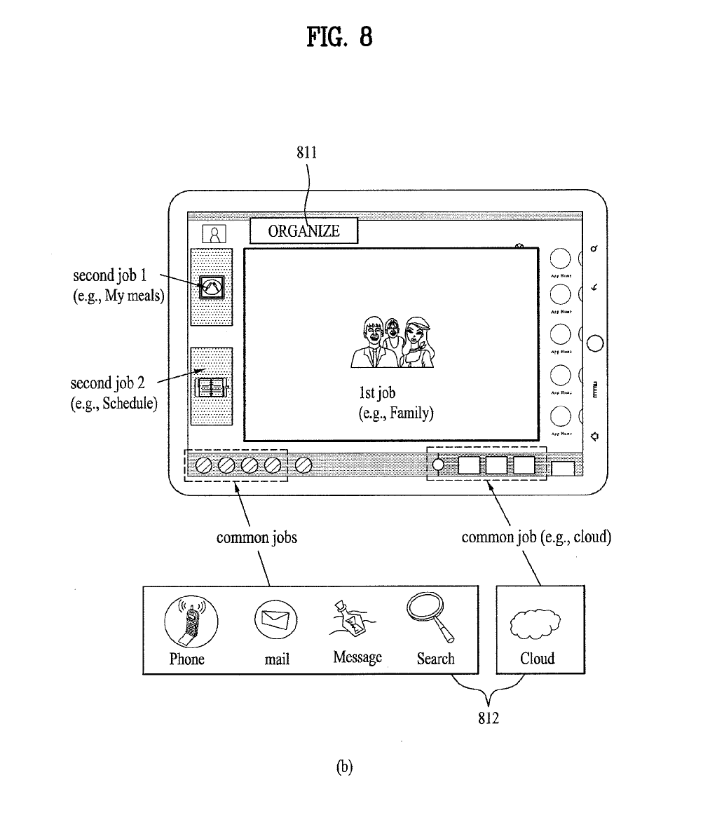

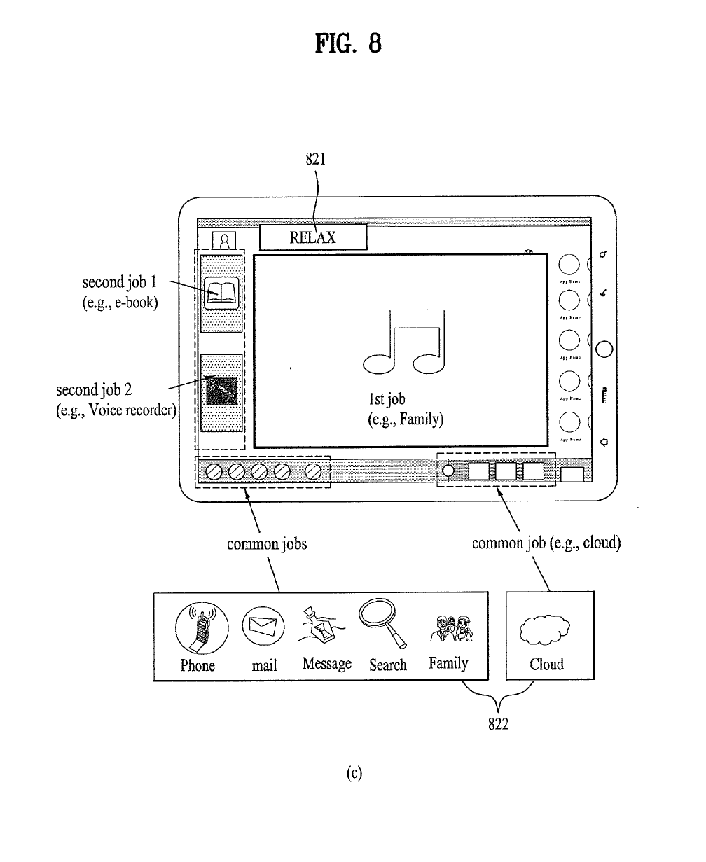

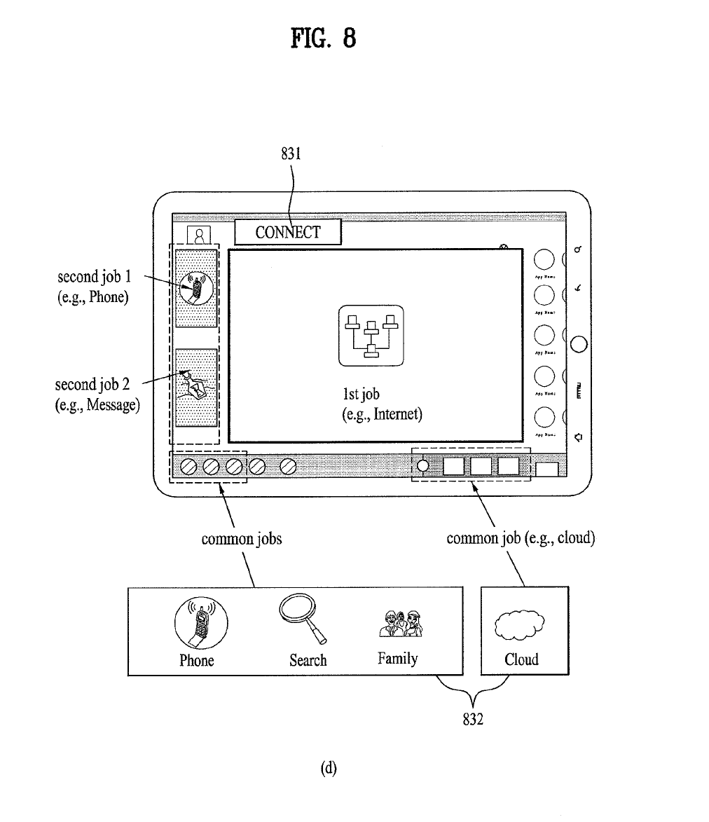

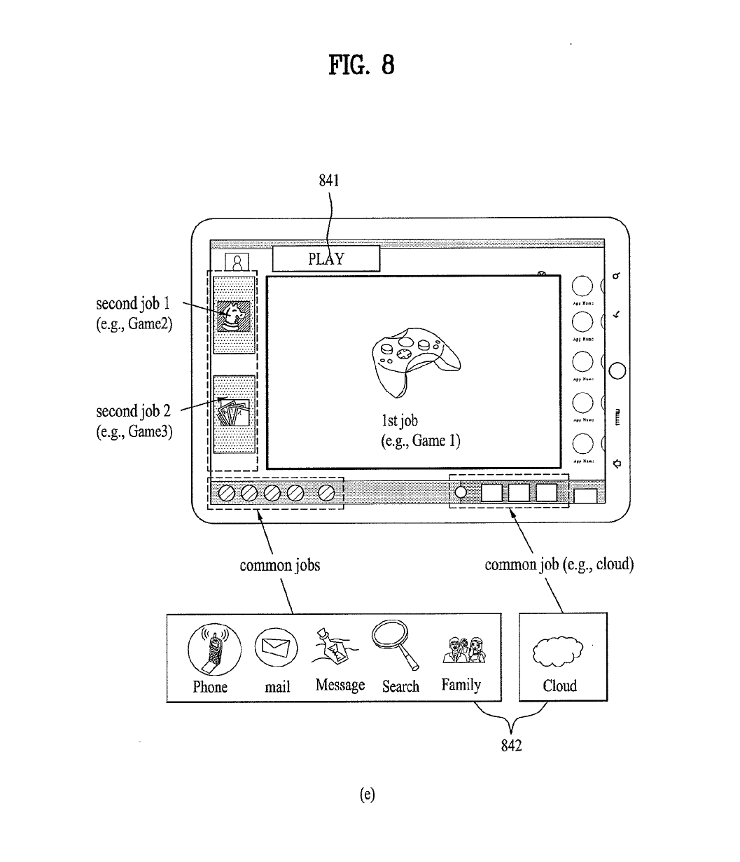

FIGS. 8(a)˜8(e) illustrate an exemplary display screen in accordance with the embodiment of FIG. 6. Compared with FIG. 7, FIGS. 8(a)˜8(e) illustrate an exemplary display screen applied to other groups.

FIG. 8(a) illustrates an exemplary display screen applied to ‘ME’ group (801, 401 in FIG. 4). If one of the applications included in the ‘ME’ group (801) is executed as a first job (e.g., ‘me’ application), the recent access applications by a user in the same ‘ME’ group (801) are determined as second jobs (e.g., ‘photo’ application and ‘camera’ application) by the processor (101). The processor (101) further determines common jobs in the predetermined common applications (501) excluding the applications corresponding to the first and second jobs. In case of this example, since none predetermined common applications are applied to the first and second jobs, all predetermined common applications (501 in FIG. 5) may be determined and operated as common jobs (802).

FIG. 8(b) illustrates another exemplary display screen applied to ‘ORGANIZE’ group (811, 402 in FIG. 4). If one of the applications included in the ‘ORGANIZE’ group (811) is executed as a first job (e.g., ‘family’ application), the recent access applications by a user in the same ‘ORGANIZE’ group (811) are determined as second jobs (e.g., ‘my meals’application and ‘schedule’ application) by the processor (101). The processor (101) further determines common jobs in the predetermined common applications (501) excluding the applications corresponding to the first and second jobs. In case of this example, since the ‘family’ application is already determined as the first job, common applications operating as common jobs are determined to be other common applications (812) excluding the ‘family’ application, from the predetermined common applications (501 in FIG. 5).

FIG. 8(c) illustrates another exemplary display screen applied to ‘RELAX’ group (821, 404 in FIG. 4). If one of the applications included in the ‘RELAX’ group (821) is executed as a first job (e.g., ‘music’ application), the recent access applications by a user in the same ‘RELAX’ group (821) are determined as second jobs (e.g., ‘e-book’ application and ‘voice recorder’ application) by the processor (101). The processor (101) further determines common jobs in the predetermined common applications (501 in FIG. 5) excluding the applications corresponding to the first and second jobs. In case of this example, since none predetermined common applications are applied to the first and second jobs, all predetermined common applications (501 in FIG. 5) may be determined and operated as common jobs (822).

FIG. 8(d) illustrates another exemplary display screen applied to ‘CONNECT’ group (831, 405 in FIG. 4). If one of the applications included in the ‘CONNECT’ group (831) is executed as a first job (e.g., ‘internet’ application), the recent access applications by a user in the same ‘CONNECT’ group (831) are determined as second jobs (e.g., ‘phone’application and ‘message’ application) by the processor (101). The processor (101) further determines common jobs from the predetermined common applications (501 in FIG. 5) excluding the applications corresponding the first and second jobs. In case of this example, since the ‘phone’ application and ‘message’ application are already determined as the second jobs, common applications operating as common jobs are determined to other common applications (832) excluding the ‘phone’ and ‘message’ applications, from the predetermined common applications (501 in FIG. 5).

FIG. 8(e) illustrates another exemplary display screen applied to ‘PLAY’ group (841, 406 in FIG. 4). If one of the applications included in the ‘PLAY’ group (841) is executed as a first job (e.g., ‘game1’ application), the recent access applications by a user in the same ‘PLAY’ group (841) are determined as second jobs (e.g., ‘game2’ application and ‘game3’ application) by the processor (101). The processor (101) further determines common jobs from the predetermined common applications (501 in FIG. 5) excluding the applications corresponding to the first and second jobs. In case of this example, since none predetermined common applications are applied to the first and second jobs, all predetermined common applications (501 in FIG. 5) may be determined and operated as common jobs (842).

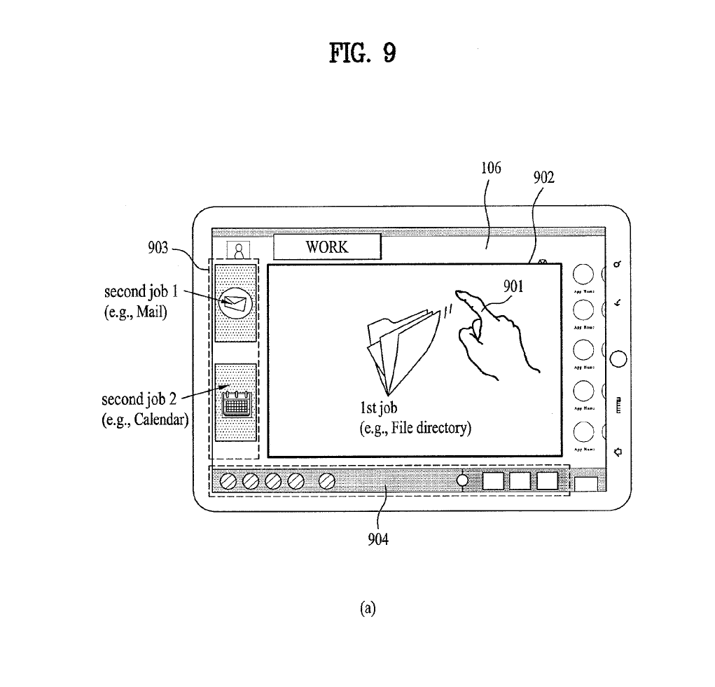

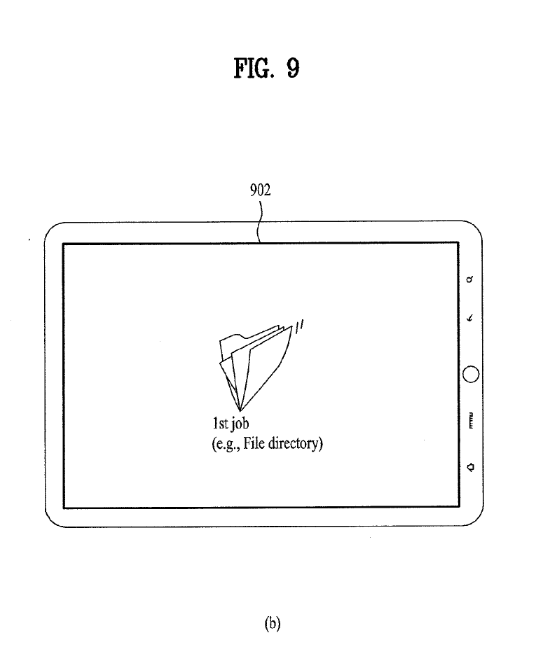

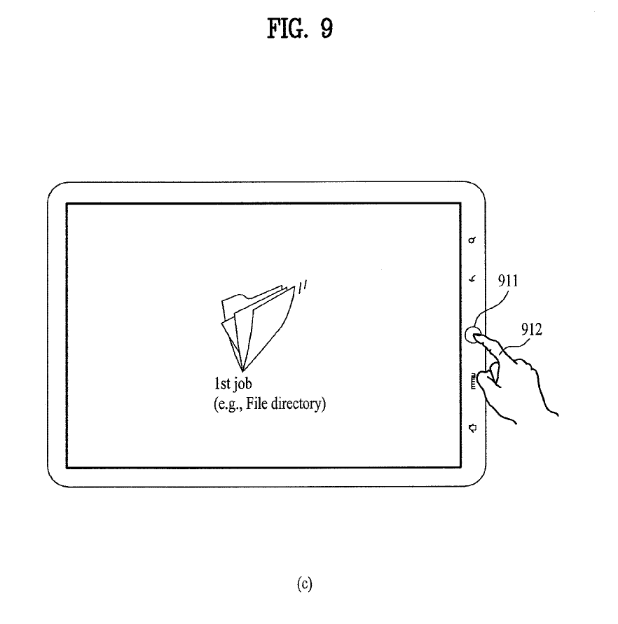

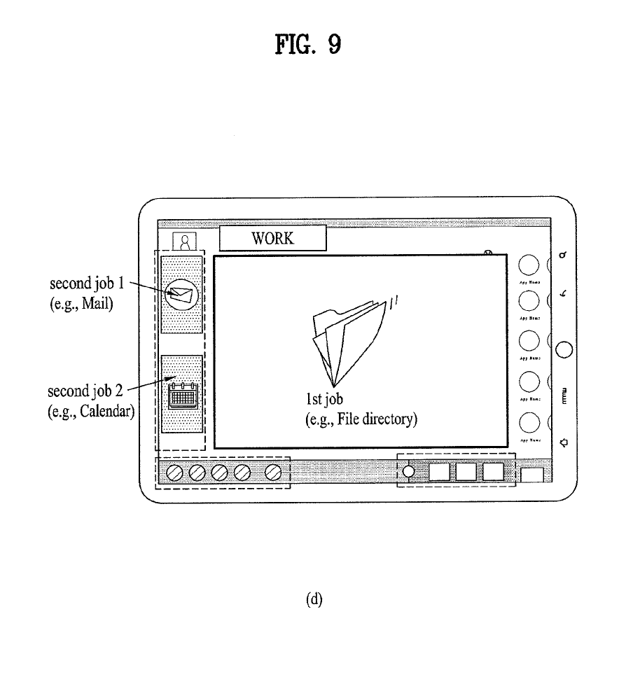

FIGS. 9(a)˜9(d) illustrate exemplary user interfaces for a first job on a display screen in accordance with some embodiments. FIG. 9(a) illustrates a display screen (106) including a first area (902) for displaying a first job, a second area (903) displaying at least one second job, and a third area (904) displaying common jobs as disclosed in FIG. 7(a)˜7(c). For simplicity, a display state of FIG. 9(a) can be referred to a ‘home environment screen’. From the home environment screen of FIG. 9(a), if a user gesture (901), for example double touching the first job screen, is detected, the processor (101) controls an image of the first job (902) to be displayed with a full size in the display screen (106) as depicted in FIG. 9(b). From a display state of FIG. 9(b), if a user gesture (912), for example pressing a home button (911), is detected as depicted in FIG. 9(c), the processor (101) controls the display screen to be returned to the home environment screen as depicted in FIG. 9(d). The location and/or type of the home button (911) (or selectable item) in this or other embodiments or examples can be varied.

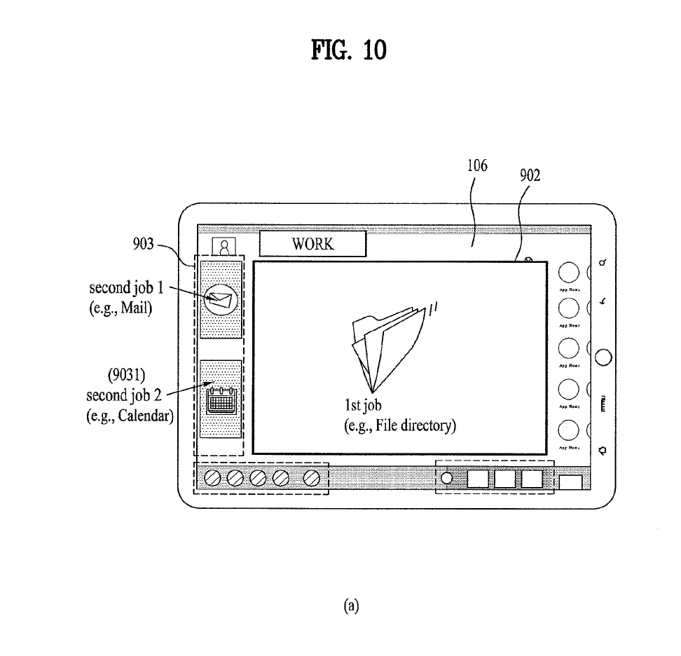

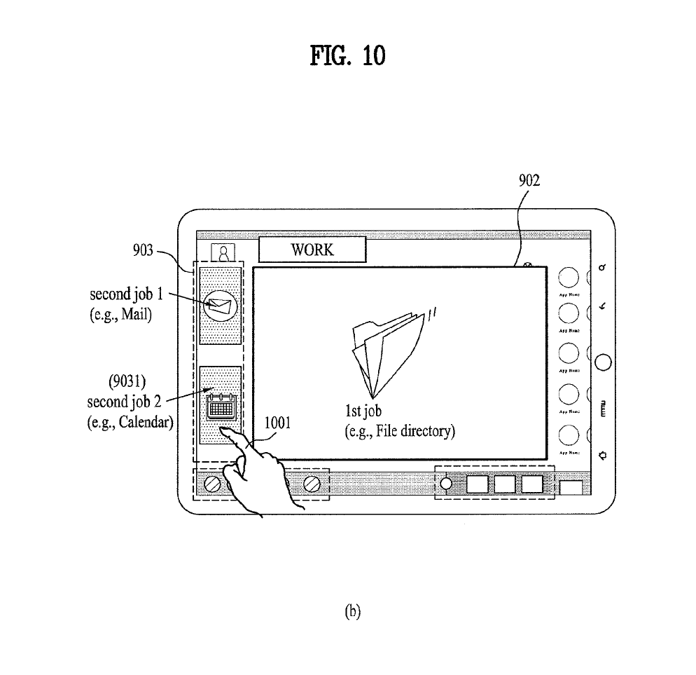

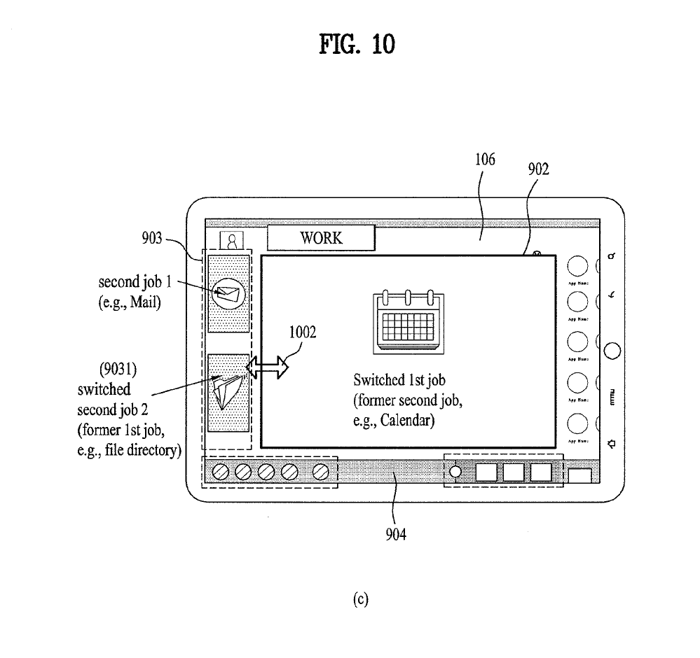

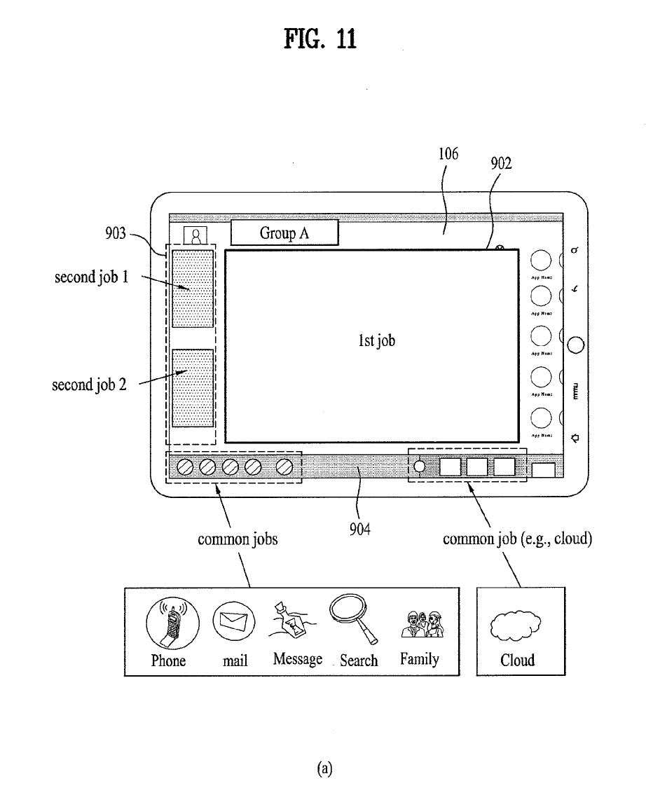

FIGS. 10(a)˜10(c) illustrate exemplary user interfaces for switching jobs between a first job and a second job on a display screen in accordance with the embodiment of FIG. 6. FIG. 10(a) illustrates the home environment screen having a display screen (106) including a first area (902) for displaying a first job, a second area (903) displaying at least one second job, and a third area (904) displaying common jobs as disclosed in FIG. 9(a). From the home environment screen of FIG. 10(a), if a user gesture (1001), for example double touching one of the at least one second job screen (9031), is detected, the processor (101) recognizes the user gesture as a command of jobs switching process between the first job (902) and the touched second job (9031) as depicted in FIG. 10(b) and switches the jobs as shown in FIG. 10(c). The user's request for the jobs switching process can be entered in various ways. Further, the jobs can be switched automatically once the user gestures the command for the job switching, or can be switched by the user dragging the selected second job to the first job area.

FIG. 10(c) illustrates a display screen (106) after the jobs switching process (1002) is completed. For example, during the jobs switching process (1002) is operating, the processor (101) controls the display control module (105) to display the switched first job (former second job) at the first area (902) of the display screen (106). Also, for example, during the jobs switching process (1002) is operating, the processor (101) controls the display control module (105) to display the switched second job (former first job) at the second area (903) of the display screen (106). Consequently, after the jobs switching process (1002) is completed, the display areas associated with the first job area (902) and the touched second job area (9031) may only be exchanged the position each other. In contrast, in this embodiment, the other areas (e.g., remain second area (9032) and third area (904) for displaying the common jobs) do not change the position in the display screen (106).

FIGS. 11(a)˜11(c) illustrate exemplary user interfaces for a common job on a display screen in accordance with the some embodiments.

FIG. 11(a) illustrates a display screen (106) including a first area (902) for displaying a first job, a second area (903) displaying at least one second job, and a third area or a global area (904) displaying common jobs including all predetermined common applications (501 in FIG. 5). From a display state of FIG. 11(a), if one of common jobs has been updated from a new update event, the processor (101) may provide a user with a guide message to indicate the updated event within a portion of the display screen (106).

For example, referring to FIG. 11(b), if the ‘mail’ common application (1101) receives a new mail from an external transmitter or server, the processor (101) controls the display control module (105) to display a popup window message (1102) to provide a user with an alarm message of receiving the new mail positioned at an upper portion of the global area. Also, for example, referring to FIG. 11(c), if the ‘cloud’ common application (1110) receives a new updated file from an external cloud server, the processor (101) controls the display control module (105) to display a popup window message (1111) to provide a user with an alarm message of receiving the updated file from the external cloud server positioned at an upper portion of the global area. Furthermore, for example, the popup window message (1102, 1111) can be displayed in a short time, such that after a predefined time is lapsed without any user action, the popup window message (1102, 1111) can be disappeared from the screen (106).

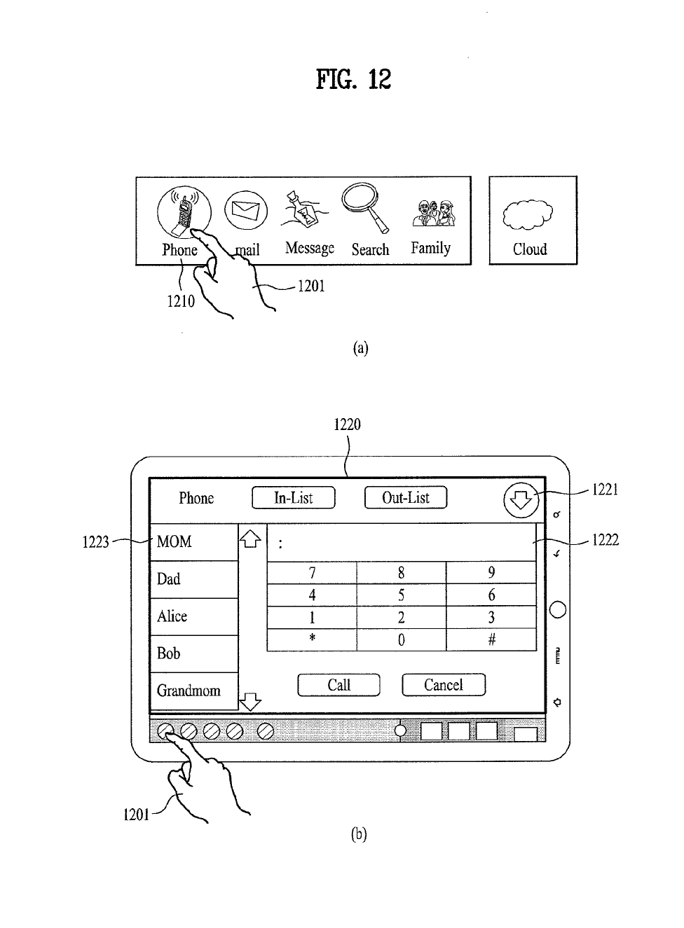

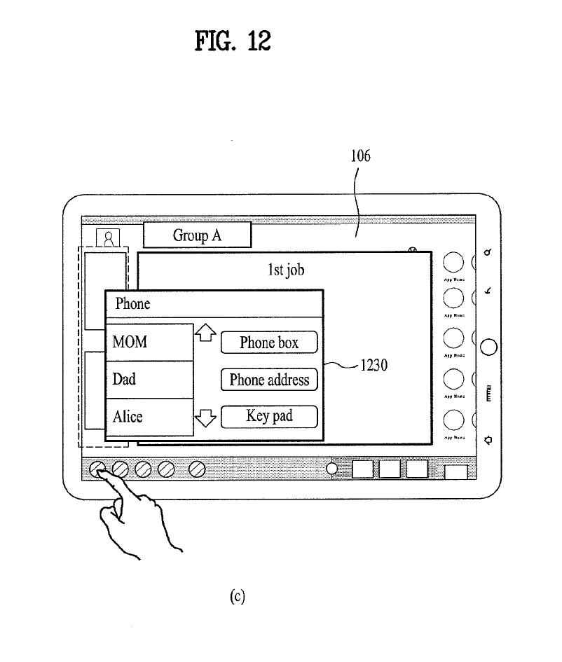

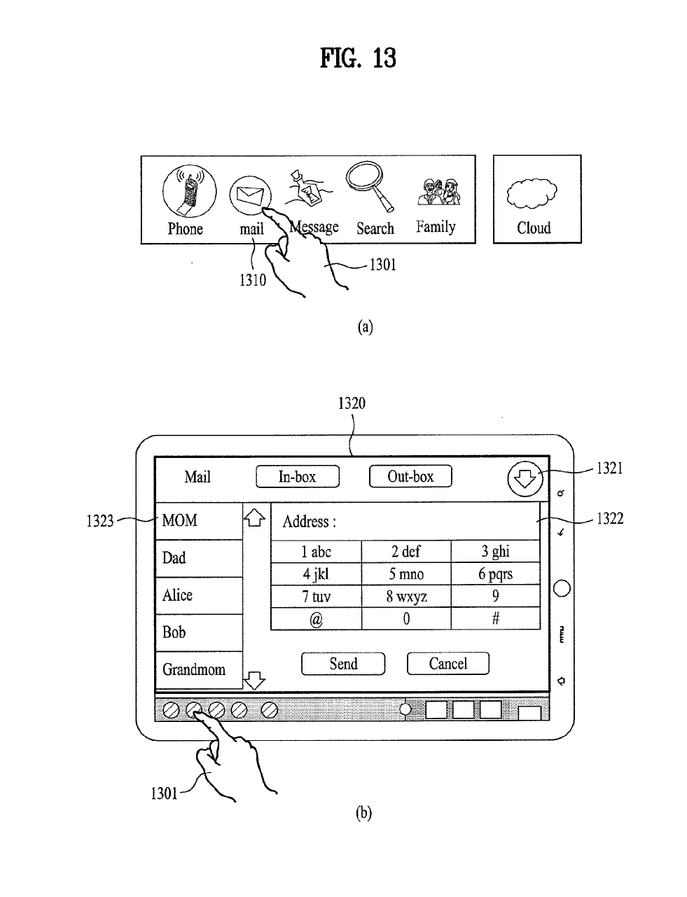

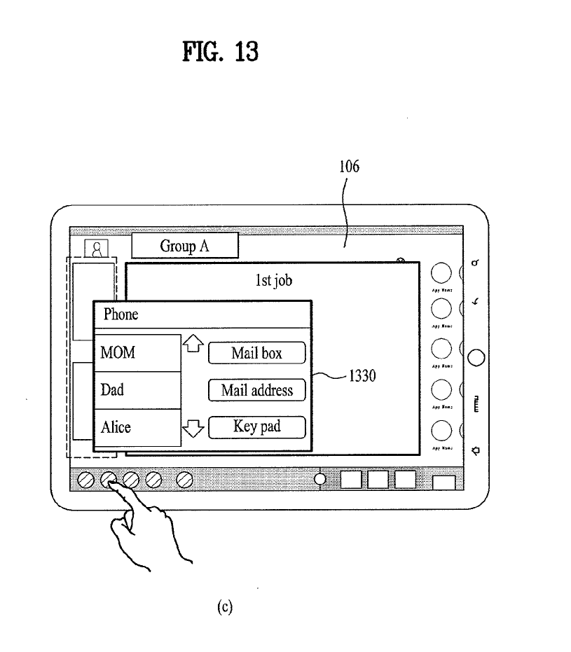

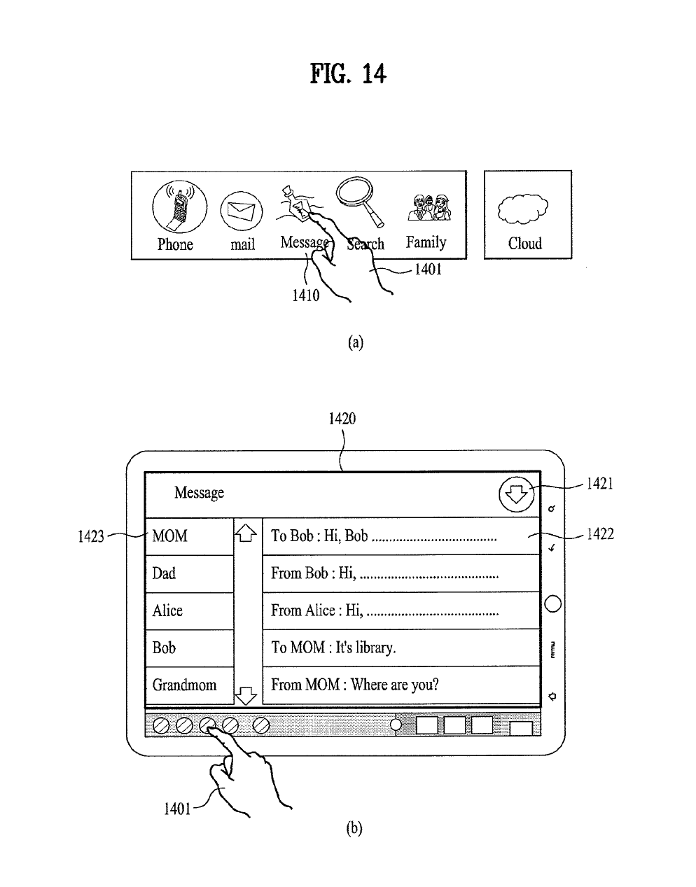

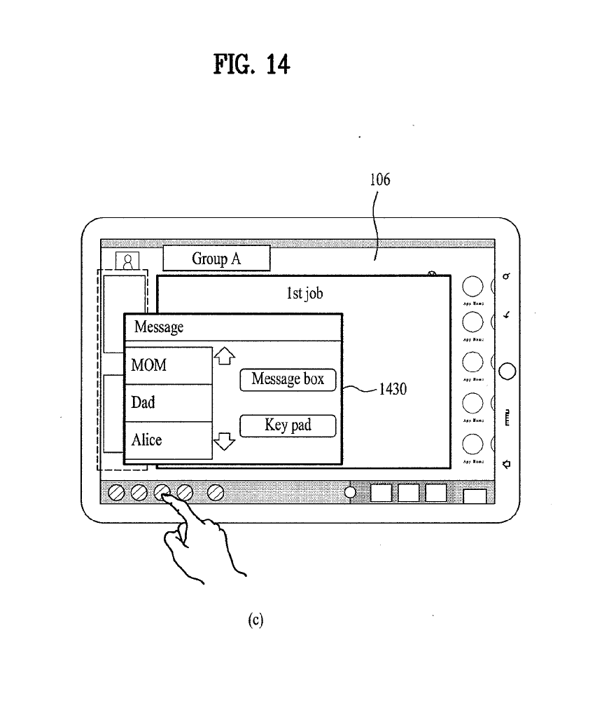

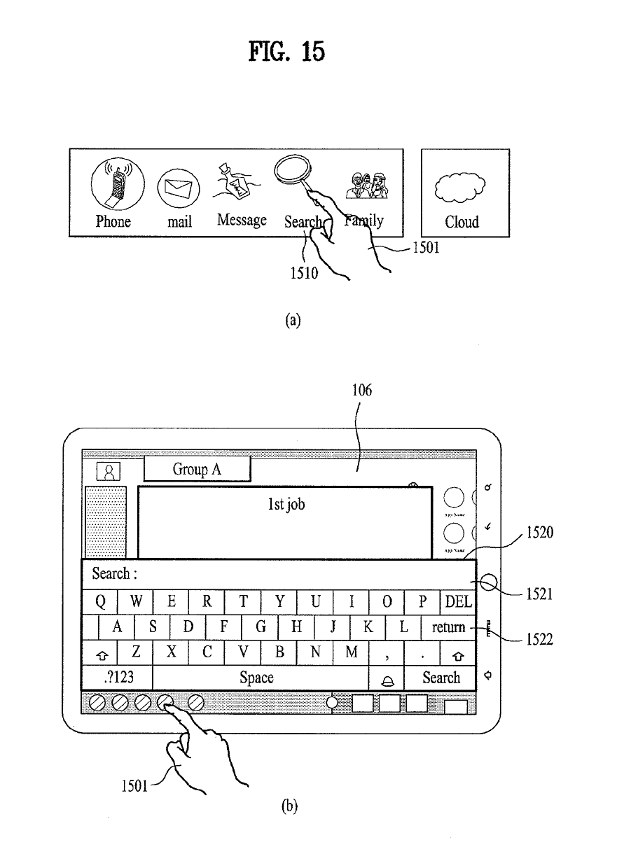

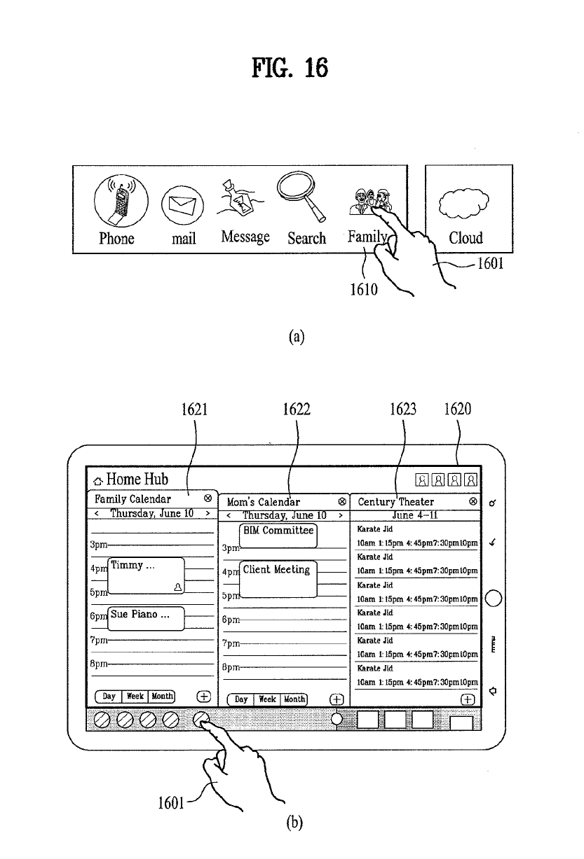

FIGS. 12(a)˜17(b) illustrate exemplary user interfaces for each common job on a display screen in accordance with the some embodiments.

FIGS. 12(a) and 12(b) illustrate exemplary user interfaces for a ‘phone’ application as a common job on a display screen in accordance with the some embodiments. if a user gesture (1201) for operating the ‘phone’ application, for example single touching an icon (1210) representing the ‘phone’ application as a common job on the screen (106), is detected, the processor (101) recognizes the user gesture as a command of displaying an image screen of operating the ‘phone’ application and display the image screen (1220) of the ‘phone’ application to be overlapped with the display screen (106) with a full size window. In the full size image screen (1220) of the ‘phone’ application, for example, a close icon (1221) may be equipped on a right upper corner of the screen (1220). If a user gesture for closing the screen (1220), for example single touching the close icon (1221), is detected, the processor (101) controls to close the screen (1220) and return to a previous display screen (106). Furthermore, a plurality of function icons and/or buttons (e.g., a screen key pad (1222) and a contact list (1223)) may be displayed on the full size image screen (1220) of the ‘phone’ application.

Alternatively, in other example for configuring an image screen of the ‘phone’ application, FIG. 12(c) illustrates an example of the image screen (1230) of the ‘phone’ application overlapped with the display screen (106) with a partial size window. For example, in the partial size image screen (1230) of the ‘phone’ application, the close icon (1221) of FIG. 12(b) may not be equipped on the screen (1230). Thus, it can be allowed that the partial size image screen (1230) can be displayed only in a short time, such that after a predefined time is lapsed without any user action, the partial size image screen (1230) can be disappeared from the screen (106).

FIGS. 13(a) and 13(b) illustrate exemplary user interfaces for a ‘mail’ application as a common job on a display screen in accordance with the some embodiments. if a user gesture (1301) for operating the ‘mail’ application, for example single touching an icon (1310) representing the ‘mail’ application as a common job on the screen, is detected, the processor (101) recognizes the user gesture as a command of displaying an image screen of operating the ‘mail’ application and display the image screen (1320) of the ‘mail’ application to be overlapped with the display screen (106) with a full size window. In the full size image screen (1320) of the ‘mail’ application, for example, a close icon (1321) may be equipped on a right upper corner of the screen (1320). If a user gesture for closing the screen (1320), for example single touching the close icon (1321), is detected, the processor (101) controls to close the screen (1320) and return to a previous display screen (106). Furthermore, a plurality of function icons and/or buttons (e.g., a screen key pad (1322) and a contact list (1323)) may be displayed on the full size image screen (1320) of the ‘mail’ application.

Also, alternatively in other example for configuring an image screen of the ‘mail’ application, FIG. 13(c) illustrates an example of the image screen (1330) of the ‘mail’ application overlapped with the display screen (106) with a partial size window. For example, in the partial size image screen (1330) of the ‘mail’ application, the close icon (1321) of FIG. 13(b) may not be equipped on the screen (1330). Thus, it can be allowed that the partial size image screen (1330) can be displayed only in a short time, such that after a predefined time is lapsed without any user action, the partial size image screen (1330) can be disappeared from the screen (106).

FIGS. 14(a) and 14(b) illustrate exemplary user interfaces for a ‘message’ application as a common job on a display screen in accordance with the some embodiments. if a user gesture (1401) for operating the ‘message’ application, for example single touching an icon (1410) representing the ‘message’ application as a common job, is detected, the processor (101) recognizes the user gesture as a command of displaying an image screen of operating the ‘message’ application and display the image screen (1420) of the ‘message’ application to be overlapped with the display screen (106) with a full size window. In the full size image screen (1420) of the ‘message’ application, for example, a close icon (1421) may be equipped on a right upper corner of the screen (1420). If a user gesture (not shown) for closing the screen (1420), for example single touching the close icon (1421), is detected, the processor (101) controls to close the screen (1420) and return to a previous display screen (106). Furthermore, a plurality of function icons and/or buttons (e.g., a recent mails list (1422) and a contact list (1423)) may be displayed on the full size image screen (1320) of the ‘message’ application.

Also, alternatively in other example for configuring an image screen of the ‘message’ application, FIG. 14(c) illustrates an example of the image screen (1430) of the ‘message’ application overlapped with the display screen (106) with a partial size window. For example, in the partial size image screen (1430) of the ‘message’ application, the close icon (1421) of FIG. 14(b) may not be equipped on the screen (1430). Thus, it can be allowed that the partial size image screen (1430) can be displayed only in a short time, such that after a predefined time is lapsed without any user action, the partial size image screen (1430) can be disappeared from the screen (106).

FIGS. 15(a) and 15(b) illustrate exemplary user interfaces for a ‘search’ application as a common job on a display screen in accordance with the some embodiments. if a user gesture (1501) for operating the ‘search’ application, for example single touching an icon (1510) representing the ‘search’ application as a common job, is detected, the processor (101) recognizes the user gesture as a command of displaying an image screen of operating the ‘search’ application and display the image screen (1520) of the ‘message’ application to be overlapped with the display screen (106) with a partial size window. Further, a plurality of function icons and/or buttons (e.g., an input wording window (1521) and a search key pad (1522)) may be displayed on the partial size image screen (1520) of the ‘search’ application. Furthermore, in the partial size image screen (1520) of the ‘search’ application, a close icon can (or cannot) be equipped on the screen (1520). Thus, if the close icon cannot be equipped on the screen (1520), it can be allowed that the partial size image screen (1520) can be displayed only in a short time, such that after a predefined time is lapsed without any input search word, the partial size image screen (1520) can be disappeared from the screen (106).

FIGS. 16(a) and 16(b) illustrate exemplary user interfaces for a ‘family’ application as a common job on a display screen in accordance with the some embodiments. if a user gesture (1601) for operating the ‘family’ application, for example single touching an icon (1610) representing the ‘family’ application as a common job on the screen, is detected, the processor (101) recognizes the user gesture as a command of displaying an image screen of operating the ‘family’ application and display the image screen (1620) of the ‘family’ application to be overlapped with the display screen (106) with a full size window. Further, a plurality of function icons and/or buttons (e.g., Family Calendar (1621), Mom's calendar (1622) and Country Theater (1623)) may be displayed on the full size image screen (1620) of the ‘family’ application. Furthermore, in the full size image screen (1620) of the ‘search’ application, a close icon can (or cannot) be equipped on the screen (1620). Thus, if the close icon cannot be equipped on the screen (1620), it can be allowed that the full size image screen (1620) can be displayed only in a short time, such that after a predefined time is lapsed without any user action, the full size image screen (1620) can be disappeared from the screen (106).

FIGS. 17(a) and 17(b) illustrate exemplary user interfaces for a ‘cloud’ application as a common job on a display screen in accordance with the some embodiments. if a user gesture (1701) for operating the ‘cloud’ application, for example single touching a cloud icon (1710) representing the ‘cloud’ application as a common job, is detected, the processor (101) recognizes the user gesture as a command of displaying an image screen of operating the ‘cloud’ application and display the image screen (1720) of the ‘cloud’ application to be overlapped with the display screen (106) with a partial size window. In the partial size image screen (1720) of the ‘message’ application, for example, a close icon (1721) may be equipped on a right upper corner of the screen (1720). If a user gesture for closing the screen (1720), for example single touching the close icon (1721), is detected, the processor (101) controls to close the screen (1720) and return to a previous display screen (106). Furthermore, a plurality of cloud contents (1722, 1723, 1724) received from an external cloud database may be displayed on the partial size image screen (1720) of the ‘message’ application. Furthermore, alternatively in other example for configuring the image screen (1720) of the ‘cloud’ application, the image screen (1720) can be configured to be overlapped with the display screen (106) with a full size window.

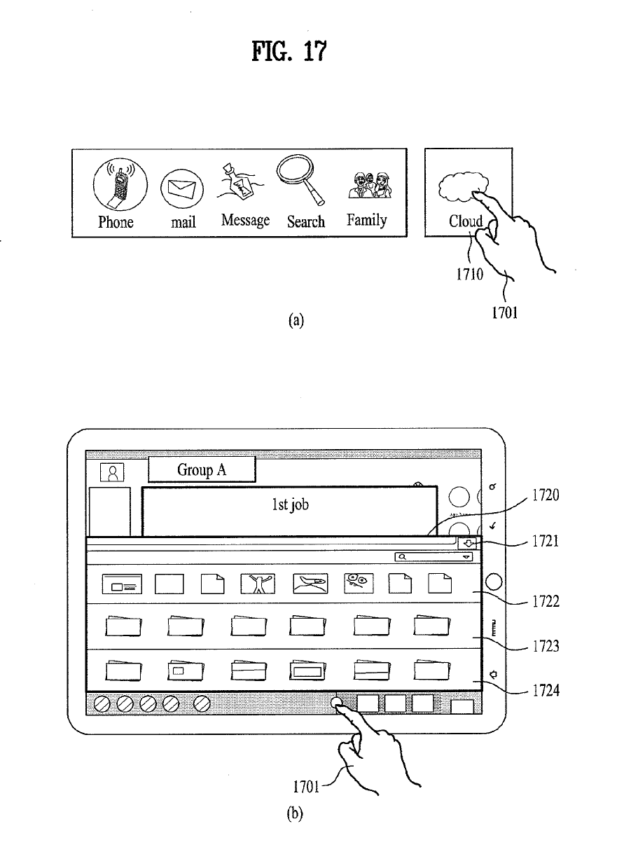

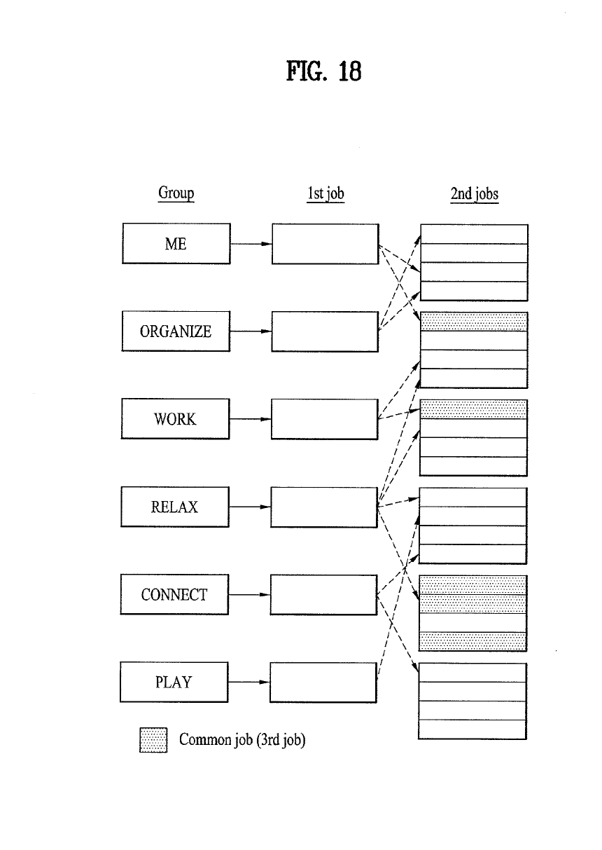

FIG. 18 illustrates an exemplary diagram in accordance with a second embodiment of the present invention. In particular, compared with FIG. 6 of the first embodiment, FIG. 18 shows another exemplary diagram of configuring correlation between the first job and the second job (and/or common jobs). When the first job is determined from a certain group by a user or a system (e.g., processor (101)), the second job and common jobs can be determined based on user experienced access regardless of the group containing the first job. The user experienced access is also referred to herein as the user access, or access by the user. The second job is determined as one of user experience jobs which were accessed by the user while the first job was operating. For example, in this embodiment, the correlation between the first job and the second job (and/or common jobs) is only based on the user experienced access. For example, if a certain application is executed by a user command represented by the user's gesture on a touch screen or remote control through a remote controller, the processor (101) can interpret the user command through the input detection unit (102) as operating the application as the first job. And then the processor (101) identifies or determines the second job(s) and the common jobs to be those applications which were most frequently accessed by the user while the first job was operating. For example, determining the second job and the common jobs was based on a number of user experienced access to a certain application while the first job was operating.

In more details, under multitasking environment of the embodiments, a user can easily access other waiting job while the main tasking job is operating. When the access to other job is allowed, the processor (101) counts the number of the access, and finally the processor (101) stores the counted data as frequency information into the data storage unit (103). For example, the frequency information includes the number of user experienced access to another application while a certain application was operating as the first job. Based on the stored frequency information, the processor (101) determines an application indicating the most high frequency number of the access as a second job. For example, if the display screen includes two second areas displaying two second jobs, the processor (101) selects two applications each having a highest frequency number of the access in order as two second jobs.

After determining the second job, the processor (101) determines at least one common application having the highest frequency number of the access in order among the predetermined common applications (501 in FIG. 5), while a certain application was operating. The processor (101) finally determines common jobs to be displayed in the global area of the display screen, among the determined at least one common application, except for an application executed as the first job and/or the determined second job. The more detailed example cases for determining the second job and common jobs will be provided as follows.

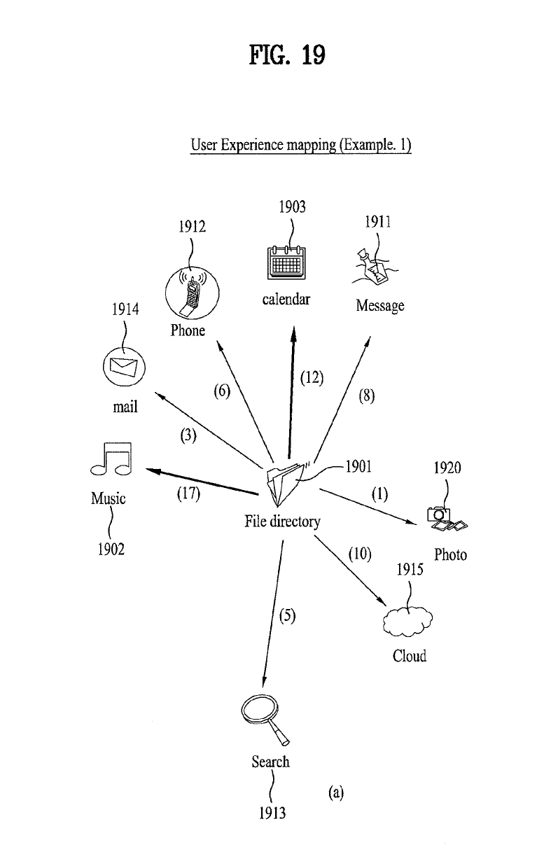

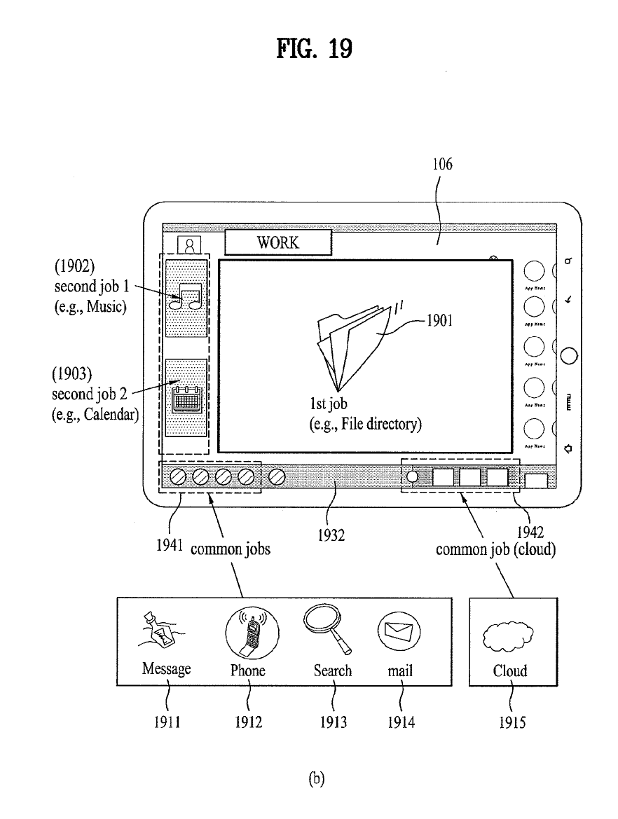

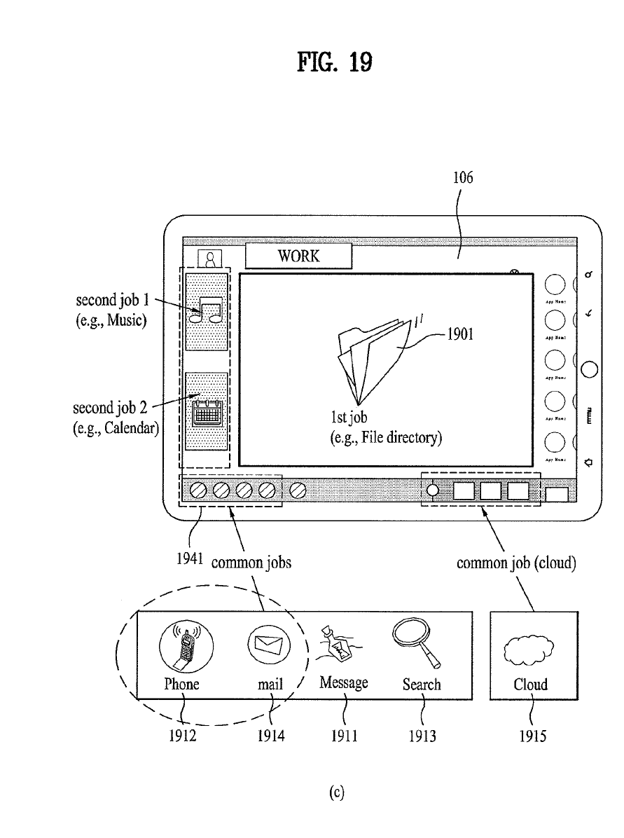

FIG. 19(a) illustrates an exemplary case to show user experienced access and FIG. 19(b) and FIG. 19(c) illustrate an exemplary display screen based on the user experienced access in accordance with the embodiment of FIG. 18.

FIG. 19(a) shows a user experienced mapping diagram surrounding a certain application (e.g., ‘File directory’ application (1901) in group WORK'). For example, the user experienced mapping diagram may be organized by the processor (101) based on the access frequency information calculated by counting the number of the access by the user while the ‘File directory’ application was operating as the first job. The exemplary numeral along with each arrow in FIG. 19(a) represents a stored data indicating the number of user experienced access to an arrowed application while the application (1901) was operated and displayed as the first job. In the case of user experienced mapping diagram of FIG. 19(a), for example, the applications mapping to the ascending order of the user experienced access number can be determined to be a ‘music’ application (1902) having ‘17’ access number, a ‘calendar’ application (1903), a ‘cloud’ application (1915), a ‘message’ application (1911), a ‘phone’ application (1912), a ‘search’ application (1913), a ‘mail’ application (1914) and a ‘photo’ application (1920) (from the highest access number to the lowest access number). This mapping diagram may be stored in the computing device or server, and may be updated as the applications are accessed. This mapping diagram may also be displayable on the screen for the user.

FIG. 19(b) illustrates an exemplary display screen based on the user experienced mapping diagram of FIG. 19(a). When a first job is selected or determined as the ‘File directory’ application (1901), for example, two second jobs and a plurality of common jobs configuring the display screen (106) can be determined based on the number of user experienced access to a certain application. For example, based on the stored frequency information, the processor (101) determines the ‘music’ application (1902) and the ‘calendar’ application (1903) having a high frequency number of the access in order as two second jobs to be displayed in the second area (1931). Alternatively, if the second area (1931) can display only one second job, the ‘music’ application (1902) having the highest frequency number of the access may be determined as the single second job.

Further, although the user experienced mapping diagram of FIG. 19(a) shows the common applications indicating a high frequency number of the access in order as like a ‘cloud’ application (1915), a ‘message’ application (1911), a ‘phone’ application (1912), a ‘search’ application (1913), and a ‘mail’ application (1914), the processor (101) finally determines common jobs to be displayed in the global area (1932) among the determined the common applications (1911˜1915) excluding the application being executed as the first job and/or the determined second job. In this example, since the first job (e.g., ‘File directory’ application (1901)) and the determined second jobs (e.g., ‘music’ application (1902), ‘calendar’ application (1903)) may not be included in the predetermined common applications (501 in FIG. 5), the processor (101) finally determines all common applications (e.g., a ‘cloud’ application (1915), a ‘message’ application (1911), a ‘phone’ application (1912), a ‘search’ application (1913), and a ‘mail’ application (1914)) as the common jobs and displays them in the global area (1932). Furthermore, for example, the processor (101) can control the determined common jobs (1911, 1912, 1913, 1914) excluding the cloud application (1915), to be displayed in a common area (1941) within the global area (1932), in the sequential order in the number of the user experienced access as depicted in FIG. 19(b). For example, the cloud application (1915) as a common job can be displayed in a cloud navigation area (1942) as previously disclosed in FIG. 7(c).

Alternatively, FIG. 19(c) illustrates another exemplary display screen based on the user experienced mapping diagram of FIG. 19(a). Compared with FIG. 19(b), a user or a system can establish a preferred or important common application (e.g., a ‘phone’ application (1912) and a ‘mail’ application (1914)) to be always displayed at the front position of the common area (1942) regardless of the order in the number of the user experienced access.

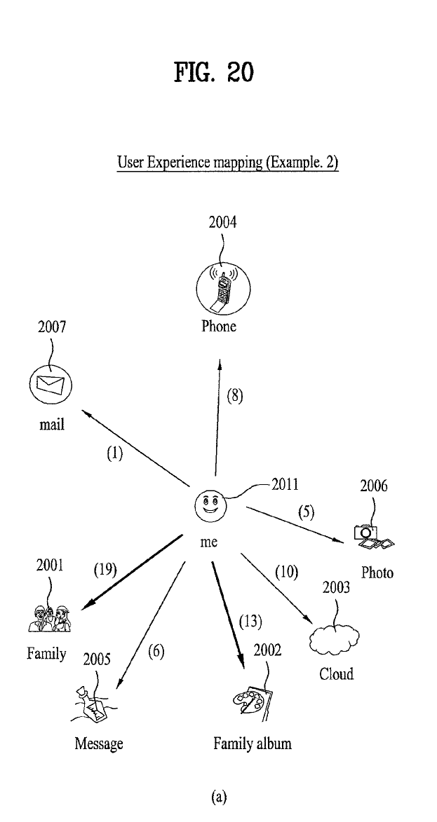

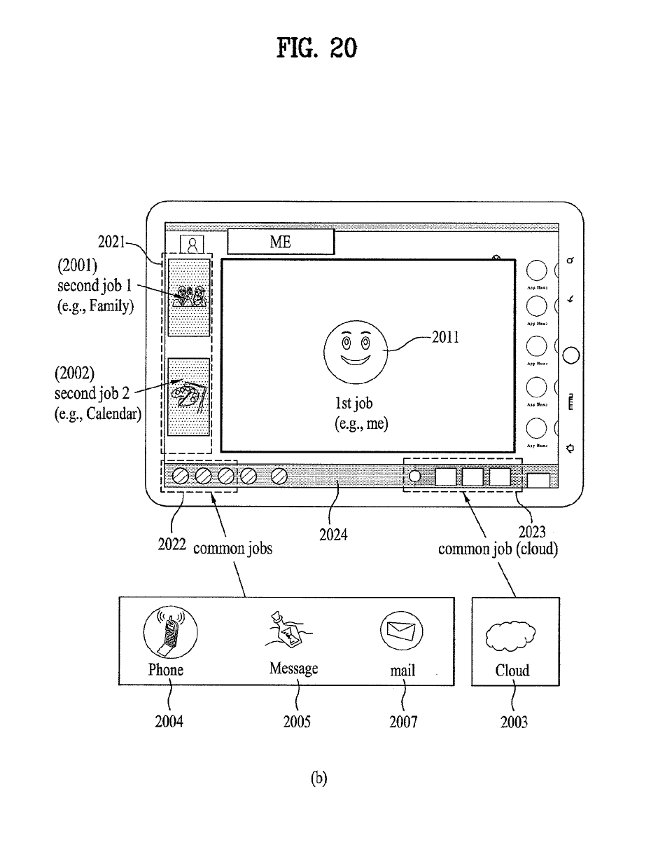

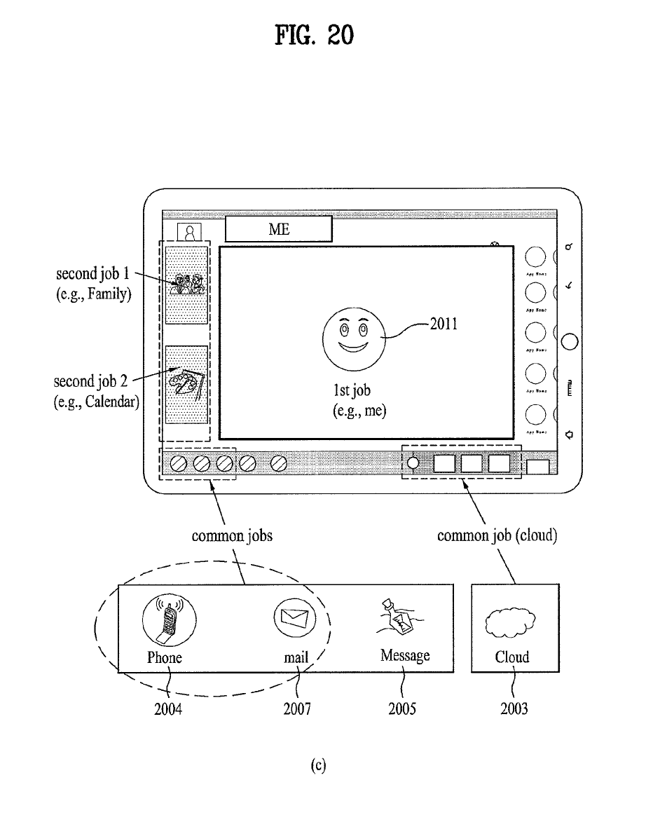

FIG. 20(a) illustrates another exemplary case to show user experienced access and FIG. 20(b) and FIG. 20(c) illustrate an exemplary display screen based on the user experienced access in accordance with the embodiment of FIG. 18.

FIG. 20(a) shows a user experienced mapping diagram surrounding a certain application (e.g., ‘me’ application (2011) in group ‘ME’). In the case of user experienced mapping diagram of FIG. 20(a), for example, the applications mapping to the ascending order of the user experienced access number (e.g., number of access) can be determined as a ‘family’ application (2001) (e.g., 19 times), a ‘family album’ application (2002) (e.g., 13 times), a ‘cloud’ application (2003), a ‘phone’ application (2004), a ‘message’ application (2005), a ‘photo’ application (2006), and a ‘mail’ application (2007).

FIG. 20(b) illustrates an exemplary display screen based on the user experienced mapping diagram of FIG. 20(a). When a first job is selected or determined as the ‘me’ application (2011), for example, the processor (101) determines a ‘family’ application (2001) and a ‘family album’ application (2002) having a high (or highest) frequency number of the access in order as two second jobs and displays them in the second area (2021) based on the stored frequency information. Alternatively, if the second area (2021) can display only one second job at a time, the ‘family’ application (2001) having the highest frequency number of the access may be determined as the single second job to be displayed in the second area (2021).

Further, in this example, since one of the determined second jobs (e.g., a ‘family’ application (2001)) may be included in the predetermined common applications (501 in FIG. 5), the processor (101) finally determines common applications excluding the ‘family’ application (2001) which is already determined as one of the second jobs, as common jobs to be displayed in the global area (2024) and displays them in the global area (2024). That is, for example, a ‘cloud’ application (2003), a ‘phone’ application (2004), a ‘message’ application (2005), and a ‘mail’ application (2007) are determined as common jobs. Furthermore, for example, the processor (101) can control the determined common jobs (2004, 2005, 2007) excluding the cloud application (2003), to be displayed in a common area (2022) within the global area (2024) in a sequential order of the number of the user experienced access as depicted in FIG. 20(b). Also, for example, the cloud application (2003) as a common job can be displayed in a cloud navigation area (2023) as previously disclosed in FIG. 7(c).

Alternatively, FIG. 20(c) illustrates another exemplary display screen based on the user experienced mapping diagram of FIG. 20(a). Compared with FIG. 20(b), a user or a system can establish a preferred or important common application (e.g., a ‘phone’ application (2004) and a ‘mail’ application (2005)) to be always displayed at the front position of the common area (1942) regardless of the order of the number of the user experienced access.

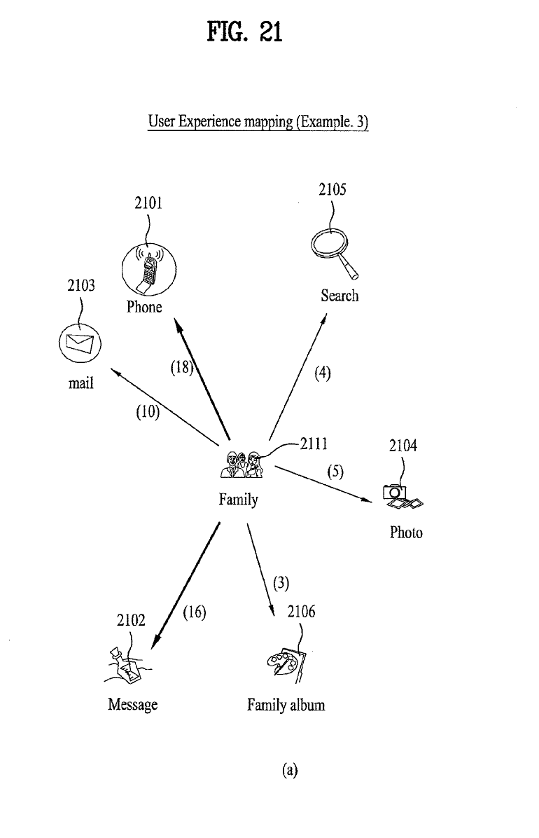

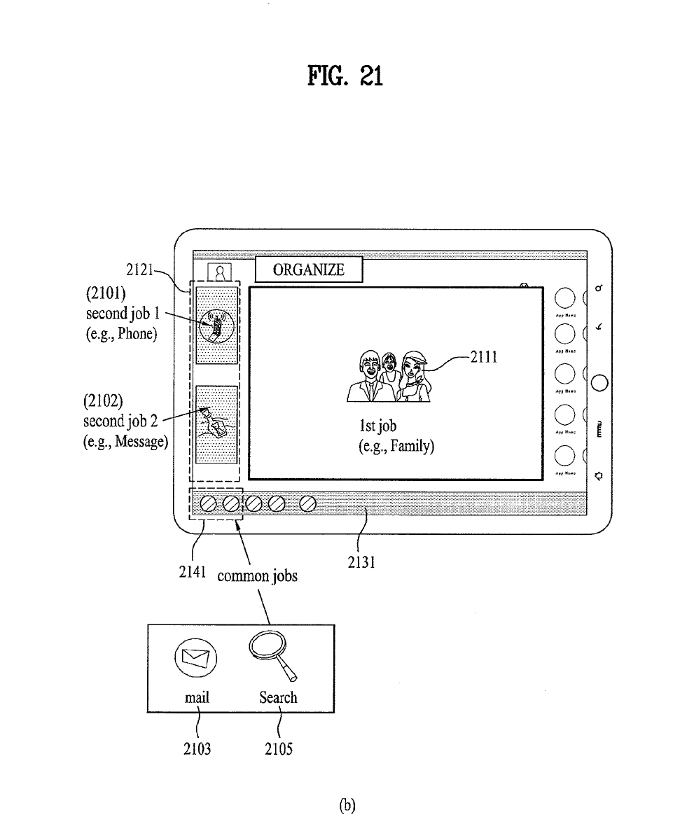

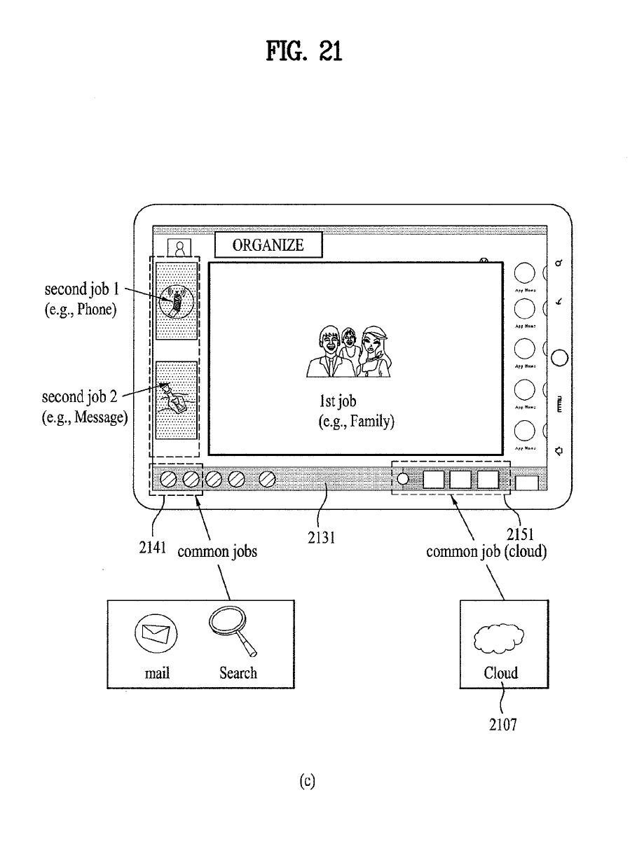

FIG. 21(a) illustrates another exemplary case to show user experienced access and FIG. 21(b) and FIG. 21(c) illustrate an exemplary display screen based on the user experienced access in accordance with the embodiment of FIG. 18.

FIG. 21(a) shows a user experienced mapping diagram surrounding a certain application (e.g., ‘family’ application (2111) in group ‘ORGANIZE’). In the case of the user experienced mapping diagram of FIG. 21(a), for example, the applications mapping to the ascending order of the user experienced access number can be determined as a ‘phone’ application (2101), a ‘message’ application (2102), a ‘mail’ application (2103), a ‘photo’ application (2104), and a ‘search’ application (2105).

FIG. 21(b) illustrates an exemplary display screen based on the user experienced mapping diagram of FIG. 21(a). When a first job is selected or determined as the ‘family’ application (2111), for example, the processor (101) determines a ‘phone’ application (2101) and a ‘message’ application (2102) having the highest frequency number of the access in order as the two second jobs to be displayed in the second area (2121) based on the stored frequency information. Alternatively, if the second area (2121) can display only one second job, the ‘phone’ application (2101) having the most highest frequency number of the access may be determined as the single second job. The determined first job is displayed in the main area screen while the other jobs are displayed in other areas of the screen as shown.

Further, in this example, since the first job (e.g., ‘family’ application (2111)) and the determined two second jobs (e.g., a ‘phone’ application (2101) and a ‘message’ application (2102)) may be included in the predetermined common applications (501 in FIG. 5), the processor (101) finally determines common applications excluding the applications corresponding to the first job and the second jobs, to be displayed in the global area (2131). That is, for example, the ‘mail’ application (2103) and the ‘search’ application (2105) are determined as common jobs. Furthermore, the processor (101) can control the determined common jobs (2103, 2105) to be displayed in a common area (2141) within the global area (2131) in the sequential order of the number of the user experienced access as depicted in FIG. 21(b). Alternatively, for other exemplary display screen, FIG. 21(c) illustrates a cloud application (2107) as a common job can be displayed in a cloud navigation area (2151) within the global area (2131), even if the cloud application (2107) does not have an access record.

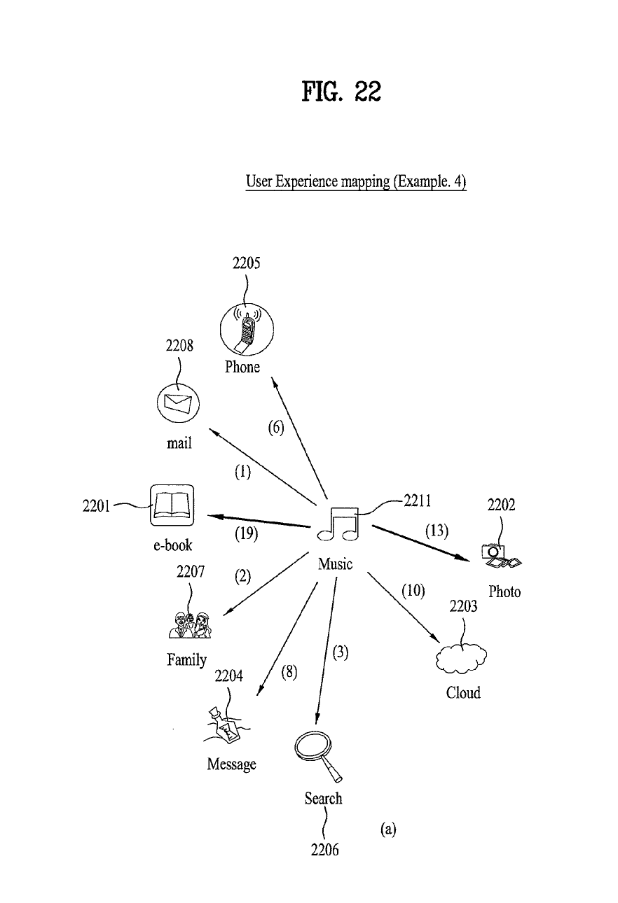

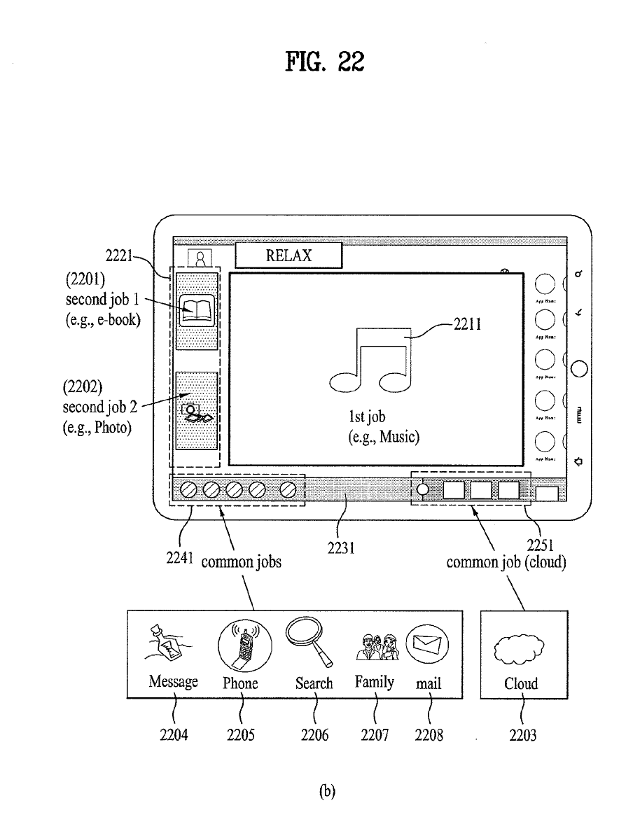

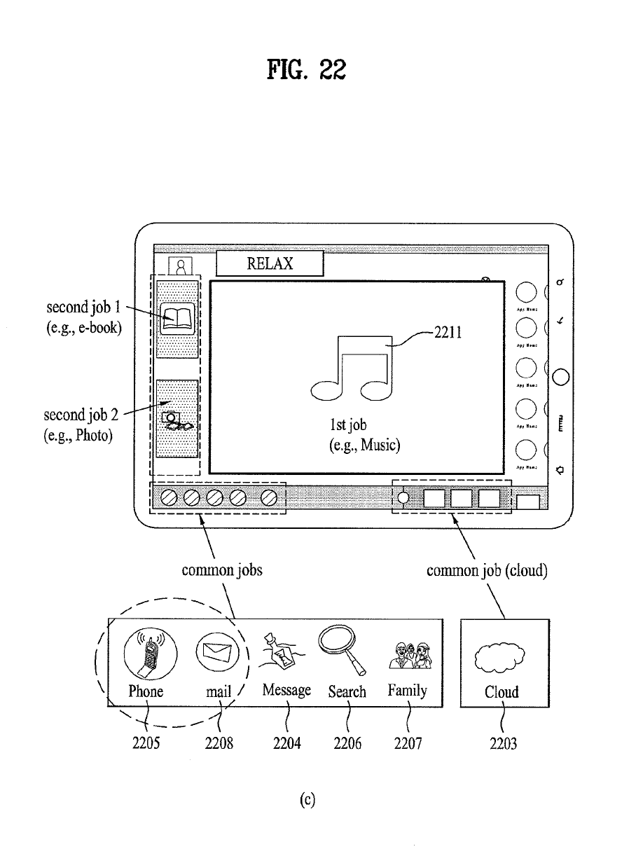

FIG. 22(a) illustrates another exemplary case to show user experienced access and FIG. 22(b) and FIG. 22(c) illustrate an exemplary display screen based on the user experienced access in accordance with the embodiment of FIG. 18.

FIG. 22(a) shows a user experienced mapping diagram surrounding a certain application (e.g., ‘music’ application (2211) in group ‘RELAX’). In the case of the user experienced mapping diagram of FIG. 22(a), for example, the applications mapping to the ascending order of the user experienced access number can be determined as a ‘e-book’ application (2201), a ‘photo’ application (2202), a ‘cloud’ application (2203), a ‘message’ application (2204), a ‘phone’ application (2205), a ‘search’ application (2206), ‘family’ application (2207), and a ‘mail’ application (2208).

FIG. 22(b) illustrates an exemplary display screen based on the user experienced mapping diagram of FIG. 22(a). When a first job is selected or determined as the ‘music’ application (2211), the processor (101) determines an ‘e-book’ application (2201) and a ‘photo’ application (2202) having the highest frequency number of the access in order as two second jobs to be displayed in the second area (2221) based on the stored frequency information. Alternatively, if the second area (2221) can display only one second job, the ‘e-book’ application (2201) having the most highest frequency number of the access may be determined as the single second job, and displayed in the second area (2221).

Further, in this example, since the first job (e.g., ‘music’ application (2201)) and the determined second jobs (e.g., a ‘e-book’application (2202), a ‘photo’ application (2203)) may not be included in the predetermined common applications (501 in FIG. 5), the processor (101) finally determines all common applications (e.g., a ‘cloud’ application (2203), a ‘message’ application (2204), a ‘phone’ application (2205), a ‘search’ application (2206), ‘family’ application (2207), and a ‘mail’ application (2208)) as common jobs, and displays them in the global area (2231). Furthermore, for example, the processor (101) can control the determined common jobs (2204, 2205, 2206, 2207, 2208) excepting the cloud application (2203) to be displayed in a common area (2241) within the global area (2231) in the sequential order of the number of the user experienced access as depicted in FIG. 22(b). Also, for example, the cloud application (2203) as a common job can be displayed in a cloud navigation area (2251) as previously disclosed in FIG. 7(c). The determined first job is displayed in the main area of the screen while the other jobs are displayed in other areas of the screen as shown. As such, in this and other examples, the user can easily recognize the priority of the jobs in a user friendly/preferred manner, and can effectively maneuver the jobs and their related items using the user interfaces of the computing device.

Alternatively, FIG. 22(c) illustrates another exemplary display screen based on the user experienced mapping diagram of FIG. 22(a). Compared with FIG. 22(b), a user or a system can establish a preferred or important common application (e.g., a ‘phone’ application (2205) and a ‘mail’ application (2208)) to be always displayed at the front position of the common area (2241) regardless of the order of the number of the user experienced access.

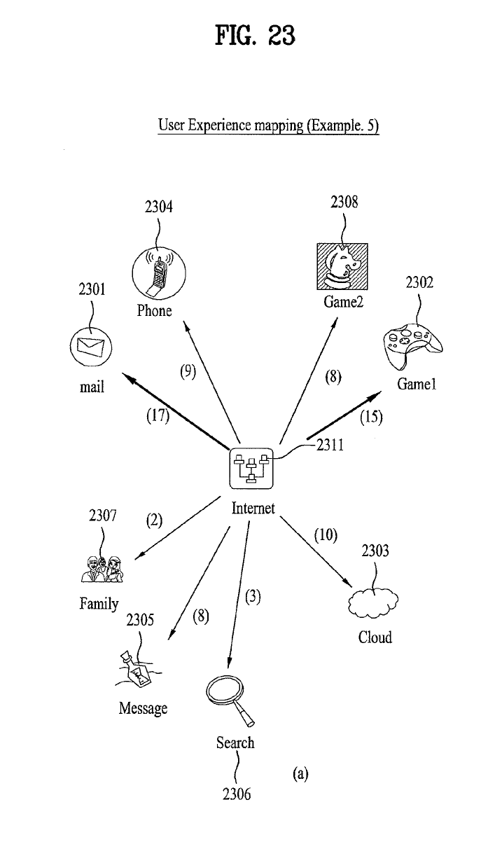

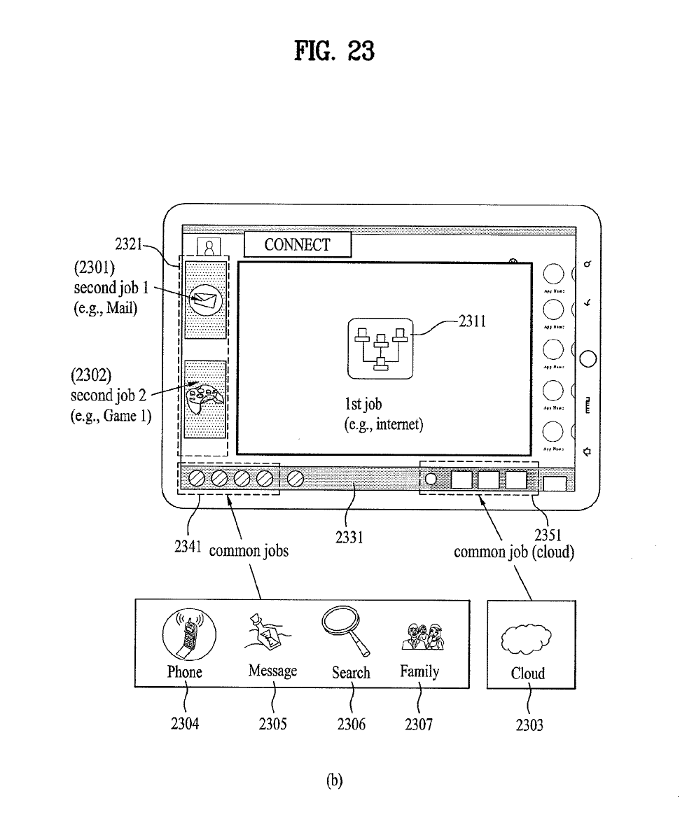

FIG. 23(a) illustrates another exemplary case to show user experienced access and FIG. 23(b) illustrate an exemplary display screen based on the user experienced access in accordance with the embodiment of FIG. 18.

FIG. 23(a) shows a user experienced mapping diagram surrounding a certain application (e.g., ‘internet’ application (2311) in group ‘CONNECT’). In the case of the user experienced mapping diagram of FIG. 23(a), for example, the applications mapping to the ascending order of the user experienced access number can be determined as a ‘mail’ application (2301), a ‘game1’ application (2302), a ‘cloud’ application (2003), a ‘phone’ application (2004), a ‘message’ application (2005), a ‘search’ application (2006), a ‘family’ application (2007), and a ‘game2’ application (2308).

FIG. 23(b) illustrates an exemplary display screen based on the user experienced mapping diagram of FIG. 23(a). When a first job is selected or determined as the ‘internet’ application (2311), the processor (101) determines a ‘mail’ application (23001) and a ‘game1’ application (2302) having a high frequency number of the access in order as two second jobs to be displayed in the second area (2321) based on the stored frequency information. Alternatively, if the second area (2321) can display only one second job, the ‘mail’ application (2001) having the most highest frequency number of the access may be determined as only single second job.

Further, in this example, since one of the determined second jobs (e.g., a ‘mail’ application (2301)) may be included in the predetermined common applications (501 in FIG. 5), the processor (101) finally determines common applications excluding the ‘mail’ application (2301), as common jobs to be displayed in the global area (2331). That is, for example, the ‘cloud’ application (2303), the ‘phone’ application (2304), the ‘message’ application (2305), the ‘search’ application (2306) and the ‘family’ application (2007) are determined as common jobs. Furthermore, for example, the processor (101) can control the determined common jobs (2304, 2305, 2306, 2307) excluding the cloud application (2303) to be displayed in a common area (2341) within the global area (2331) in sequential order of a number of the user experienced access as depicted in FIG. 23 (b). Also, for example, the cloud application (2303) as a common job can be displayed in a cloud navigation area (2351). The determined first job is displayed in the main area of the screen while the other jobs are displayed in other areas of the screen as shown.

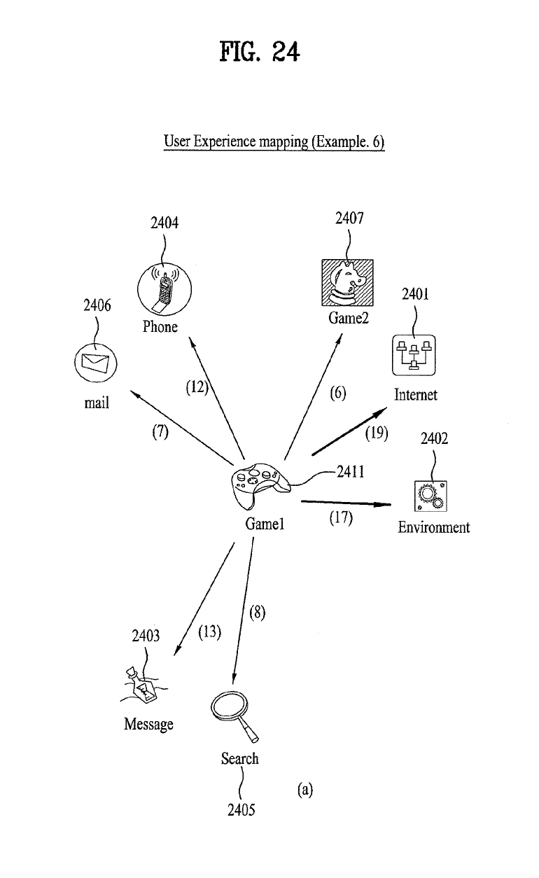

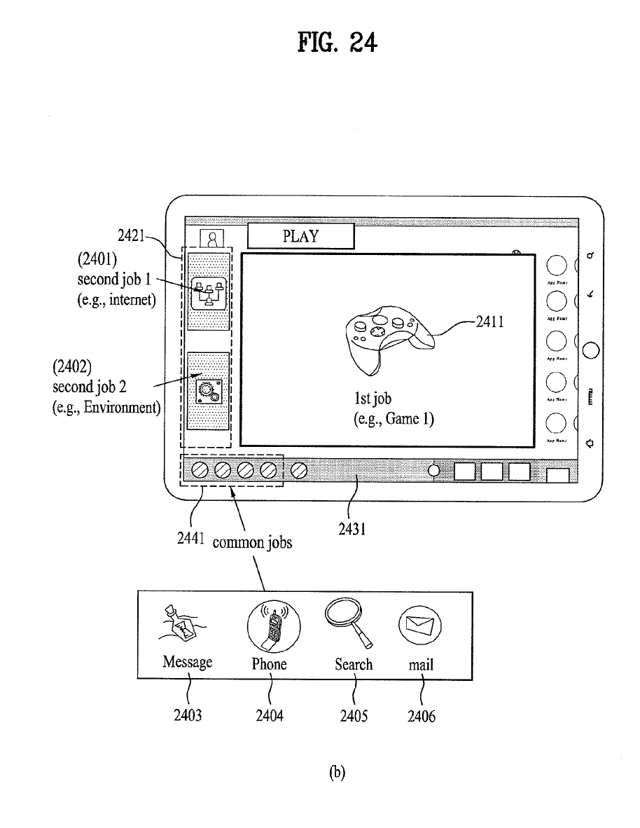

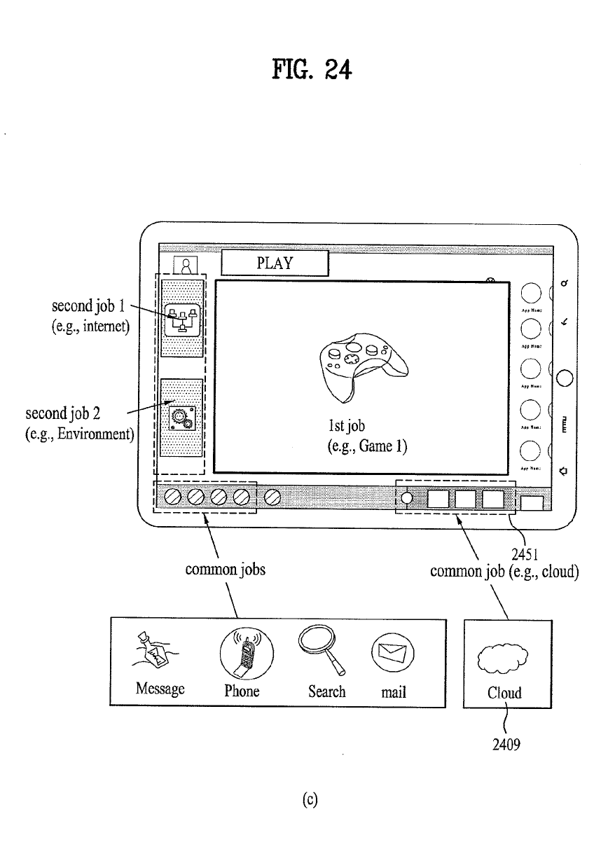

FIG. 24(a) illustrates another exemplary case to show user experienced access and FIG. 24(b), FIG. 24(c) and FIG. 24(d) illustrate an exemplary display screen based on the user experienced access in accordance with the embodiment of FIG. 18.

FIG. 24(a) shows a user experienced mapping diagram surrounding a certain application (e.g., ‘game l’ application (2411) in group ‘PLAY’). In the case of the user experienced mapping diagram of FIG. 24(a), for example, the applications mapping to the ascending order of the user experienced access number can be determined as a ‘internet’ application (2401), a ‘environment’ application (2402), a ‘message’ application (2403), a ‘phone’ application (2404), a ‘search’ application (2405), a ‘mail’ application (2406), and a ‘game2’ application (2407).

FIG. 24(b) illustrates an exemplary display screen based on the user experienced mapping diagram of FIG. 24(a). When a first job is selected or determined as the ‘game1’ application (2411), the processor (101) determines the ‘internet’ application (2401) and the ‘environment’ application (2402) having the highest frequency number of the access in order as two second jobs to be displayed in the second area (2421) based on the stored frequency information. Alternatively, if the second area (2421) can display only one second job, the ‘internet’ application (2401) having the most highest frequency number of the access may be determined as the single second job.

Further, in this example, since the first job (e.g., ‘game1’ application (2411)) and the determined second jobs (e.g., ‘internet’ application (2401) and ‘environment’ application (2402)) are not included in the predetermined common applications (501 in FIG. 5), the processor (101) finally determines all common applications (e.g., ‘message’ application (2403), ‘phone’ application (2404), ‘search’ application (2405), and ‘mail’ application (2406)) as common jobs to be displayed in the global area (2431). Furthermore, for example, the processor (101) can control the determined common jobs (2403, 22404, 2405, 2406) to be displayed in a common area (2441) within the global area (2431) in the sequential order of the number of the user experienced access as depicted in FIG. 24(b). Alternatively, for other exemplary display screen, FIG. 24(c) illustrates a cloud application (2409) as a common job can be displayed in a cloud navigation area (2451) within the global area (2431), even if the cloud application (2409) do not have an access record.

Alternatively, FIG. 24(d) illustrates another exemplary display screen based on the user experienced mapping diagram of FIG. 24(a). Compared with FIG. 24(b) or FIG. 24(c), a user or a system can establish a preferred or important common application (e.g., a ‘phone’ application (2404) and a ‘mail’ application (2406)) to be always displayed at the front position of the common area (2441) regardless of the order of the number of the user experienced access. As such, the determined first job is displayed in the main area of the screen while the other jobs are displayed in other areas of the screen as shown.

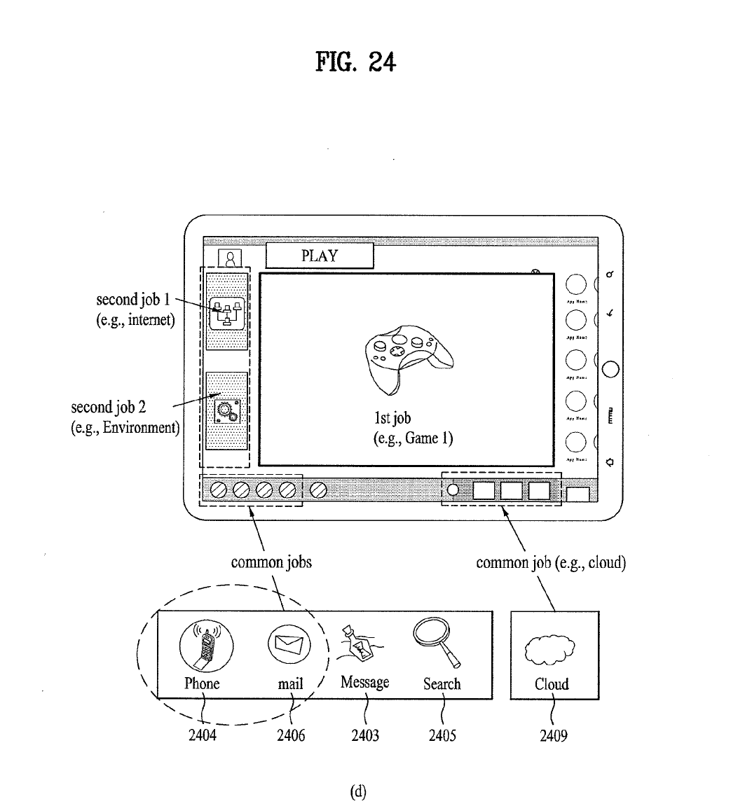

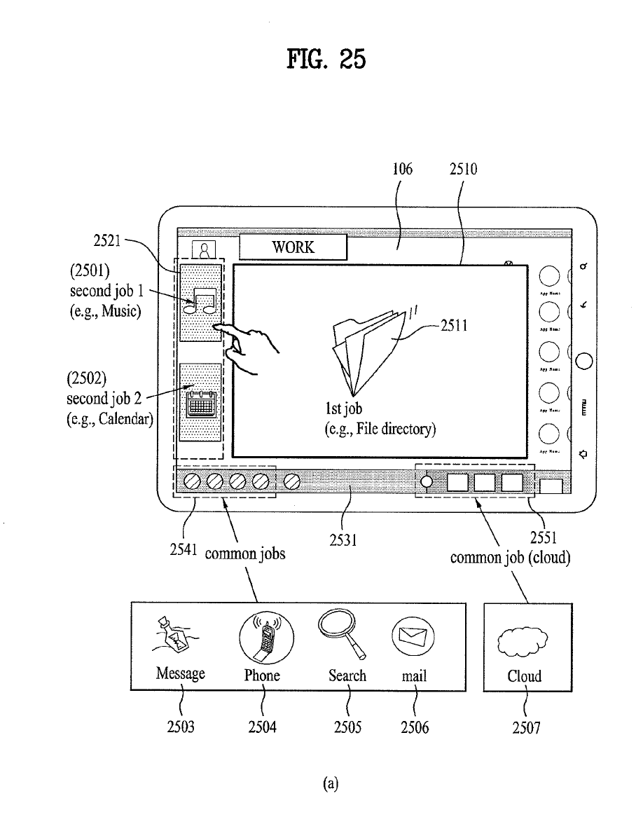

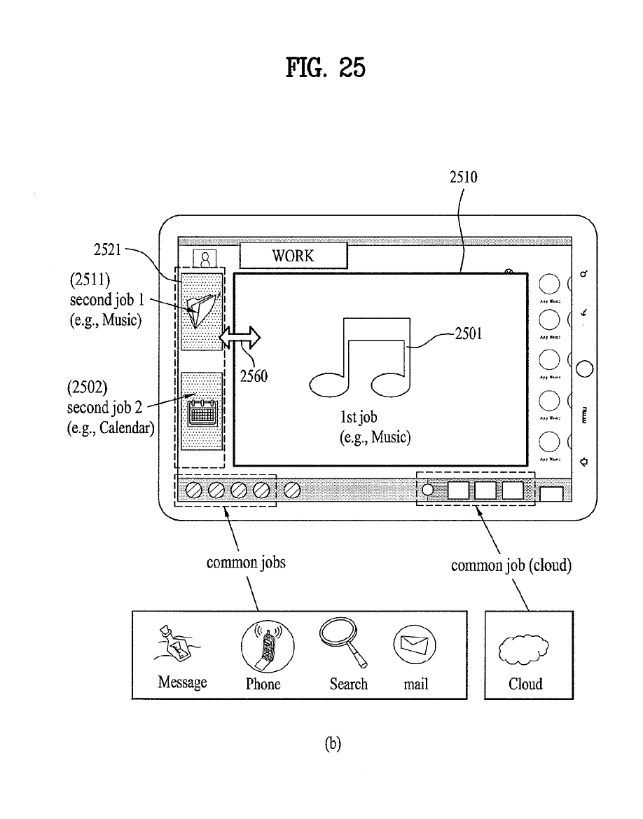

FIGS. 25(a)˜25(b) illustrate exemplary user interfaces for switching jobs between a first job and a second job on a display screen in accordance with the embodiment of FIG. 18.

FIG. 25(a) illustrates a display screen (106) including a first area (2510) for displaying a first job (2511), a second area (2521) for displaying at least one second job (e.g., 2501, 2502), and a global area (2531) for displaying one or more common jobs (2503˜2507) as similar to FIG. 19(b). From the display screen of FIG. 25(a), if a user gesture (2500), for example, double touching one of the at least one second job screen (2501), is detected, the processor (101) recognizes the user gesture as a command for a jobs switching process between the first job (2511) and the touched second job (2501) based on the current display state.

FIG. 25(b) illustrates a display screen (106) after the jobs switching process (2560) is completed according to the user's command/gesture. For example, during the jobs switching process (2560) is operating, the processor (101) controls the display control module (105) to display the switched first job (former second job, 2501) at the first area (2510) of the display screen (106). Also, For example, during the jobs switching process (2560) is operating, the processor (101) controls the display control module (105) to display the switched second job (former first job, 2511) at the second area (2521) of the display screen (106). Consequently, after the jobs switching process (2560) is completed, the applications corresponding to the newly designated first job area and the touched second job area are displayed on the screen according to their job designation. In contrast, in this embodiment, the remaining second job (2502) and the common jobs (1503˜2507) do not change their position in the display screen (106). In this regard, it is understood that when the jobs are displayed as switched on the screen, the processor (101) has already implemented the job switching internally so that execution of such applications occurs according to the switching in the job designation.

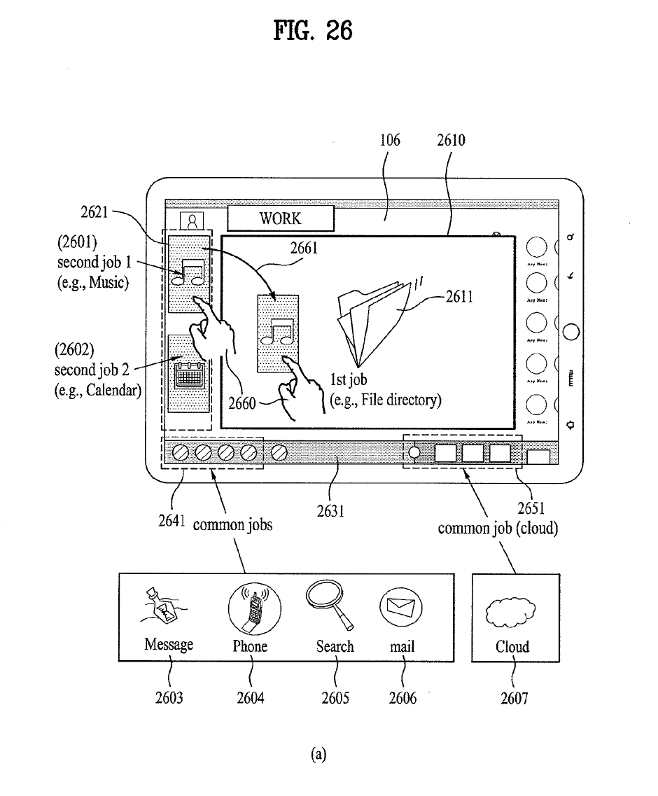

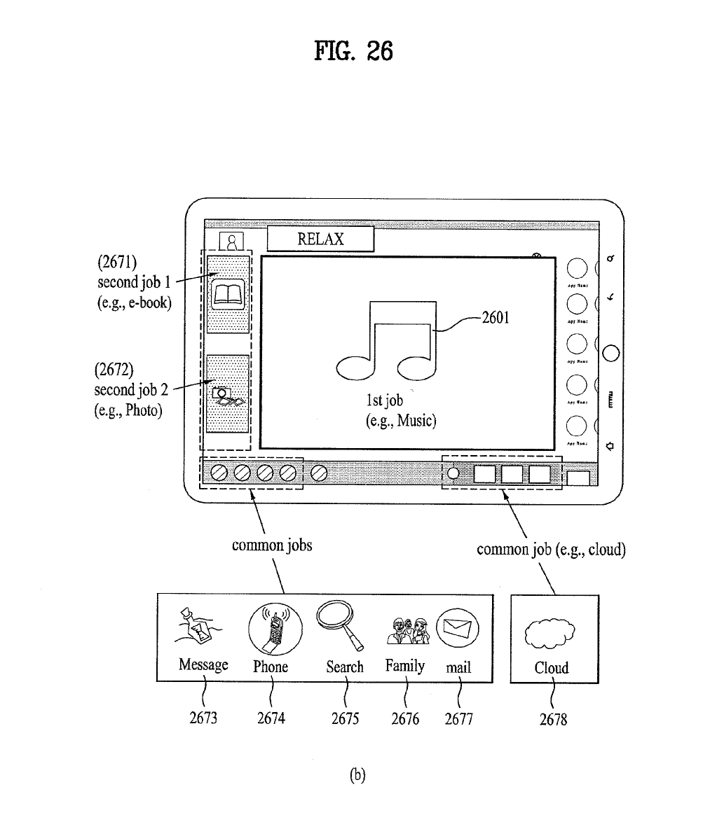

FIGS. 26(a)˜26(b) illustrate exemplary user interfaces for switching jobs between a first job and a second job on a display screen in accordance with the embodiment of FIG. 18.

FIG. 26(a) illustrates a display screen (106) including a first area (2610) for displaying a first job (2611), a second area (2621) for displaying at least one second job (e.g., 2601, 2602), and a global area (2631) for displaying one or more common jobs (2603˜2607) as like FIG. 25(a). From the display screen of FIG. 26(a), if a user gesture (2660), for example dragging (2661) an icon of a second job (2601) to the first area (2610), is detected, the processor (101) recognizes the user gesture as a command for a jobs switching process between the first job (2611) and the touched second job (2601) based on the user experienced access, and thus implements the switch.

FIG. 26(b) illustrates a display screen (106) after the jobs switching process is completed. For example, during the jobs switching process is operating, the processor (101) controls the display control module (105) to display the switched first job (former second job, 2601) at the first area (2610) of the display screen (106). Also, the processor (101) determines a new second job and new common jobs based on user experienced access while the switched first job (former second job, 2601) was operating, in accordance with the embodiment of FIG. 18. For example, referring back to FIGS. 22(a) and 22(b), when the switched application (former second job, e.g., ‘music’ application, 2601) was operated as a first job, the applications mapping to the ascending order of the user experienced access number can be determined as an ‘e-book’ application (2671), a ‘photo’ application (2672), a ‘cloud’ application (2678), a ‘message’ application (2673), a ‘phone’ application (2674), a ‘search’ application (2675), ‘family’ application (2676), and a ‘mail’ application (2677) and displays them as the new second jobs and common jobs since they were associated with the ‘music’ application 2601 (newly designated as the first job now).

FIG. 26(b) illustrates an exemplary display screen for the switching jobs process, based on the user experienced mapping diagram of FIG. 22(a). The processor (101) determines the ‘e-book’ application (2671) and the ‘photo’ application (2672) as new second jobs to be displayed in the second area (2621) based on the stored frequency information. Further, similar to FIG. 22(b), the processor (101) finally determines common applications (e.g., the ‘cloud’ application (2678), the ‘message’ application (2673), the ‘phone’ application (2674), the ‘search’ application (2675), the ‘family’ application (2676), and the ‘mail’ application (2677)) as new common jobs to be displayed in the global area (2631).

Consequently, the switching jobs process of FIG. 25 may provide only exchanged positions between the first job and the second job without changing the configuration of other second job(s) and common jobs. Alternatively, the switching jobs process of FIG. 26 may organize the new display screen based on the switched first job (former second job) and the user experienced access information by newly designating, arranging and displaying also the second and common jobs associated with the switched first job.

FIGS. 27˜28(c) illustrate exemplary user interfaces for displaying images on a display screen in accordance with the some embodiments.

FIG. 27 illustrates an exemplary display screen (2700) in accordance with the some embodiments. The exemplary display screen (2700) includes a first area (2701) for displaying a first job, a second area (2710) for displaying a plurality of second jobs (2711˜2718), a third area (or a global area) (2720) for displaying common jobs, and a fourth area (2730) for displaying clipped applications and widgets (2731, 2732). For example, in this exemplary of FIG. 27, a partial portion (2711, 2712) of the second area (2710) and a partial portion (2731) of the fourth area (2730) may be displayed (or visible to the user) on the screen (2700). From a display state of FIG. 27, the user can view the images only displayed on the screen (2700). Thus, if the user hopes to view a hidden portion (2711˜2718) of the second area (2710) and a hidden portion (2732) of the fourth area (2730), he (or she) can control the screen with a user gesture, for example touch-swiping the screen (e.g., a main portion of any portion) to any direction (2811, 2821) what he hopes to view from the hidden jobs as depicted in FIG. 28(a).

FIG. 28(b) illustrates an exemplary display screen (2850) when a user gesture of swiping the screen to a right direction (2821) is detected. The exemplary display screen (2850) displays the second area (2710) including all or next-lined multitasked second job applications (e.g., second jobs). If a user gesture, for example double touching one of the multitasked second job applications, is detected, the processor (101) may control to perform one of the jobs switching process as disclosed in FIGS. 10, 25(a)/(b) and 26(a)/(b). Also, If a user gesture, for example touching a close icon (2791) of one of the multitasked second job applications, is detected, the processor (101) may control to perform to stop the running operation of the corresponding application (2711) and make that application (2711) disappear from the screen (2850). In such a case, the other second jobs can be shifted to fill that job (2711) on the screen.

FIG. 28(c) illustrates an exemplary display screen (2860) when a user gesture of swiping the screen to a left direction (2811) at the screen of FIG. 28(a) is detected. The exemplary display screen (2860) displays the fourth area (2730) including clipped applications and widgets (2731, 2732). If a user gesture, for example double touching one of the clipped applications, is detected, the processor (101) may control to operate the selected application as a first job to be displayed on the first area (2710). Furthermore, the processor (101) can determine at least one second job and common jobs based on the disclosed embodiments of FIG. 6 and FIG. 18. For instance, the job switching discussed above in connection with the other examples can be applied here or in any other examples/embodiments discussed in the present application.

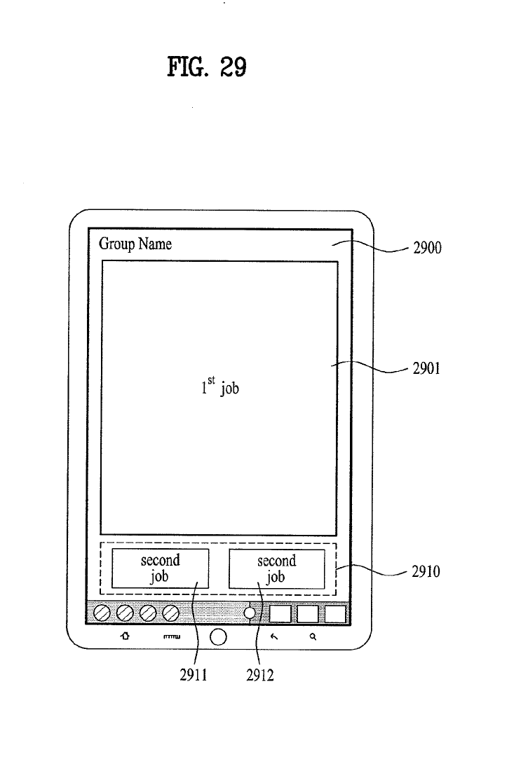

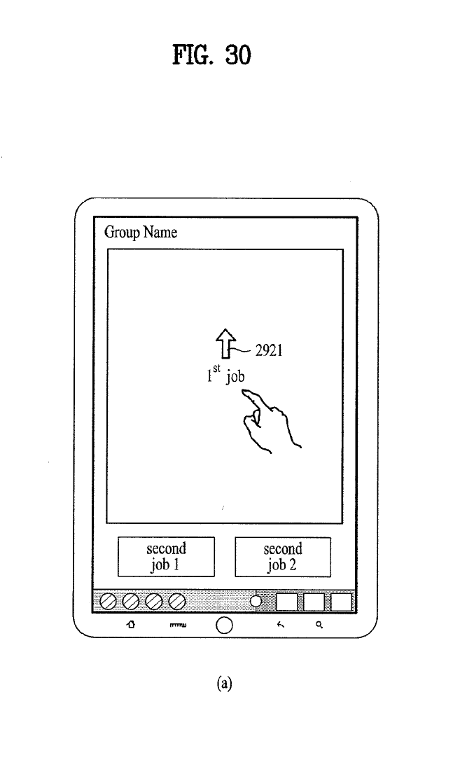

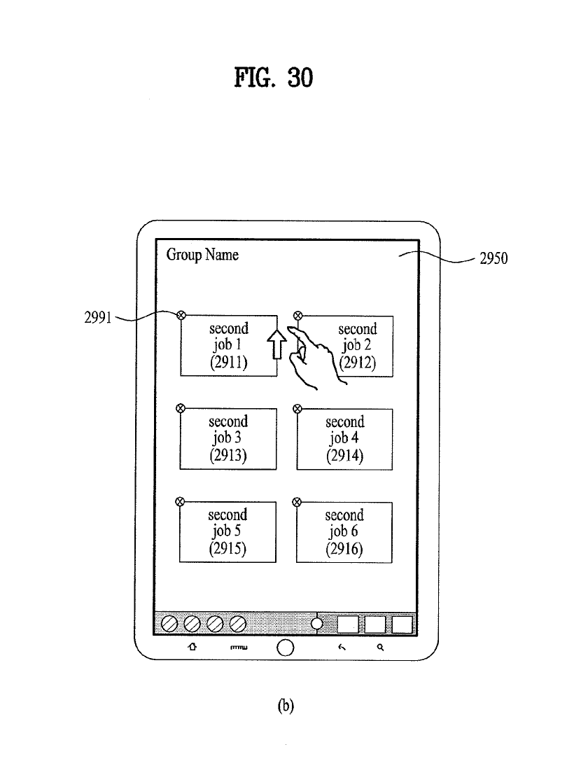

FIGS. 29˜30(b) illustrate exemplary user interfaces for displaying images on a display screen in accordance with the some embodiments.

FIG. 29 illustrates an exemplary display screen (2900) in accordance with the some embodiments. For example, compared with FIG. 27, FIG. 29 illustrates an example environment that the images displayed on the exemplary display screen (2900) can be viewed through a vertical (or substantially vertical) direction. The exemplary display screen (2900) also includes a first area (2901) for displaying a first job, a second area (2910) for displaying a plurality of second jobs (2911, 2912), a third area (or a global area) (2920) for displaying common jobs. From a display state of FIG. 29, a user can view the images only displayed on the screen (2900). Thus, if the user hopes to view a hidden portion of the second area (2910), he (or she) can control the screen with a user gesture, for example touch-swiping the screen to an upper direction (2911) as depicted in FIG. 30(a).

FIG. 30(b) illustrates an exemplary display screen (2950) when a user gesture of swiping the screen to the upper direction (2921) is detected. The exemplary display screen (2950) displays the second area (2910) including all multitasked applications (e.g., second jobs, 2911˜2916). If a user gesture, for example double touching one of the second jobs, is detected, the processor (101) may control to perform one of the jobs switching process as disclosed above, e.g., in FIGS. 10, 25(a)/(b) and 26 (a)/(b). Also, If a user gesture, for example touching a close icon (2991) of one of the multitasked second job applications, is detected, the processor (101) may control to perform to stop the running operation of the corresponding second job application (e.g., 2912) and make that application (2912) disappear from the screen (2950). Here, although each of the second job applications may have its own close icon (2991), but such is not needed if not desired, and only certain second job applications may have the corresponding close icons.

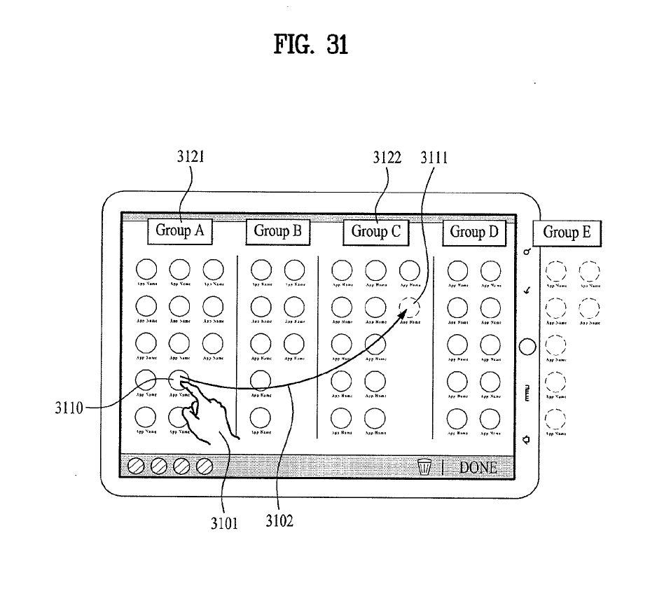

FIG. 31 illustrates an exemplary user interface for configuring group(s) of applications on a display screen in accordance with the some embodiments. Referring to FIG. 31, a user can change a grouping of a certain application (3110) with a user gesture, for example touch-dragging an icon of the application (3110) to the desired position (3111). For example, the user can touch and drag the application (3110) from the current group (Group-A) to a new group (Group-C) on the screen so that the application (3110) can now be part of Group-C. After changing the group position from Group-A (3121) to Group-C (3122), the application (3110) can be involved in the Group-C (3122) and be acted as a member of the Group C (3122), e.g., when applied to the first embodiment of FIG. 6.

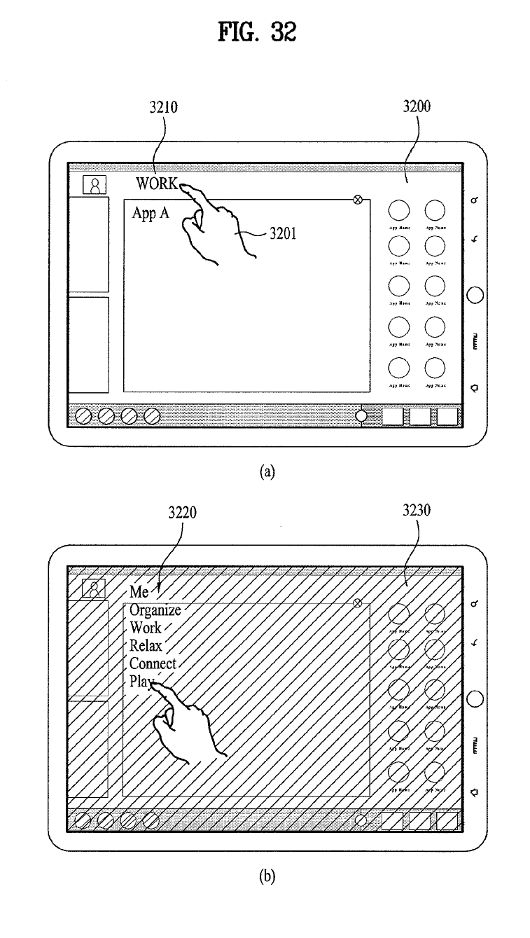

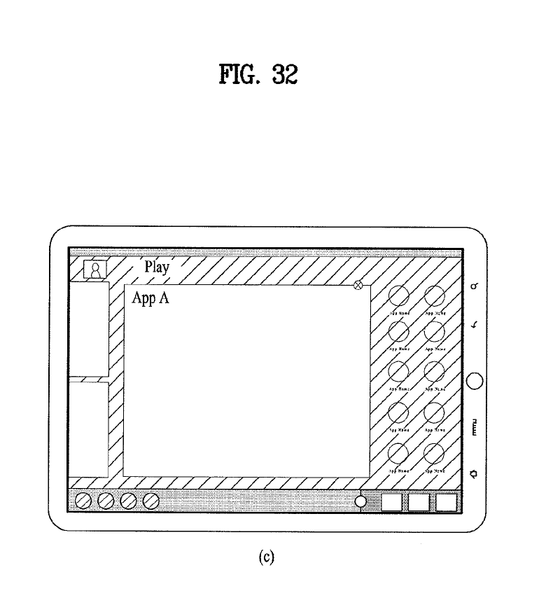

FIGS. 32(a)˜32(c) illustrate exemplary user interfaces for changing the application/job group(s) on a display screen in accordance with the some embodiments. If a user hopes to change an operating job in a certain group to another group on the display screen (3200), he (or she) can control the screen with a user gesture, for example touching the group name field (3210) as depicted in FIG. 32(a).

For instance, referring to FIG. 32(b), when a user touches the group name field (3210) as depicted in FIG. 32(a), the processor (101) can control to display the group name list (3220) listing all group names on the display screen (3200) and to change the display screen (3220) to an editing screen mode (3230). For example, for the editing screen mode (3230), the processor (101) can control the display screen (3220) to be blurred or the background color and/or font color of the display screen can change or other indication can be provided.

From the editing screen mode (3230), the user may select a desired group to be operated as a main job group. For example, referring to FIG. 32(c), if the user selects a ‘PLAY’ group from the screen of FIG. 32(b), the processor (101) determines a first job in the ‘PLAY’ group among a plurality of applications included in the ‘PLAY’ group. For example, the processor (101) can determine one of the applications included in the ‘PLAY’ group as a first job, which was most recently accessed by a user in the ‘PLAY’ group. Alternatively, for example, the processor (101) can determine a predefined application as a first job, which was a default setting application set as a first job by a user or a system initially or later.

After determining the first job for the selected current job group (PLAY), the processor (101) can determine at least one second job and common job(s) for configuring the display screen of the selected ‘PLAY’ group. The second jobs and common jobs can be determined as discussed above, e.g., based on one of the embodiments of FIG. 6 and FIG. 18.

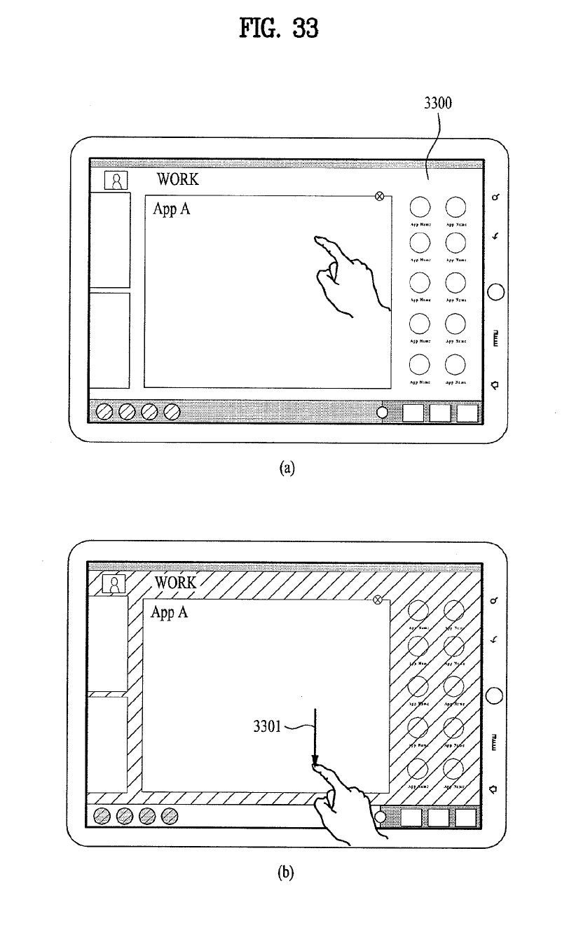

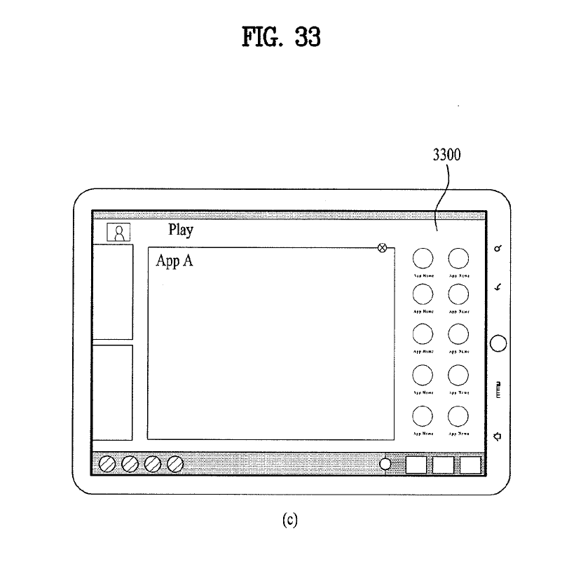

FIGS. 33(a)˜33(c) illustrate exemplary user interfaces for changing a group on a display screen in accordance with the some embodiments. Alternative to FIGS. 32(a)˜32(c), if a user hopes to change an operating group to another group on the display screen (3300), he (or she) can control the screen with a user gesture, for example touch-dragging the screen (3300) to a down direction (3301) as depicted in FIGS. 33(a) and 33(b). Once the user gesture (3301) is detected, the processor (101) controls the display screen (3300) to display a changed screen of the corresponding group. For instance, the processor (101) can recognize the down-direction gesture as a command to go back to the previous main job group as shown in FIG. 32(c) or to switch the current job group to a next job group (e.g., RELAX) on the list shown in FIG. 32(b). After the user gesture (3301) is completed, the processor (101) can determine a first job, at least one second jobs and common jobs of the newly displayed job group as a similar process of FIGS. 32(a)˜32(c) above.

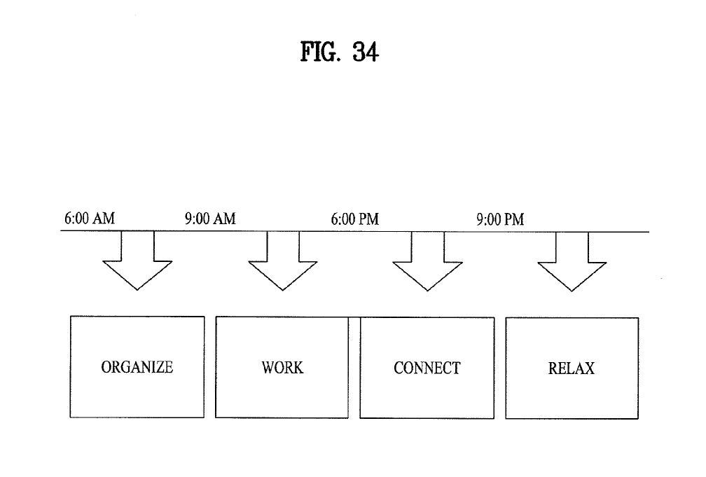

FIG. 34 is an exemplary diagram in accordance with a third embodiment of the present invention. When a computing device is powered on, the device can display a predetermined screen image on a display screen. In this exemplary embodiment, FIG. 34 provides a time-scheduled screen or a time-based screen responding to a current time. For example, a predefined group responding to a specific time period is pre-established. In this example, the ‘ORGANIZE’ group may be pre-established with respect to a morning time (e.g., 6:00˜9:00 am). The ‘WORK’ group may be pre-established with respect to a business time (e.g., 9:00 am˜6:00 pm). The ‘CONNECT’ group may be pre-established with respect to an evening time (e.g., 6:00 pm˜9:00 pm). And the ‘RELAX’ group may be pre-established with respect to a night time (e.g., 9:00 pm˜). Thus, when the computing device is powered on at a certain time, the processor (101) identifies the current time and determines a pre-established group corresponding to the current time, and determines an application as a first job, for example, which was most recently accessed by a user in the determined group. Alternatively, the processor (101) can determine an application as a first job which was pre-established by a system or a user's selection. Next, the processor (101) can determine at least one second job and common jobs as discussed above, e.g., based on one of the embodiments of FIG. 6 and FIG. 18.

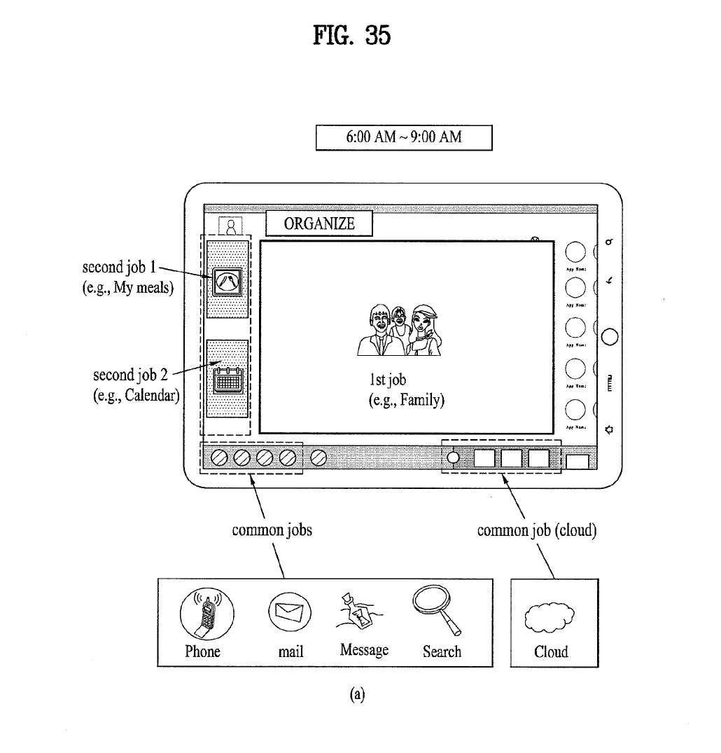

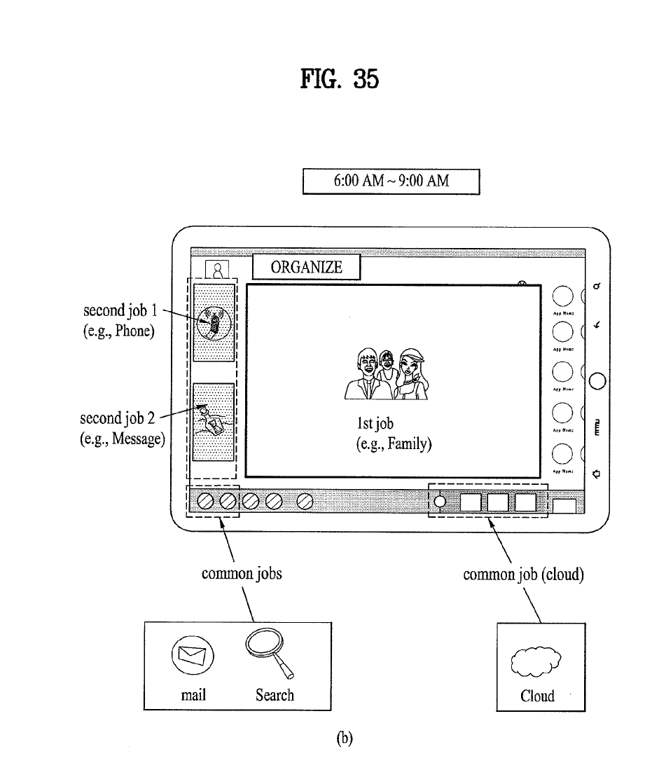

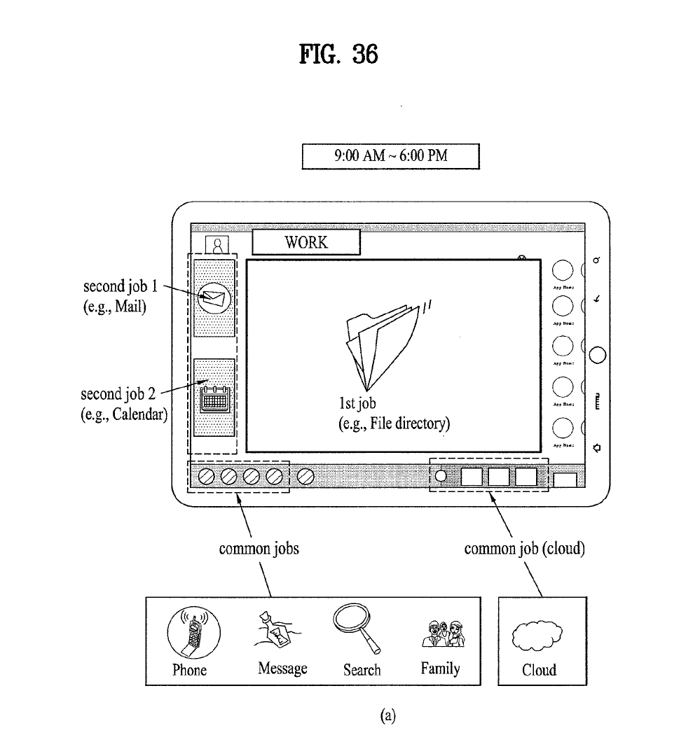

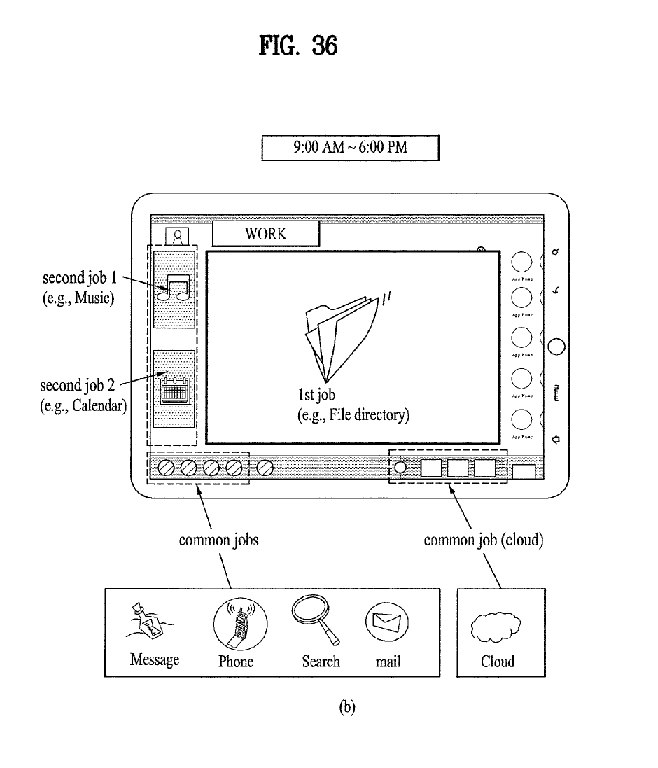

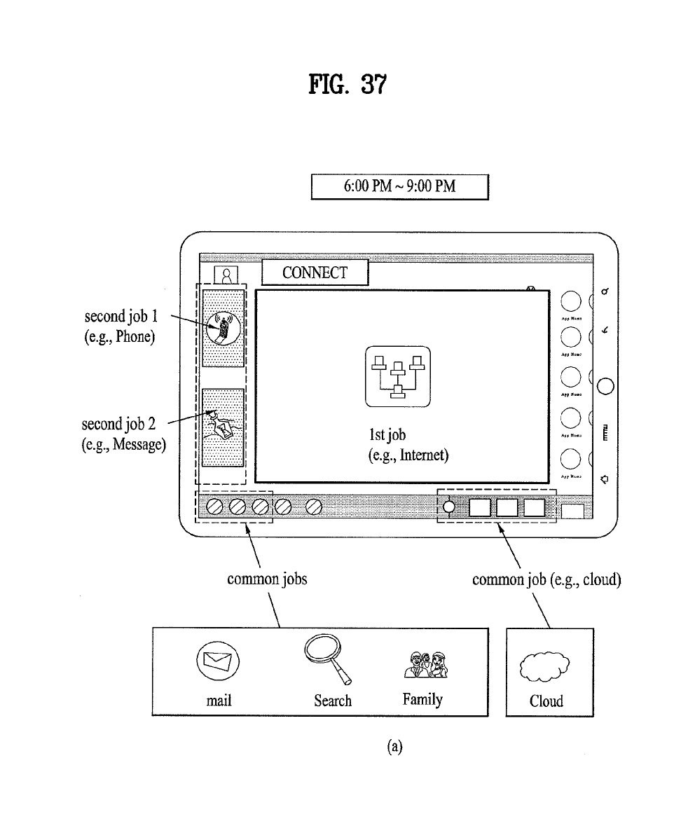

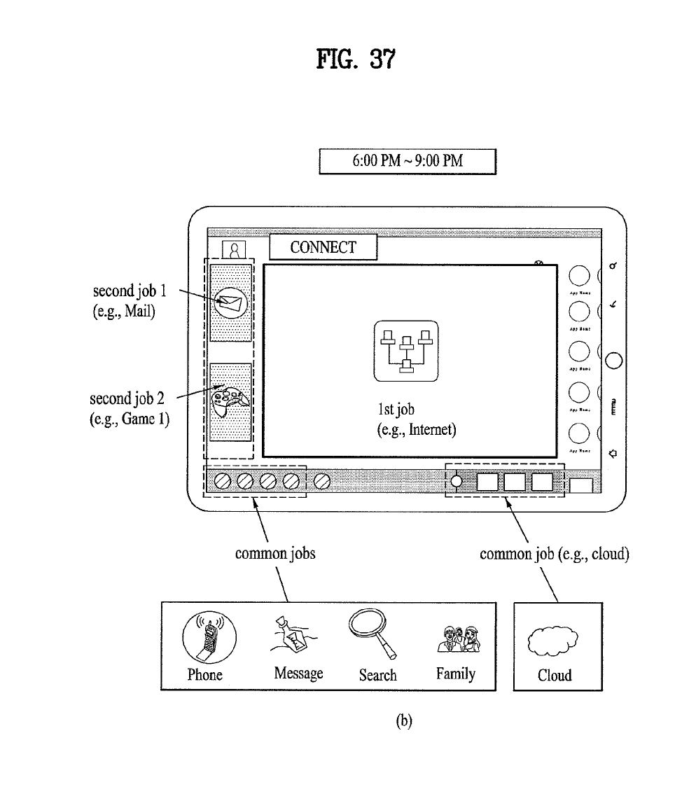

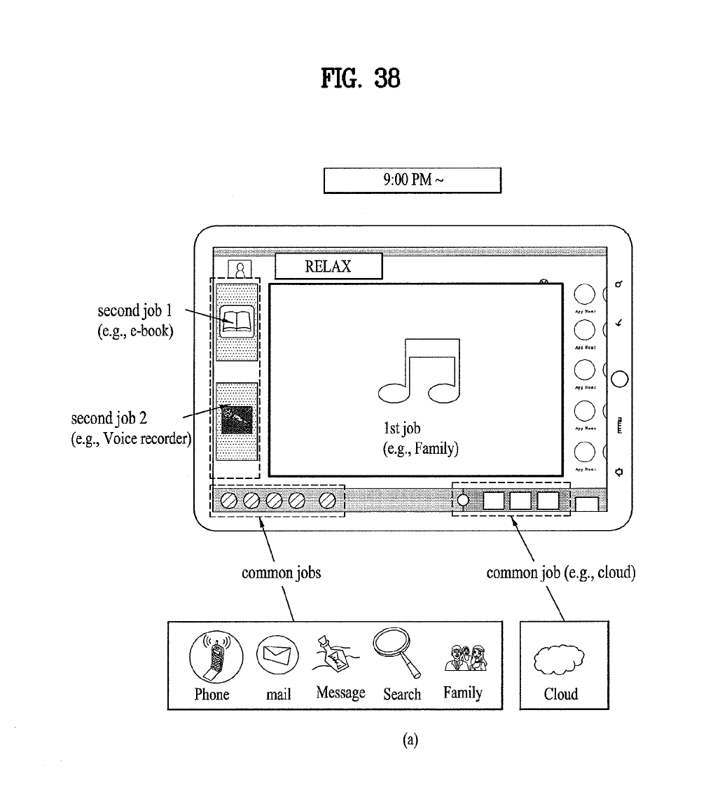

FIG. 35(a) and FIG. 35(b) illustrate an exemplary configuration of a display screen in accordance with the embodiment of FIG. 34. When the computing device is powered on during 6:00 am˜9:00 am, the processor (101) can recognize the ‘ORGANIZE’ group to be displayed at the time duration in view of the pre-establishments made in connection with FIG. 34. Further, for example, the processor (101) may determine a ‘family’ application as a first job of the ‘ORGANIZE’ group, since the ‘family’application was most recently accessed by a user from the ‘ORGANIZE’ group, e.g., before the power was turned on to the computing device. As a variation, the processor (101) may determine the ‘family’ application as a first job, since the ‘family’ application was pre-established to be a first job in the ‘ORGANIZE’ group by a system or a user's selection, e.g., before the power to the device was turned on. Next, the processor (101) can determine at least one second job and common jobs as discussed above, e.g., based on one of the embodiments of FIG. 6 and FIG. 18. For example, FIG. 35(a) shows an example case in accordance with the embodiment of FIG. 6 such that the second jobs and common jobs can be determined as the same or similar manner of FIG. 8(b). Alternatively, for example, FIG. 35(b) shows an example case in accordance with the embodiment of FIG. 18 such that the second jobs and common jobs can be determined as the same or similar manner of FIG. 21(c).

FIG. 36(a) and FIG. 36(b) illustrate an exemplary configuration of a display screen in accordance with the embodiment of FIG. 34. When the computing device is powered on during 9:00 am˜6:00 pm, the processor (101) can recognize the ‘WORK’ group to be displayed at the time duration as the operating job group. Further, for example, the processor (101) may determine a ‘file directory’ application as a first job, since the ‘file directory’ application was most recently accessed by a user in the ‘WORK’ group before the device power was turned on. As a variation, the processor (101) may determine the ‘file directory’ application as a first job, since the ‘file directory’ application was pre-established to be a first job in the ‘WORK’ group by a system or a user's selection before the device power was turned on. Next, the processor (101) can determine at least one second job and common jobs as discussed above, e.g., based on one of the embodiments of FIG. 6 and FIG. 18. For example, FIG. 36(a) shows an example case in accordance with the embodiment of FIG. 6 such that the second jobs and common jobs can be determined in the same or similar manner of FIG. 7(c). Alternatively, for example, FIG. 36(b) shows an example case in accordance with the embodiment of FIG. 18 such that the second jobs and common jobs can be determined in the same or similar manner of FIG. 19(b).

FIG. 37(a) and FIG. 37(b) illustrate an exemplary configuration of a display screen in accordance with the embodiment of FIG. 34. When the computing device is powered on during 6:00 pm˜9:00 pm, the processor (101) can recognize the ‘CONNECT’ group to be displayed at the time duration as the operating job group. Further, for example, the processor (101) may determine an ‘internet’ application as a first job, since the ‘internet’ application was most recently accessed by a user in the ‘CONNECT’ group before the device power was turned on. As a variation, the processor (101) may determine the ‘internet’ application as a first job, since the ‘internet’ application was pre-established to be a first job in the ‘CONNECT’ group by a system or a user's selection before the device power was turned on. Next, the processor (101) can determine at least one second jobs and common jobs as discussed above, e.g., based on one of the embodiments of FIG. 6 and FIG. 18. For example, FIG. 37(a) shows an example case in accordance with the embodiment of FIG. 6 such that the second jobs and common jobs can be determined in the same or similar manner of FIG. 8(d). Alternatively, for example, FIG. 36(b) shows an example case in accordance with the embodiment of FIG. 18 such that the second jobs and common jobs can be determined in the same or similar manner of FIG. 23(b).

FIG. 38(a) and FIG. 38(b) illustrate an exemplary configuration of a display screen in accordance with the embodiment of FIG. 34. When the computing device is powered on after 9:00 pm, the processor (101) can recognize the ‘RELAX’ group to be displayed at the time duration as the operating job group. Further, for example, the processor (101) may determine a ‘music’ application as a first job, since the ‘music’ application was most recently accessed by a user in the ‘RELAX’ group before the device power was turned on. As a variation, the processor (101) may determine the ‘music’ application as a first job, since the ‘music’ application was pre-established to be a first job in the ‘RELAX’ group by a system or a user's selection before the device power was turned on. Next, the processor (101) can determine at least one second job and common jobs as discussed above, e.g., based on one of the embodiments of FIG. 6 and FIG. 18. For example, FIG. 37(a) shows an example case in accordance with the embodiment of FIG. 6 such that the second jobs and common jobs can be determined in the same or similar manner of FIG. 8(c). Alternatively, for example, FIG. 36(b) shows an example case in accordance with the embodiment of FIG. 18 such that the second jobs and common jobs can be determined in the same or similar manner of FIG. 22(b).

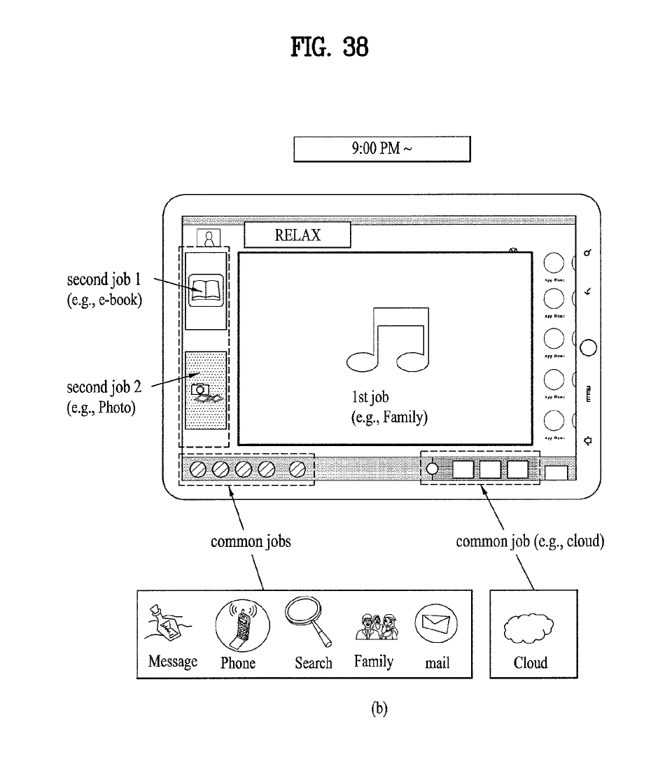

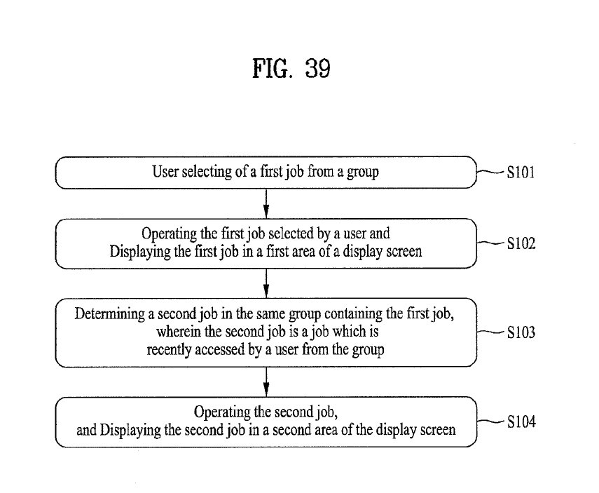

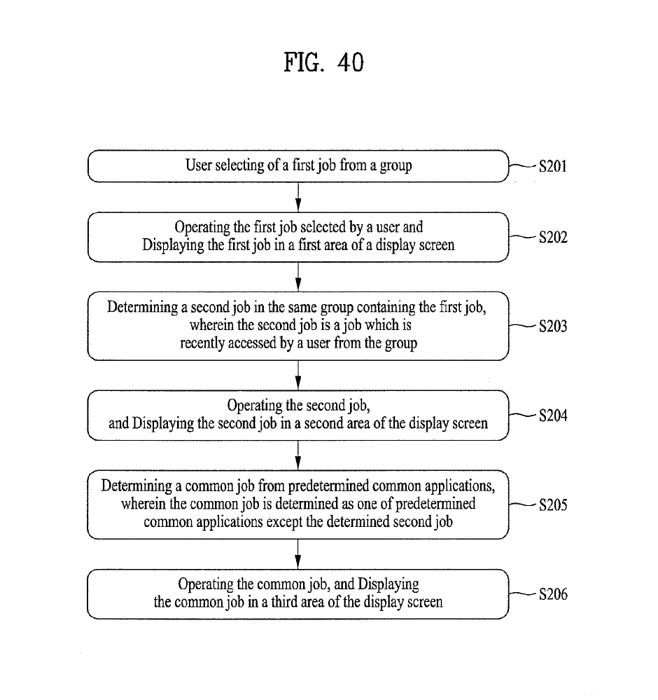

FIGS. 39˜41 illustrate an exemplary flow chart in accordance with the embodiment of FIG. 6.

FIG. 39 illustrates an exemplary flow chart when ‘2-Tier’ levels in FIG. 2 are applied to the embodiment of FIG. 6. The user can select a job group among available job groups. Further, in this exemplary case, the processor (101) identifies a user command of selecting a first job from a certain group (e.g., job group selected or otherwise designated) (S101). For example, the user command of selecting a first job can be recognized by a user gesture or user's predefined reaction. The processor (101) operates the first job selected by a user and displays the first job in a first area of the display screen (S102). Next, the processor (101) determines a second job in the same group containing the first job, wherein the second job can be an application which is recently accessed by a user from the same group (S103). Also, the processor (101) operates (e.g., executes) the second job and displays the second job in a second area of the display screen (S104).

FIG. 40 illustrates an exemplary flow chart when ‘3-Tier’ levels in FIG. 3 are applied to the embodiment of FIG. 6. The user can select a job group among the available job groups. Further, in this exemplary case, the processor (101) identifies a user command of selecting a first job from a certain group (e.g., job group selected or otherwise designated) (S201). For example, the user command of selecting a first job can be recognized by a user gesture or user's predefined reaction. The processor (101) operates the first job selected by the user and displays the first job in a first area of the display screen (S202). Next, the processor (101) determines a second job in the same group containing the first job, wherein the second job can be an application which is recently accessed by a user in the same group (S203). Also, the processor (101) operates the second job and displays the second job in a second area of the display screen (S204). Further, the processor (101) determines a common job from predetermined common applications (501 in FIG. 5), wherein the common job is determined as one of the predetermined common applications excluding the applications corresponding to the determined first job and second job (S205). Furthermore, the processor (101) operates the determined common job, and displays the determined common job in a third area or global area of the display screen (S206).

FIG. 41 illustrates an exemplary flow chart in case of job switching process is applied to the embodiment of FIG. 6. In this exemplary case, after selecting a first job and determining a second job in a same group are completed, the processor (101) operates the first job and the second job and displays the first job in a first area and the second job in a second area of a display screen (S301). The processor (101) determines whether a user gesture for switching the jobs/applications between the first job and the second job is detected or not (S302). If the user gesture for switching the jobs between the first job and the second job is detected, the processor (101) operates the switched first job (former second job) and displays the switched first job (former second job) in the first area (S303). Also, the processor (101) operates the switched second job (former first job) and displays the switched second job in the second area (S304). However, if the user gesture for switching the jobs between the first job and the second job is not detected at step S302, the process can return to step S301.

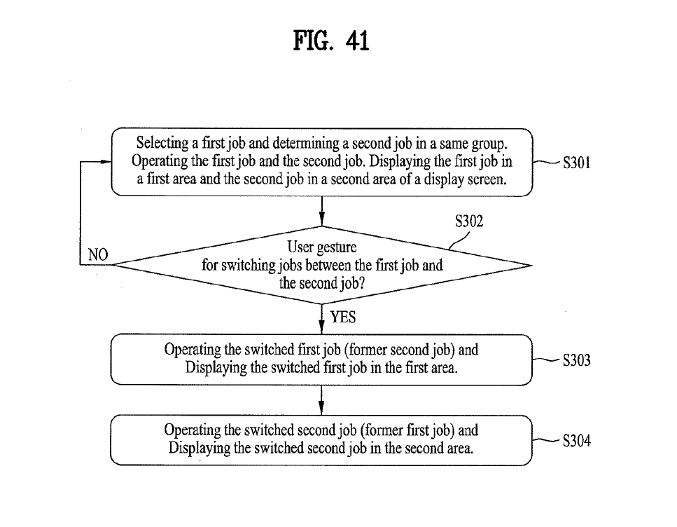

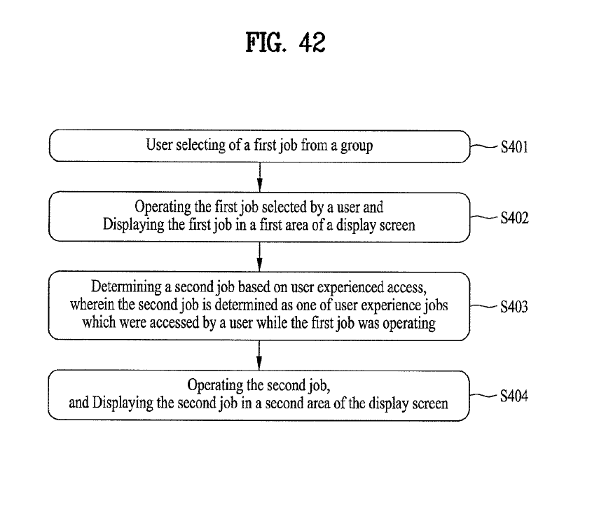

FIGS. 42˜44(b) illustrate an exemplary flow chart in accordance with the embodiment of FIG. 18.

FIG. 42 illustrates an exemplary flow chart when ‘2-Tier’ levels in FIG. 2 are applied to the embodiment of FIG. 18. In this exemplary case, the processor (101) identifies a user command of selecting a first job from a certain group (e.g., job group selected or otherwise designated) (S401). For example, the user command of selecting a first job can be recognized by a user gesture or user's predefined reaction. The processor (101) operates the first job selected by a user and displays the first job in a first area of the display screen (S402). Next, the processor (101) determines a second job based on user experienced access, wherein the second job is determined as one of user experience jobs which were accessed by a user while the first job was operating (S403). In this example or other examples, the user experience jobs as the second jobs merely can mean or include those jobs or applications that have been accessed by the user while the first job was operating or running. Also, the processor (101) operates the second job and displays the second job in a second area of the display screen (S404).

FIG. 43 illustrates an exemplary flow chart when ‘3-Tier’ levels in FIG. 3 are applied to the embodiment of FIG. 18. In this exemplary case, the processor (101) identifies a user command of selecting a first job from a certain group (e.g., job group selected or otherwise designated) (S401). For example, the user command of selecting a first job can be recognized by a user gesture or user's predefined reaction. The processor (101) operates the first job selected by a user and displays the first job in a first area of the display screen (S402). Next, the processor (101) determines a second job based on user experienced access, wherein the second job is determined as one of user experience jobs which were accessed by a user while the first job was operating (S403). Also, the processor (101) operates the second job and displays the second job in a second area of the display screen (S404). Further, the processor (101) determines a common job from predetermined common applications (501 in FIG. 5), based on user experienced access, wherein the common job is determined as one of user experience common applications excluding the applications corresponding to the first job and the determined second job, which were accessed by a user while the first job was operating (S505). In this example other examples, the user experience common applications can merely mean or include those common applications that were accessed by the user while the first job was operating or running. Furthermore, the processor (101) operates the determined common job, and displays the determined common job in a third area or global area of the display screen (S506).

FIG. 44(a) illustrates an exemplary flow chart in case of job switching process is applied to the embodiment of FIG. 18. In this exemplary case, after selecting a first job and determining a second job based on user experienced access are completed, the processor (101) operates the first job and the second job and displays the first job in a first area and the second job in a second area of a display screen (S601). The processor (101) determines whether a user gesture for switching the jobs (applications) between the first job and the second job is detected or not (S602). If the user gesture for switching the jobs between the first job and the second job is detected, the processor (101) operates the switched first job (former second job) and displays the switched first job (former second job) in the first area (S603).

Further, the processor (101) determines a new second job based on user experienced access, wherein the new second job is determined as one of user experience jobs which were accessed by a user while the switched first job was operating as a first job (S604). Also, the processor (101) operates the switched second job (former first job) and displays the switched second job in the second area (S604). However, if the user gesture for switching the jobs between the first job and the second job is not detected at step S602, the process returns to step S601 and step S601 can be still processed.

FIG. 44(b) illustrates another exemplary flow chart in case of a job switching process is applied to the embodiment of FIG. 18. In this exemplary case, after selecting a first job and determining a second job based on user experienced access are completed, the processor (101) operates the first job and the second job and displays the first job in a first area and the second job in a second area of a display screen (S701). The processor (101) determines whether a user gesture for switching the jobs (or applications) between the first job and the second job is detected or not (S702). If a user gesture for switching the jobs between the first job and the second job is detected, the processor (101) further determines whether or not a user command for changing the configuration of the display screen is recognized from the user gesture (S702).

If the user command for changing the configuration of the display screen is recognized or received, the processor (101) operates the switched first job (former second job) and displays the switched first job (former second job) in the first area (S706). Furthermore, the processor (101) determines a new second job based on user experienced access, wherein the new second job is determined as one of user experience jobs which were accessed by a user while the switched first job was operating as a first job (S707). Also, the processor (101) operates the switched second job (former first job) and displays the switched second job in the second area (S708). However, if the user gesture for switching the jobs between the first job and the second job is not detected at step S702, the process returns to step S701 and step S701 can be still processed.

In another flow, if the user command for changing the configuration of the display screen is not recognized or received, the processor (101) operates the switched first job (former second job) and displays the switched first job (former second job) in the first area (S704). Also, the processor (101) operates the switched second job (former first job) and displays the switched second job in the second area (S705). However, if the user gesture for switching the jobs between the first job and the second job is not detected at step S702, the process returns to and step S701 can be processed.

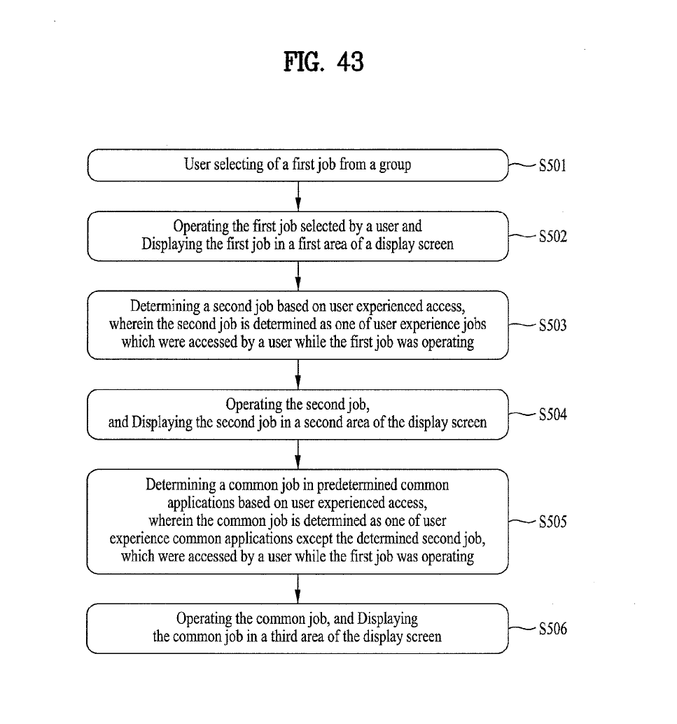

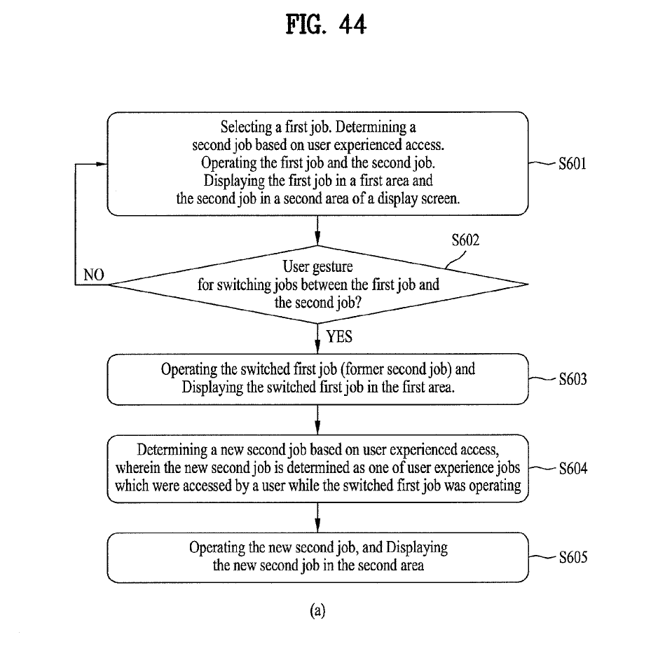

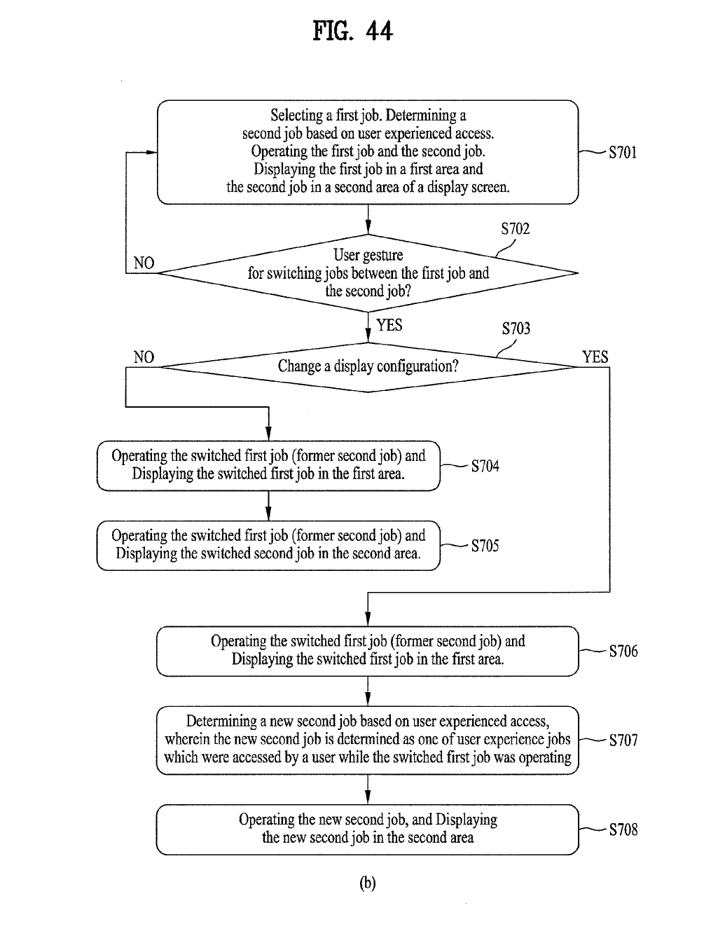

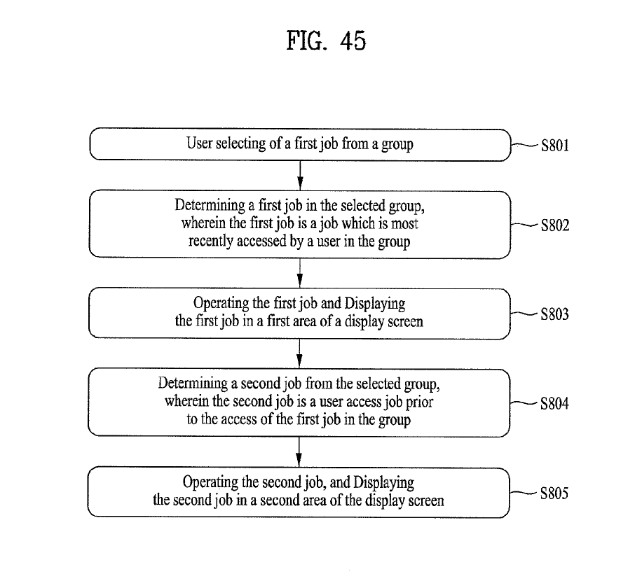

FIGS. 45˜47 illustrate exemplary flow charts in accordance with the embodiments of FIGS. 6 and 32.

FIG. 45 illustrates an exemplary flow chart when ‘2-Tier’ levels in FIG. 2 are applied to the embodiment of FIG. 6 in view of FIGS. 32(a)˜33(c). In this exemplary case, the processor (101) identifies a user command of selecting a group from a plurality of groups such as the groups shown in FIG. 4 (S801). For example, the user command of selecting the group can be recognized by a user gesture or user's predefined reaction. The processor (101) determines a first job in the selected group, wherein the first job can be determined as an application which was most recently accessed by a user from the selected group (S802). And the processor (101) operates the first job and displays the first job in a first area of a display screen (S803). Next, the processor (101) determines a second job in the selected group containing the first job, wherein the second job can be a user access job prior to the access of the first job from the selected group (S804). For instance, in this or other examples, the second job can be a job (from the corresponding group) that was accessed by the user prior to the accessing of the first job. Further, the processor (101) operates the second job and displays the second job in a second area of the display screen (S805).

FIG. 46 illustrates an exemplary flow chart when ‘3-Tier’ levels in FIG. 3 are applied to the embodiment of FIG. 6 in view of FIGS. 32(a)˜33(c). In this exemplary case, the processor (101) identifies a user command of selecting a group from a plurality of groups such as the groups shown in FIG. 4 (S901). For example, the user command of selecting the group can be recognized by a user gesture or user's predefined reaction. The processor (101) determines a first job for the selected group, wherein the first job can be determined as an application which was most recently accessed by a user from the selected group (S902). And the processor (101) operates the first job and displays the first job in a first area of a display screen (S903). Next, the processor (101) determines a second job for the selected group containing the first job, wherein the second job can be a user access job prior to the access of the first job in the selected group (S904). Further, the processor (101) operates the second job and displays the second job in a second area of the display screen (S905). Further, the processor (101) determines a common job from predetermined common applications (501 in FIG. 5), wherein the common job can be determined as one of predetermined common applications excluding the determined first job and second job (S906). Furthermore, the processor (101) operates the determined common job and displays the determined common job in a third area or global area of the display screen (S906).

FIG. 47 illustrates an exemplary flow chart in case of a job switching process is applied to the embodiment of FIG. 6 in view of FIGS. 32(a)˜33(c). In this exemplary case, after selecting a group and determining a first job and a second job for the selected group are completed, the processor (101) operates the first job and the second job and displays the first job in a first area of a display screen and the second job in a second area of the display screen (S1001). The processor (101) determines whether a user gesture for switching the jobs between the first job and the second job is detected or not (S1002). If the user gesture for switching the jobs between the first job and the second job is detected, the processor (101) operates the switched first job (former second job) and displays the switched first job (former second job) in the first area of the display screen (S1003). Also, the processor (101) operates the switched second job (former first job) and displays the switched second job in the second area of the display screen (S1004). However, if the user gesture for switching the jobs between the first job and the second job is not detected at step S1002, the process returns to step S1001 and step S1001 can be processed.

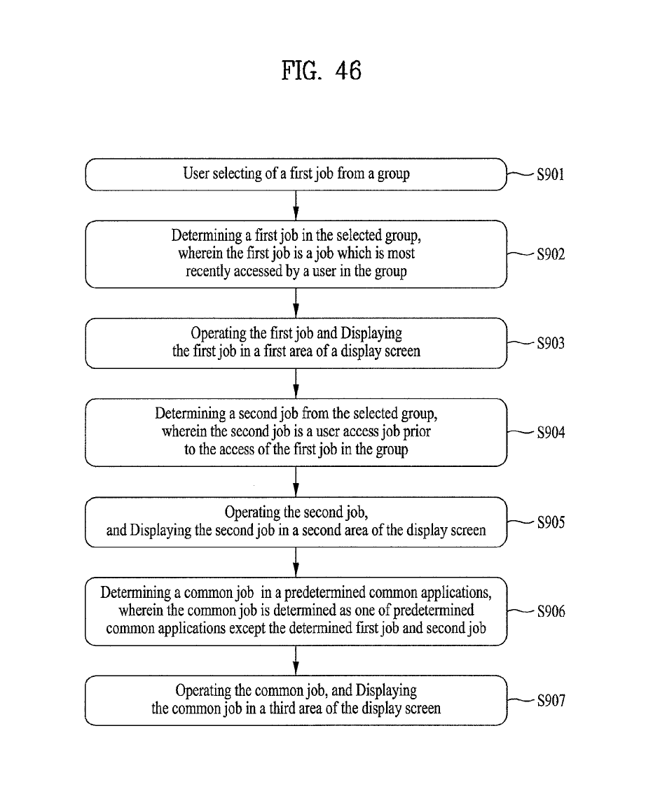

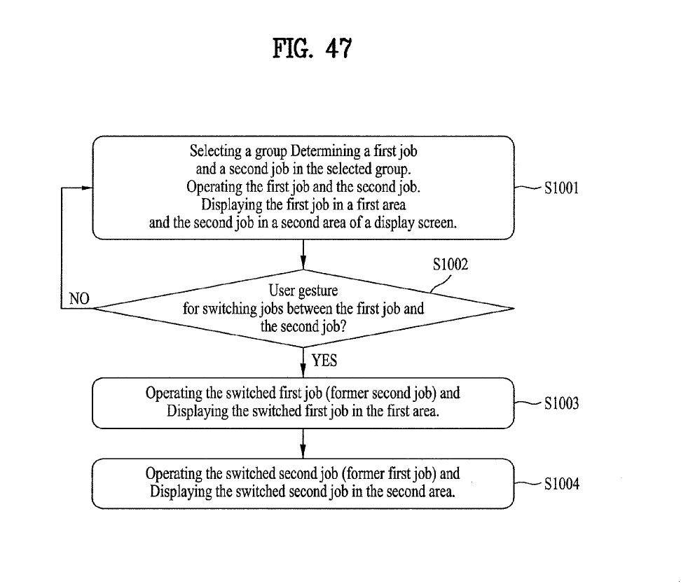

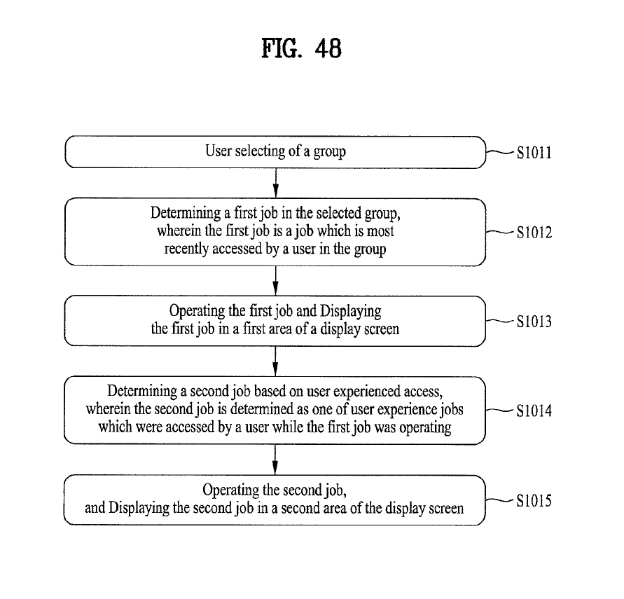

FIGS. 48˜50(b) illustrate exemplary flow charts in accordance with the embodiments of FIGS. 18 and 32.

FIG. 48 illustrates an exemplary flow chart when ‘2-Tier’ levels in FIG. 2 are applied to the embodiment of FIG. 18 in view of FIGS. 32(a)˜33(c). In this exemplary case, the processor (101) identifies a user command of selecting a group from a plurality of groups such as the groups shown in FIG. 4 (S1011). For example, the user command of selecting the group can be recognized by a user gesture or user's predefined reaction. The processor (101) determines a first job for the selected group, wherein the first job can be determined as an application which was most recently accessed by a user from the selected group (S1012). And the processor (101) operates the first job and displays the first job in a first area of a display screen (S1013). Next, the processor (101) determines a second job based on user experienced access, wherein the second job is determined as one of user experience jobs which were accessed by the user while the first job was operating (S1014). Also, the processor (101) operates the second job and displays the second job in a second area of the display screen (S1015).

FIG. 49 illustrates an exemplary flow chart when ‘3-Tier’ levels in FIG. 3 are applied to the embodiment of FIG. 18 in view of FIGS. 32(a)˜33(c). In this exemplary case, the processor (101) identifies a user command of selecting a group from a plurality of groups such as the groups shown in FIG. 4 (S1021). For example, the user command of selecting the group can be recognized by a user gesture or user's predefined reaction. The processor (101) determines a first job for the selected group, wherein the first job can be determined as an application which was most recently accessed by a user from the selected group (S1022). And the processor (101) operates the first job and displays the first job in a first area of a display screen (S1023). Next, the processor (101) determines a second job based on user experienced access, wherein the second job is determined as one of user experience jobs which were accessed by the user while the first job was operating (S1024). Also, the processor (101) operates the second job and displays the second job in a second area of the display screen (S1025).

Further, the processor (101) determines a common job from predetermined common applications (501 in FIG. 5), based on user experienced access, wherein the common job is determined as one of user experience common applications excluding the determined first job and second job, which were accessed by the user while the determined first job was operating (S1026). Furthermore, the processor (101) operates the determined common job and displays the determined common job in a third area or global area of the display screen (S1027).

FIG. 50(a) illustrates an exemplary flow chart in case of a job switching process is applied to the embodiment of FIG. 18 in view of FIGS. 32(a)˜33(c). In this exemplary case, after selecting a group and determining a first job and a second job for the selected group are completed, the processor (101) operates the first job and the second job and displays the first job in a first area of a display screen and the second job in a second area of the display screen (S1031). The processor (101) determines whether a user gesture for switching the jobs between the first job and the second job is detected or not (S1032). If the user gesture for switching the jobs between the first job and the second job is detected, the processor (101) operates the switched first job (former second job) and displays the switched first job (former second job) in the first area of the display screen (S1033).

Further, the processor (101) determines a new second job based on user experienced access, wherein the new second job is determined as one of user experience jobs which were accessed by the user while the switched first job was operating as a first job (S1034). Also, the processor (101) operates the switched second job (former first job) and displays the switched second job in the second area of the display screen (S1035). However, if the user gesture for switching the jobs between the first job and the second job is not detected at step S1032, the process returns to step S1031 and step S1031 can be processed.

FIG. 50(b) illustrates another exemplary flow chart in case of a job switching process is applied to the embodiment of FIG. 18 in view of FIGS. 32(a)˜33(c). In this exemplary case, after selecting a group and determining a first job and a second job for the selected group are completed, the processor (101) operates the first job and the second job and displays the first job in a first area of a display screen and the second job in a second area of the display screen (S1041). The processor (101) determines whether a user gesture for switching the jobs between the first job and the second job is detected or not (S1042). If the user gesture for switching the jobs between the first job and the second job is detected, the processor (101) further determines whether or not a user command of changing the configuration of the display screen is recognized from the user gesture (S1043).

If the user command of changing the configuration of the display screen is recognized or received, the processor (101) operates the switched first job (former second job) and displays the switched first job (former second job) in the first area of the display screen (S1046). Furthermore, the processor (101) determines a new second job based on user experienced access, wherein the new second job is determined as one of user experience jobs which were accessed by the user while the switched first job was operating as a first job (S1047). Also, the processor (101) operates the switched second job (former first job) and displays the switched second job in the second area of the display screen (S1048). However, if the user gesture for switching the jobs between the first job and the second job is not detected at step S1042, the process returns to step S1041 and step S1041 can be processed.

In another flow, if the user command of changing the configuration of the display screen is not recognized or received at step S1043, the processor (101) operates the switched first job (former second job) and displays the switched first job (former second job) in the first area of the display screen (S1044). Also, the processor (101) operates the switched second job (former first job) and displays the switched second job in the second area of the display screen (S1045). However, if the user gesture for switching the jobs between the first job and the second job is not detected at step S1042, the process returns to step S1041 and step S1041 can be processed.

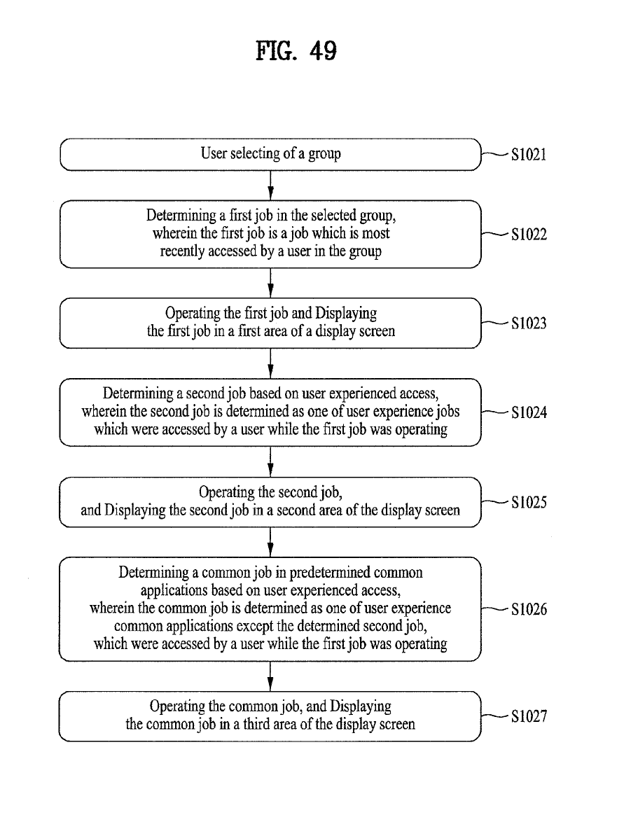

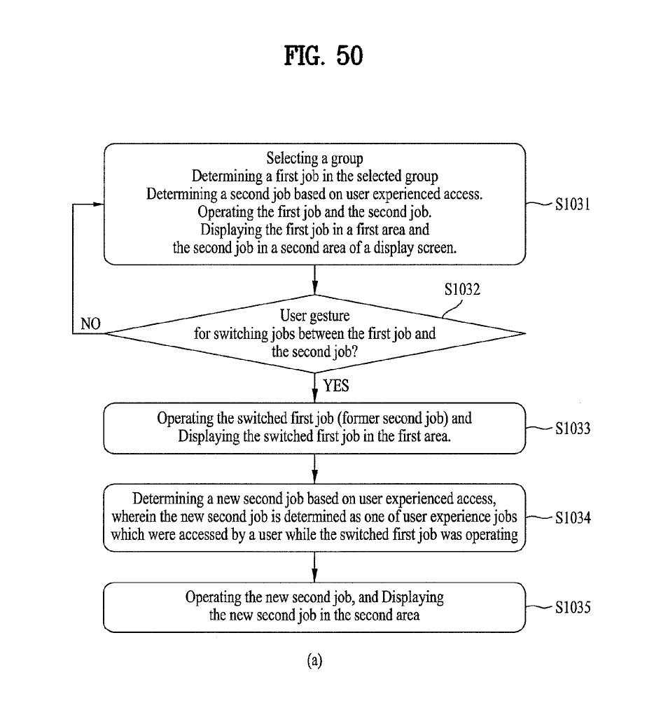

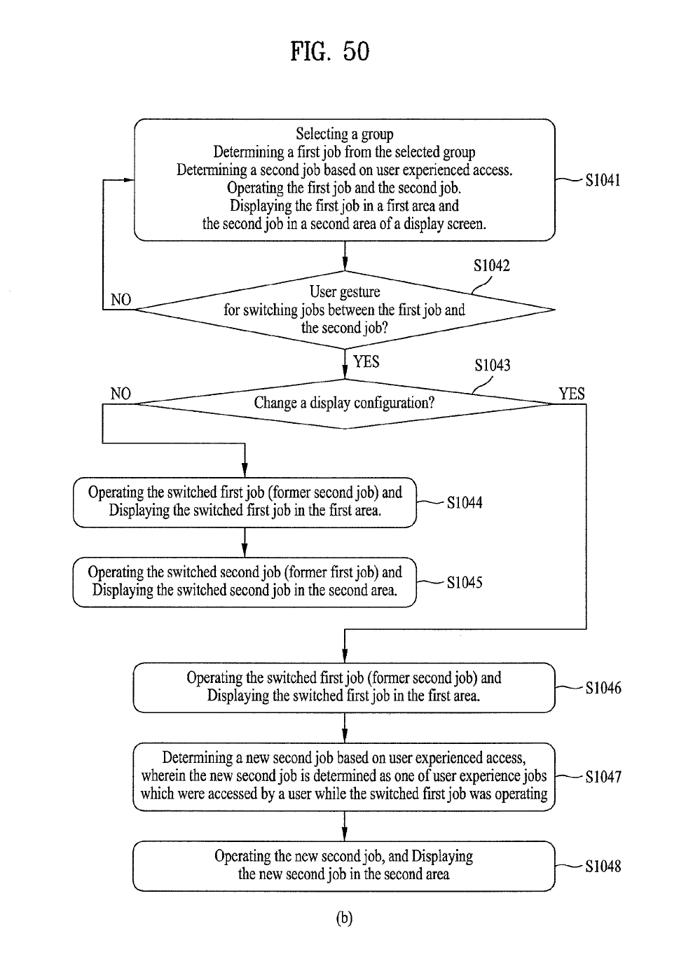

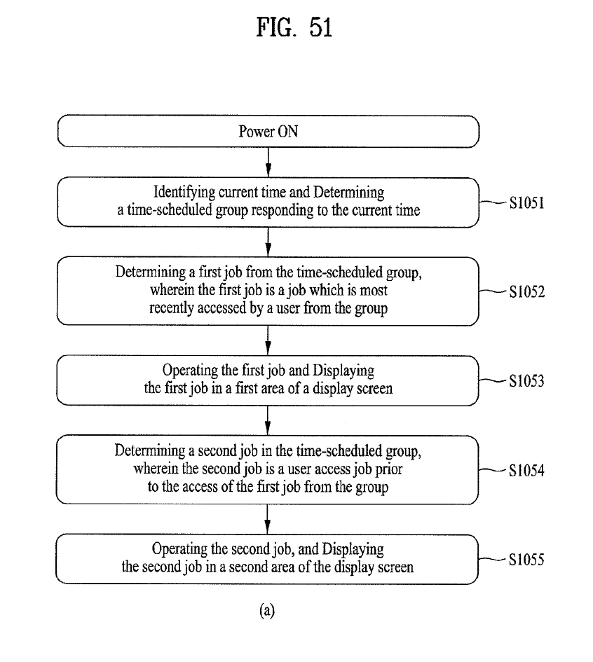

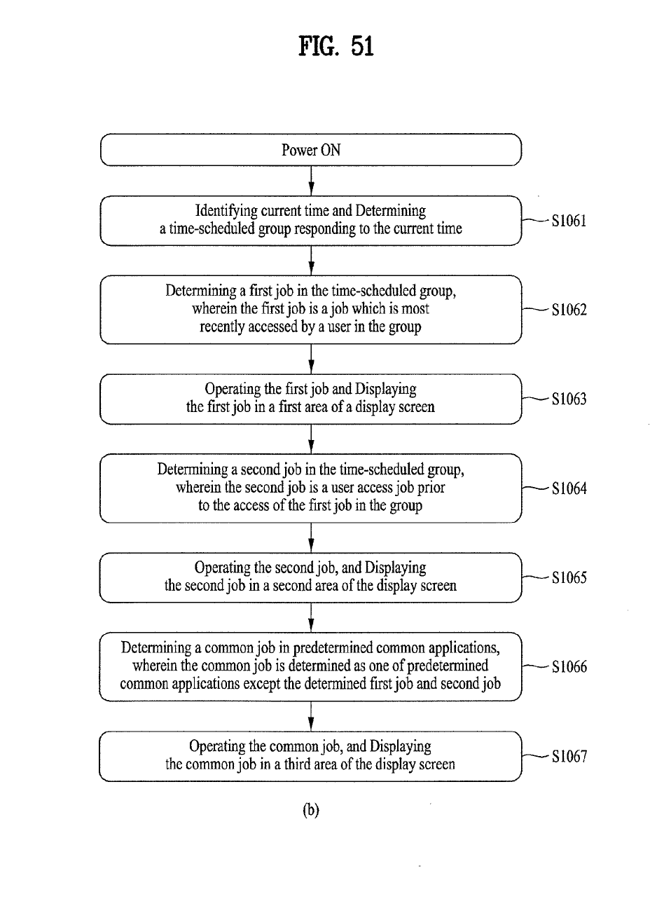

FIGS. 51(a)˜52 illustrate exemplary flow charts in accordance with the embodiments of FIGS. 6 and 34.

FIG. 51(a) illustrates an exemplary flow chart when ‘2-Tier’ levels in FIG. 2 are applied to the embodiment of FIG. 6 in view of FIG. 34. In this exemplary case, the processor (101) identifies the current time when the computing device (100) is powered on and determines a time-scheduled group corresponding to the current time (S1051). For instance, in this example or other examples below, the time-scheduled group can be pre-established by a system or user's selection before the power is on, e.g., the determined time-scheduled group can be one of the pre-established groups shown in FIG. 34 that corresponds to the current time. The processor (101) determines a first job for the time-scheduled group, wherein the first job can be determined as an application which was most recently accessed by the user in the time-scheduled group (S1052). And the processor (101) operates the first job and displays the first job in a first area of a display screen (S1053). Next, the processor (101) determines a second job for the time-scheduled group, wherein the second job can be a user access job prior to the access of the first job in the time-scheduled group (S1054). Further, the processor (101) operates the second job and displays the second job in a second area of the display screen (S1055).

FIG. 51(b) illustrates an exemplary flow chart when ‘3-Tier’ levels in FIG. 3 are applied to the embodiment of FIG. 6 in view of FIG. 34. In this exemplary case, the processor (101) identifies the current time when the computing device (100) is powered on and determines a time-scheduled group corresponding to the current time (S1061). For example, the time-scheduled group can be pre-established by a system or user's selection before the device power is turned on. The processor (101) determines a first job for the time-scheduled group, wherein the first job can be determined as an application which as most recently accessed by the user in the time-scheduled group (S1062). And the processor (101) operates the first job and displays the first job in the first area of the display screen (S1063). Next, the processor (101) determines a second job for the time-scheduled group, wherein the second job can be a user access job prior to the access of the first job in the time-scheduled group (S1064). Further, the processor (101) operates the second job and displays the second job in the second area of the display screen (S1065). Further, the processor (101) determines a common job from predetermined common applications (501 in FIG. 5), wherein the common job can be determined as one of predetermined common applications excluding the determined first job and second job (S1066). Furthermore, the processor (101) operates the determined common job and displays the determined common job in a third area or global area of the display screen (S1067).

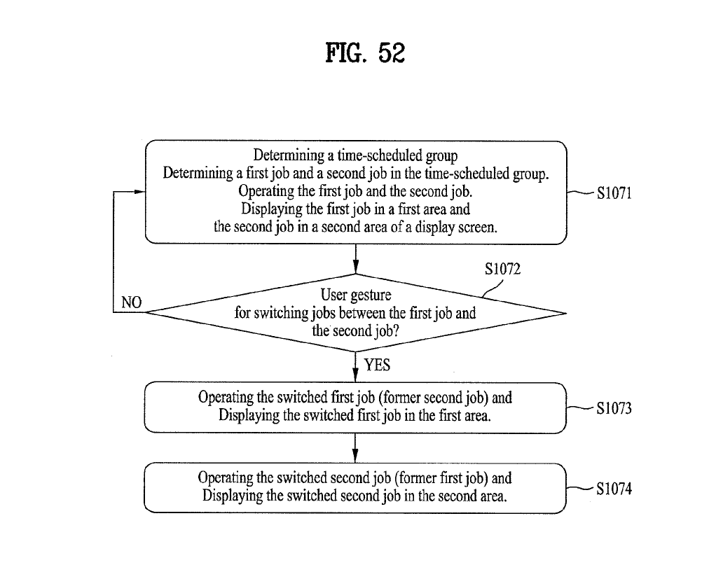

FIG. 52 illustrates an exemplary flow chart in case of a job switching process is applied to the embodiment of FIG. 6 in view of FIG. 34. In this exemplary case, after determining a time-scheduled group and determining a first job and a second job in the time-scheduled group are completed, the processor (101) operates the first job and the second job and displays the first job in a first area of a display screen and the second job in a second area of the display screen (S1071). The processor (101) determines whether a user gesture for switching the jobs between the first job and the second job is detected or not (S1072). If the user gesture for switching the jobs between the first job and the second job is detected, the processor (101) operates the switched first job (former second job) and displays the switched first job (former second job) in the first area of the display screen (S1073). Also, the processor (101) operates the switched second job (former first job) and displays the switched second job in the second area of the display screen (S1074). However, if the user gesture for switching the jobs between the first job and the second job is not detected at step S1072, the process returns to step S1071 and step S1071 can be processed.

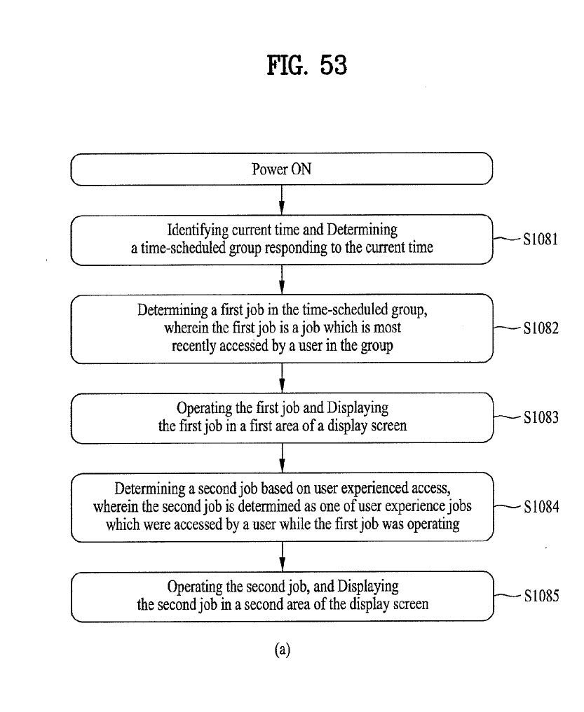

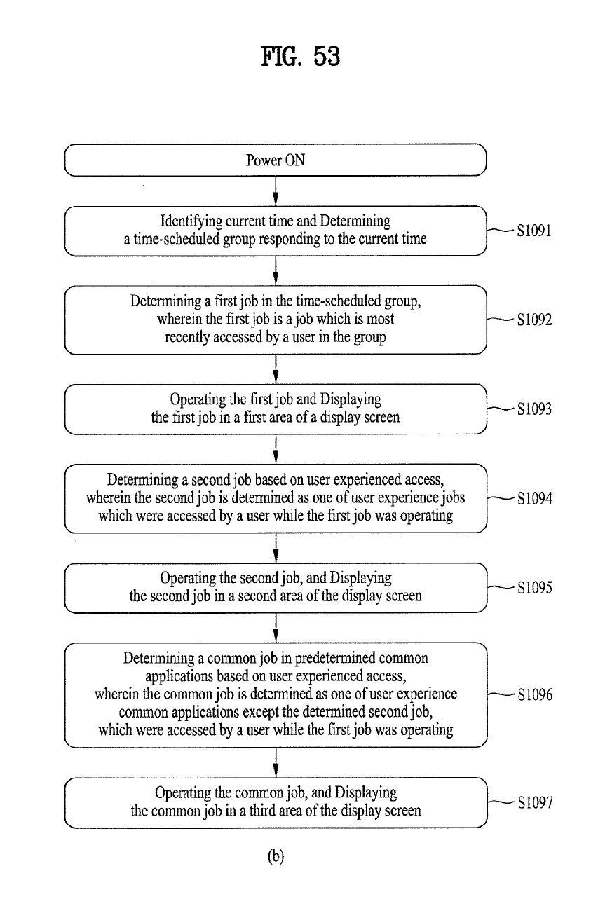

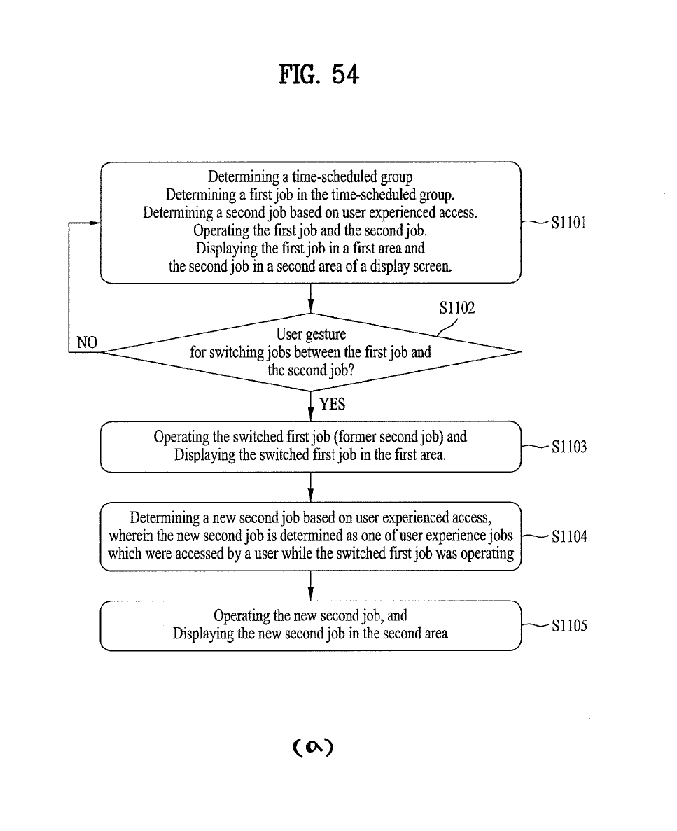

FIGS. 53(a)˜54(b) illustrate an exemplary flow chart in accordance with the embodiments of FIGS. 18 and 34.

FIG. 53(a) illustrates an exemplary flow chart when ‘2-Tier’ levels in FIG. 2 are applied to the embodiment of FIG. 18 in view of FIG. 34. In this exemplary case, the processor (101) identifies the current time when the computing device (100) is powered on and determines a time-scheduled group corresponding to the current time (S1081). For example, the time-scheduled group can be pre-established by a system or user's selection before the device power is on. The processor (101) determines a first job for the time-scheduled group, wherein the first job can be determined as an application which was most recently accessed by the user in the time-scheduled group (S1082). And the processor (101) operates the first job and displays the first job in a first area of a display screen (S1083). Next, the processor (101) determines a second job based on user experienced access, wherein the second job is determined as one of user experience jobs which were accessed by the user while the first job was operating (S1084). Also, the processor (101) operates the second job and displays the second job in a second area of the display screen (S1085).

FIG. 53(b) illustrates an exemplary flow chart when ‘3-Tier’ levels in FIG. 3 are applied to the embodiment of FIG. 18 in view of FIG. 34. In this exemplary case, the processor (101) identifies the current time when the computing device (100) is powered on and determines a time-scheduled group corresponding to the current time (S1091). For example, the time-scheduled group can be pre-established by a system or user's selection before the device power is on. The processor (101) determines a first job for the time-scheduled group, wherein the first job can be determined as an application which was most recently accessed by the user in the time-scheduled group (S1092). And the processor (101) operates the first job and displays the first job in a first area of a display screen (S1093). Next, the processor (101) determines a second job based on user experienced access, wherein the second job is determined as one of user experience jobs which were accessed by he user while the first job was operating (S1094). Also, the processor (101) operates the second job and displays the second job in a second area of the display screen (S1095).

Further, the processor (101) determines a common job from predetermined common applications (501 in FIG. 5), based on user experienced access, wherein the common job is determined as one of user experience common applications excluding the determined first job and second job, which were accessed by a user while the determined first job was operating (S1096). Furthermore, the processor (101) operates the determined common job and displays the determined common job in a third area or global area of the display screen (S1097).

FIG. 54(a) illustrates an exemplary flow chart in case of a job switching process is applied to the embodiment of FIG. 18 in view of FIG. 34. In this exemplary case, after determining a time-scheduled group and determining a first job and a second job in the time-scheduled group are completed, the processor (101) operates the first job and the second job and displays the first job in a first area of a display screen and the second job in a second area of the display screen (S1101). Wherein the determining the second job can be performed by using the information related to user experienced access. The processor (101) determines whether a user gesture for switching the jobs between the first job and the second job is detected or not (S1102). If the user gesture for switching the jobs between the first job and the second job is detected, the processor (101) operates the switched first job (former second job) and displays the switched first job (former second job) in the first area of the display screen (S1103).

Further, the processor (101) determines a new second job based on user experienced access, wherein the new second job is determined as one of user experience jobs which were accessed by the user while the switched first job was operating as a first job (S1104). Also, the processor (101) operates the switched second job (former first job) and displays the switched second job in the second area of the display screen (S1105). However, if the user gesture for switching the jobs between the first job and the second job is not detected at step S1102, the process returns to step S1101 and step S1101 can be processed.

FIG. 54(b) illustrates another exemplary flow chart in case of a job switching process is applied to the embodiment of FIG. 18 in view of in view of FIG. 34. In this exemplary case, after determining a time-scheduled group and determining a first job and a second job in the time-scheduled group are completed, the processor (101) operates the first job and the second job and displays the first job in a first area of a display screen and the second job in a second area of the display screen (S1111). Wherein the determining the second job can be performed by using the information related to user experienced access. The processor (101) determines whether or not a user gesture for switching the jobs between the first job and the second job is detected (S1112). If the user gesture for switching the jobs between the first job and the second job is detected, the processor (101) further determines whether or not a user command of changing the configuration of the display screen is recognized or received from the user gesture (S1113).

If the user command of changing the configuration of the display screen is recognized or received, the processor (101) operates the switched first job (former second job) and displays the switched first job (former second job) in the first area of the display screen (S1116). Furthermore, the processor (101) determines a new second job based on user experienced access, wherein the new second job is determined as one of user experience jobs which were accessed by the user while the switched first job was operating as a first job (S1117). Also, the processor (101) operates the switched second job (former first job) and displays the switched second job in the second area of the display screen (S1118). However, if the user gesture for switching the jobs between the first job and the second job is not detected at step S1112, the process returns to step S1111 and step S1111 can be processed.

In another flow, if the user command of changing the configuration of the display screen is not recognized or received, the processor (101) operates the switched first job (former second job) and displays the switched first job (former second job) in the first area of the display screen (S1114). Also, the processor (101) operates the switched second job (former first job) and displays the switched second job in the second area of the display screen (S1115). However, if the user gesture for switching the jobs between the first job and the second job is not detected at step S1112, the process returns to step S1111 and step S1111 can be processed.

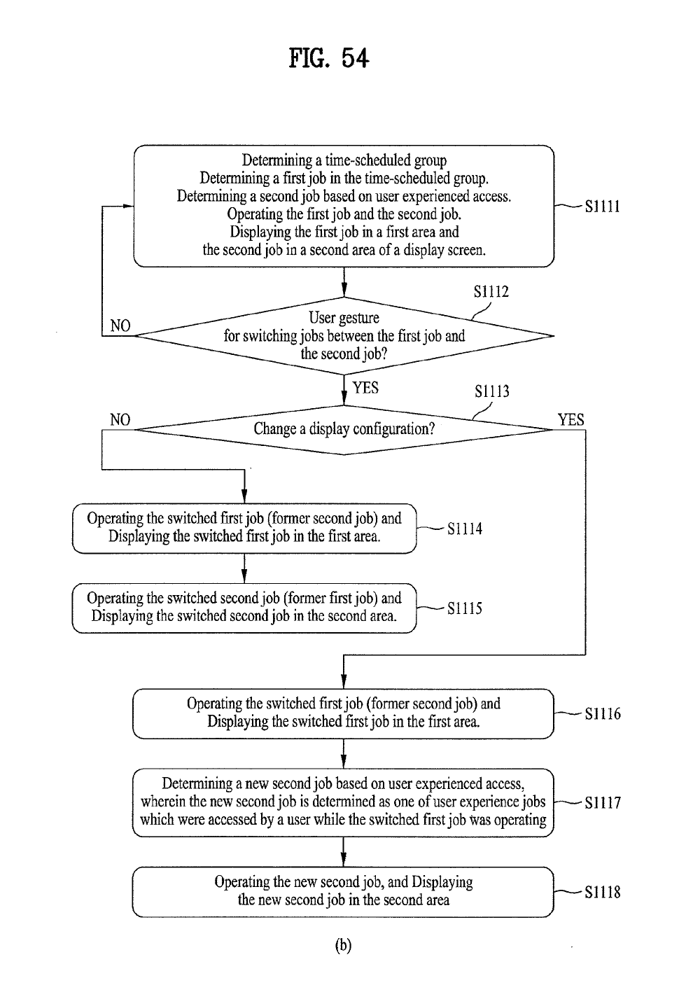

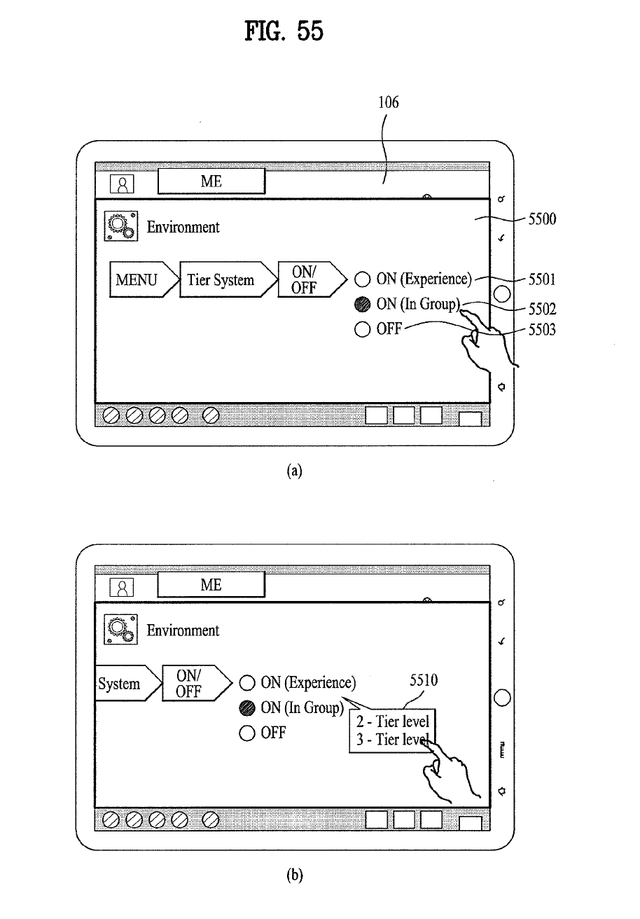

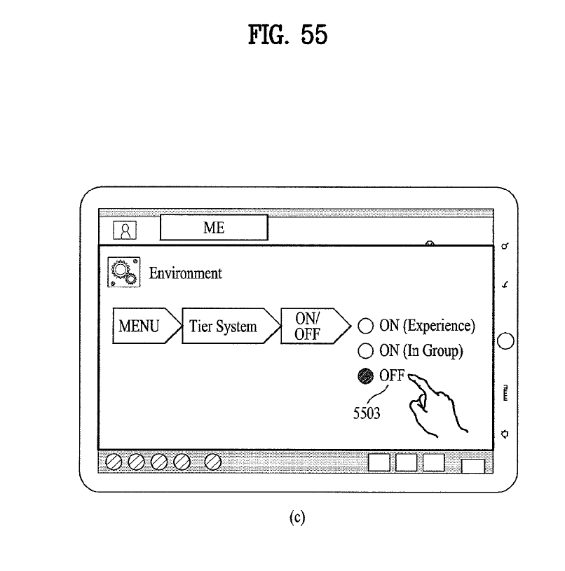

FIGS. 55(a)˜55(c) illustrate exemplary user interfaces for selecting a menu of a Tier-system on a display screen in accordance with the some embodiments. Referring to FIGS. 55(a) and 55(c), the processor (101) can provide a user with a menu page (5500) on the display screen (106). Referring to the exemplary case of FIGS. 55(a) and 55(c), on the menu page (5500), the processor (101) can provide two ON-fields (5501, 5502) for executing the Tier-system on the computing device and one OFF-field (5503) for not-executing the Tier-system on the computing device. In particular, the first field (5501) among the two ON-fields can be configured to operate the Tier-system based on user experienced access in accordance with the embodiment of FIG. 18. The second field (5502) among the two ON-fields can be configured to operate the Tier-system based on group configuration in accordance with the embodiment of FIG. 6.

Referring to FIG. 55(b), if a user selects one of the two ON-fields (5501, 5502), the processor (101) can further provide a menu window (5510) on the menu page (5500) to guide the user to determine one of the Tier levels (e.g., ‘2-Tier levels’ in FIGS. 2 and ‘3-Tier levels’ in FIG. 3).

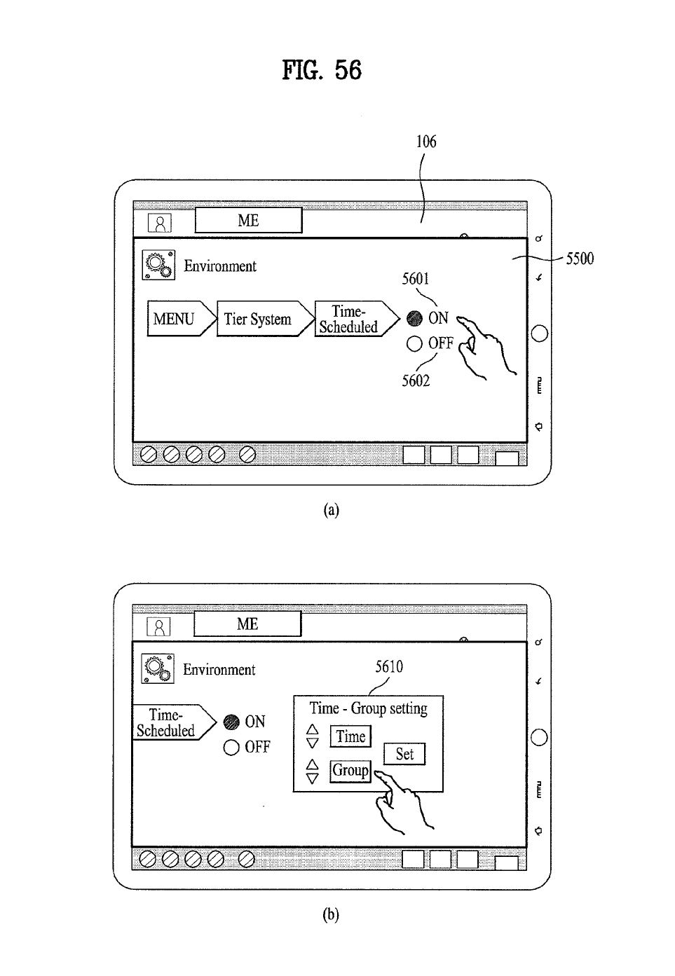

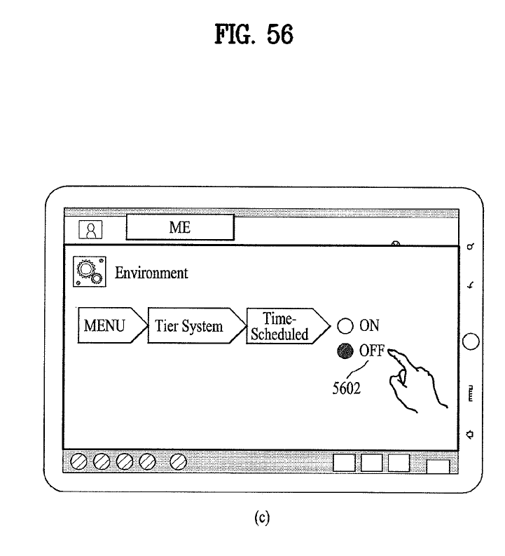

FIGS. 56(a)˜56(c) illustrate other exemplary user interfaces for selecting a menu of Time-scheduled group on a display screen in accordance with some embodiments. Referring to FIGS. 56(a) and 56(c), the processor (101) can provide a user with a menu page (5600) on the display screen (106). Referring to the exemplary case of FIGS. 56(a) and 56(c), on the menu page (5600), the processor (101) can provide an ON-field (5601) for executing the Time-scheduled group on the computing device and an OFF-field (5602) for not-executing the Time-scheduled group on the computing device in accordance with the embodiment of FIG. 34. Referring to FIG. 56(b), if he user selects the ON-field (5601), the processor (101) can further provide a menu window (5610) on the menu page (5600) to guide the user to set a specific group name and Time-period to be applied to the embodiment of FIG. 34. Other variations on the menus and selectable items corresponding to the fields discussed above are possible and part of the invention.

The disclosed embodiments provide a plurality of functions for computing device for supporting an efficient usage for multitasking environment on a computing device. Furthermore, various embodiments proposed in the description of the present invention may be used so that the user can easily realize multitasking environment by using his (or her) own computing device. Moreover, any feature discussed in connection with one example or embodiment of the present invention can be applied to any other example or embodiment discussed in the application. Such an application can be made as an addition, a variation or as a substitute for a generally corresponding feature. Further, although specific areas of the display screen have been designated for displaying the first, second and/or common jobs as discussed above, these are mere examples and other variations are possible. For instance, the second area of the display screen can be on the right or upper side of the screen, and/or the common job area can be on the left or bottom side of the screen. In another example, the first, second and common job areas can all be located from a left to right (or right to left) of the entire screen area. Furthermore, the user can selectively designate or change how these areas of the display screen would be used for the first, second and common jobs. In addition to the display location, the first, second, and common jobs can be displayed differently (e.g., different colors, sizes, fonts, etc.) from each other on the screen for an easy recognition by the user. Moreover, the user can designate (e.g., by touching and dragging the job to an appropriately designated job area on the screen) any of the available jobs as a first, second or common job and can switch any of the first, second and common jobs to be any other job, e.g., switch a current common job as the first or second job or vice versa.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for controlling multitasking using a computing device having a display screen and a processor, the method comprising:
identifying, by the processor of the computing device, a user command for selecting a first job from a group of jobs associated with the multitasking;
determining, by the processor, at least one second job for the same group containing the first job, wherein the second job is a job which was recently accessed by a user from the same group;
performing, by the processor, an operating process of the first job while displaying the first job in a first area of the display screen; and
performing, by the processor, an operating process of the second job while displaying the second job in a second area of the display screen.

2. The method of claim 1, further comprising;
determining at least one common job from predetermined common applications, wherein the common job is determined as at least one of the predetermined common applications excluding the determined second job; and
performing an operating process of the common job while displaying the common job in a global area of the display screen,
wherein the global area is different from at least one of the first and second areas of the display screen.

3. The method of claim 1, wherein
the first job is a primary operating job desired by the user, and/or
the second job is a secondary operating job determined by the processor.

4. The method of claim 2,
wherein the operating process of the first job is performed based on a complete running process,
the operating process of the second job is performed based on a partial running process, and
the operating process of the common job is performed based on a background running process.

5. The method of claim 1, further comprising;
performing, by the processor, a job switching process between the first and second jobs in response to the user's request for job switching,
wherein the step of performing the job switching process includes:
displaying the second job as a new first job in the first area of the display screen and performing an operating process of the new first job displayed in the first area of the display screen; and
displaying the first job as a new second job in the second area of the display screen and performing an operating process of the new second job displayed in the second area of the display screen.

6. The method of claim 1,
wherein the first area is a center portion or main portion of the display screen, and
the second area is a side portion or a hidden portion of the display screen.

7. The method of claim 6, further comprising:
scrolling contents displayed on the display screen according to the user's touch movement, wherein the scrolled contents include at least one second job that was not visible to the user due to being in the hidden portion of the display screen.

8. A method for controlling multitasking using a computing device having a display screen and a processor, the method comprising:
identifying, by the processor of the computing device, a user command for selecting a first job from a group of jobs associated with the multitasking;
determining, by the processor, at least one second job based on user access, wherein the second job is determined as one of jobs which were accessed by the user while the first job was operating;
performing, by the processor, an operating process of the first job while displaying the first job in a first area of the display screen; and
performing, by the processor, an operating process of the second job while displaying the second job in a second area of the display screen.

9. The method of claim 8, further comprising;
determining at least one common job from predetermined common applications based on user access, wherein the common job is determined as one of common applications excluding the determined second job, which were accessed by the user while the first job was operating; and
performing an operating process of the common job while displaying the common job in a global area of the display screen.

10. The method of claim 8, further comprising;
performing, by processor, a job switching process between the first and second jobs in response to the user's request for job switching,
wherein the step of performing the job switching process includes:
performing an operating process of the switched first job with displaying the switched first job in the first area of the display screen;
determining a new second job based on user experienced access, wherein the new second job is determined as one of user experience jobs which were accessed by a user while the switched first job was operating; and
performing an operating process of the new second job with displaying the new second job in a second area of the display screen.

11. A method for controlling multitasking using a computing device having a display screen and a processor, the method comprising:
identifying, by the processor of the computing device, a group from a plurality of groups associated with the multitasking, each group containing at least one application, wherein the identified group is a group selected by a user according to the user's command, or is a group determined by the processor that corresponds to a current time;
determining, by the processor, a first job from the identified group, wherein the first job is a job which was most recently accessed by the user from the identified group;
determining, by the processor, at least one second job from the identified group, wherein the second job is a user job accessed prior to the access of the first job in the identified group;
performing, by the processor, an operating process of the first job while displaying the first job in a first area of the display screen; and
performing, by the processor, an operating process of the second job while displaying the second job in a second area of the display screen.

12. The method of claim 11, further comprising;
determining at least one common job from predetermined common applications, wherein the common job is determined to be one of the predetermined common applications excluding the determined second job; and
performing an operating process of the common job while displaying the common job in a global area of the display screen.

13. A method for controlling multitasking using a computing device having a display screen and a processor, the method comprising:
identifying, by the processor of the computing device, a group from a plurality of groups associated with the multitasking, each group containing at least one application, wherein the identified group is a group selected by a user according to the user's command, or is a group determined by the processor that corresponds to a current time;
determining, by the processor, a first job from the identified group, wherein the first job is a job which was most recently accessed by the user from the identified group;
determining, by the processor, at least one second job based on user access, wherein the second job is determined as one of jobs which were accessed by the user while the first job was operating;
performing, by the processor, an operating process of the first job while displaying the first job in a first area of the display screen; and
performing, by the processor, an operating process of the second job while displaying the second job in a second area of the display screen.

14. The method of claim 13, further comprising;
determining at least one common job from predetermined common applications based on user access, wherein the common job is determined as one of the predetermined common applications excluding the determined second job, which were accessed by the user while the first job was operating; and
performing an operating process of the common job while displaying the common job in a global area of the display screen.

15. A computing device for controlling multitasking, the computing device comprising:
a display screen; and
a processor which controls the display screen and which:
identifies a user command for selecting a first job from a group of jobs associated with the multitasking,
determines at least one second job for the same group containing the first job, wherein the second job is a job which was recently accessed by a user from the same group,
performs an operating process of the first job while displaying the first job in a first area of the display screen, and
performs an operating process of the second job while displaying the second job in a second area of the display screen.

16. The computing device of claim 15, wherein the processor is further configured to:
determine at least one common job from predetermined common applications, wherein the common job is determined as at least one of the predetermined common applications excluding the determined second job, and
perform an operating process of the common job while displaying the common job in a global area of the display screen,
wherein the global area is different from at least one of the first and second areas of the display screen.

17. The computing device of claim 15, wherein the first area is a center portion or main portion of the display screen, and
the second area is a side portion or a hidden portion of the display screen.

18. A computing device for controlling multitasking, the computing device comprising:
a display screen; and
a processor which controls the display screen and which:
identifies a user command for selecting a first job from a group of jobs associated with the multitasking,
determines at least one second job based on user access, wherein the second job is determined as one of jobs which were accessed by the user while the first job was operating,
performs an operating process of the first job while displaying the first job in a first area of the display screen, and
performs an operating process of the second job while displaying the second job in a second area of the display screen.

19. A computing device for controlling multitasking, the computing device comprising:
a display screen; and
a processor which controls the display screen and which:
identifies a group from a plurality of groups associated with the multitasking, each group containing at least one application, wherein the identified group is a group selected by a user according to the user's command, or is a group determined by the processor that corresponds to a current time,
determines a first job from the identified group, wherein the first job is a job which was most recently accessed by the user from the identified group,
determines at least one second job from the identified group, wherein the second job is a user job accessed prior to the access of the first job in the identified group,
performs an operating process of the first job while displaying the first job in a first area of the display screen, and
performs an operating process of the second job while displaying the second job in a second area of the display screen.

20. A computing device for controlling multitasking, the computing device comprising:
a display screen; and
a processor which controls the display screen and which:
identifies a group from a plurality of groups associated with the multitasking, each group containing at least one application, wherein the identified group is a group selected by a user according to the user's command, or is a group determined by the processor that corresponds to a current time,
determines a first job from the identified group, wherein the first job is a job which was most recently accessed by the user from the identified group,
determines at least one second job based on user access, wherein the second job is determined as one of jobs which were accessed by the user while the first job was operating,
performs an operating process of the first job while displaying the first job in a first area of the display screen, and
performs an operating process of the second job while displaying the second job in a second area of the display screen.
